(19) United States
(12) Patent Application Publication
(10) Pub. No.: US 2004/0230659 A1
(43) Pub. Date: Nov. 18, 2004

(54) Systems and methods of media messaging

(76) Inventor: Michael John Chase, Boulder, CO (US)

Correspondence Address: LATHROP & GAGE LC, 4845 PEARL EAST CIRCLE, SUITE 300, BOULDER, CO, 80301, US

(21) Appl. No.: 10/799,981

(22) Filed: Mar. 12, 2004

Related U.S. Application Data
(60) Provisional application No. 60/454,158, filed on Mar. 12, 2003.
(60) Provisional application No. 60/468,575, filed on May 7, 2003.

(51) Int. Cl. G06F 15/16

(52) U.S. Cl. 709/206

(57) ABSTRACT

A messaging system has a first computer and a second computer connected via a network. A first Edge Terminal Device (ETD) connects to the first computer and a second ETD connects to the second computer. The first ETD is responsive to a received message transmitted by the second ETD to reproduce content of the received message and to accept user input in response to the message. A software product has instructions, stored on computer-readable media, wherein the instructions, when executed by a computer, perform steps for controlling the computer and an ETD connected to the computer, including: instructions for interpreting user inputs of the ETD; instructions for re-characterizing the user inputs as directive instructions for a second computer, the directive instructions having control information for a second ETD connected to the second computer; and instructions for capturing content from the ETD, through the computer and second computer, for delivery to the second ETD. A method is provided for best effort delivery messaging for a recipient user agent, including: as directed by the recipient user agent, forming one or more surrogate proxy user agents for the user agent; and through operation of the surrogate proxy user agents, storing multimedia data for the recipient user agent due to one or both of (a) unavailability of the recipient user agent and (b) request by the receiving user agent. A server system manages mark-ups of multimedia data of one or more communicating devices on a network, comprising: means for buffering first multimedia data; and means for accepting inputs from the communicating devices to mark-up the first multimedia data such that, for each mark-up, a node is added to a hierarchical list structure having child and peer relationships, and such that applying the mark-ups to the first multimedia data defines a second multimedia data that is of equal or different duration and content to the first multimedia data.

### CROSS-REFERENCE TO RELATED APPLICATIONS

This application claims priority to U.S. Provisional Application Serial. No. 60/454,158, filed Mar. 12, 2003, and incorporated herein by reference.

### REFERENCE TO COMPUTER PROGRAM LISTING COMPACT DISK

Reference is hereby made to a compact disc appendix submitted herewith, in duplicate and in accordance with 37 CFR 1.52(e). The appendix contains a computer program listing in the form of a CD-ROM.

### BACKGROUND

The following art may be beneficial to understanding the subject matter hereof and is therefore incorporated herein by reference: “INETPhone: Telephone Services And Servers On Internet,” C. Yang, Memo, Internet RFC/STD/FYI/BCP Archives, RFC1789, University Of North Texas, April 1995, 5 pages; “Using the Microsoft Office Live Communications Server API,” Wayne Freeze, Microsoft (MSDN) Corporation, November 2003. “Media Support in the Microsoft Windows Real-Time Communications Client,” Tom Fout; Microsoft Corporation, November 2001; “Integrating Windows Real-Time Communications into Applications,” Tom Fout; Microsoft Corporation, Jan. 15, 2002; “A Presence Event Package for the Session Initiation Protocol (SIP),” Internet Engineering Task Force, draft-ietf-simple-presence-10.txt, J. Rosenberg, Jan. 31, 2003; “DirectPlay Voice: A Discussion of Implementation Design Strategies and Costs,” Paul Donlan, Microsoft Corporation; February 2000; “DirectX 9.0 Complete Software Development Kit (SDK),” dx9sdk.exe; 227732 KB; Dec. 19, 2002; V 9.0, © 2002 Microsoft Corporation.; “Middlebox Communications (MIDCOM) Protocol Requirements,” IETF RFC 3304; R. P. Swale, et al.; August 2002, The Internet Society; “Middlebox Communication Architecture and Framework,” IETF RFC 3303; P. Srisuresh, et al.; August 2002, The Internet Society; “RTP: A Transport Protocol for Real-Time Applications,” IETF RFC 1889, January 1996; “SDP:

Session Description Protocol,” IETF RFC 2327, April 1998; “SIP: Session Initiation Protocol,” IETF RFC 3261, June 2002; “Uniform Resource Identifiers (URI): Generic Syntax,” IETF RFC 2396, August 1998;

“WinRTP 2 Design Document,” http://www.vovida.org/applications/downloads/winRTP, © 2003 Cisco Systems, Inc; and “WinRTP Programmer's Guide,” http://www.vovida.org/applications/downloads/winRTP/WinRTPProgrammersGuide.htm © 2003 Cisco Systems, Inc.

### BACKGROUND OF THE INVENTION

Currently available communication infrastructures include voice, electronic mail, facsimile and video communications. These communication infrastructures are augmented by storage and retrieval facilities such as voice mail facilities, fax servers, bulletin board services and the like. These various communications have largely been processed on independent platforms and interconnected into private networks through independent and disparate channels of communication. Accordingly, voice messaging and instant text messaging technology have evolved virtually independently from one another. The following background provides a survey of the prior art and examines certain deficiencies.

Valdemar Poulsen (1898) has been given credit for inventing the “Telegraphone”—it is acknowledged to be the first machine to magnetically record and reproduce (voice) sound. When manufacturing economics allowed, analog answering machines flooded the consumer market between 1960 and 1980. These machines were adaptive variations on traditional tape recording devices and provided an interface to the telephone network so that announcements and received messages could be recorded, edited and replayed. In 1979, Gordon Matthews created a digital voice storage and management technology. In 1983, Matthews was granted U.S. Pat. No. 4,371,752, for an “Electronic audio communication system”, which has become broadly known as voicemail, and for which a billion dollar industry exists today. Voicemail has become an integral part of operating a successful business.

A parallel increase in the complexity of managing the directory and address information associated with each network complicates the growth of existing messaging systems and networks. Existing directory facilities are usually limited to a single system or, at most, a single organization. With prior art systems, it is difficult or impractical to acquire and effectively use directory information among the systems because of the technical and logical complexity of integrating new and disparate facilities into the network. Large scale directories are more complicated to deal with in voice messaging systems due to the fact that any functionality (such as retrieval or lookup) provided to the user is almost always restricted to Dual Tone Multi-Frequency (“DTMF”) inputs. The isolated nature of messaging systems discourages the standardization necessary to effectively network disparate systems. As such, even messaging systems that are working in the same media, for example, two voice messaging systems, may be incapable of transferring information and messages therebetween due to differences in the proprietary protocols used to process and transfer messages. Further, combinations of alternate messaging technologies such as e-mail and instant messaging (IM) are currently challenging the efficiency and effectiveness of voicemail.

IM began when Telex and TWX teletypewriters were first deployed in the 1930's, in Europe and the US, to transmit binary coded data representing text messages. IM has also existed on closed proprietary computer systems dating back to the 1950's. At that time, messaging had many forms—some similar to IM of the present day, others closer to present-day e-mail—of sending messages quickly and electronically. Some of the first programs written for the first timesharing computers in the early 1960's were designed to support real-time chat.

Early chat programs were limited to transmitting messages between two users at a time, the users being connected to the same computer. As the first computer terminals were essentially electronic typewriters without display monitors, usually situated in the same room as the computer, early users were generally limited to chatting with other users in their close proximity.

As technology improved, terminals were distributed throughout buildings and campuses via dedicated circuits; but they could not be used by geographically-distributed elements until the development of broadly available wide area networks, e.g., the ARPANET, and its successor, the Internet.

It may be argued that one of the first forms of IM transmitted on a public, non-proprietary computer network used the “talk” program under TENEX and Unix operating systems in the evolving stages of the ARPANET during the 1970's. Another popular program often used with “talk” was “finger,” which provided real time presence information for users desiring to locate others with whom to talk. Such systems managed the disposition (or presence) of users by assigning authorization and capability levels (e.g., user, operator, sysop, root, wheel, et al.) and by displayed user status (e.g., active, idle, engaged, et al.). These systems were not generally available to the public as a retail product.

In 1983, MIT's Laboratory for Computer Science started Project Athena, a network of workstations and servers for undergraduate use. By 1987, there were thousands of workstations and several servers, and it became difficult to acquire vital messages quickly. In 1988, an instant messaging system named Zepher was deployed, allowing users to “subscribe” to different types of messages—e.g., viewing all warnings regarding a particular server, for example, or all messages sent out by a specific person. Though Zephyr was intended to send system status notifications and alerts—e.g., “you have new e-mail”—users started to use it to pass messages amongst themselves. When a user logged on, notifications went out to all who had subscribed to be notified. Peers could send and reply to messages or notifications, e.g., by employing “pop-up” windows on the user's screen. Participants could even create automatic response notices, saying they had briefly left their desks.

The next major milestone for messaging or chat systems came with the introduction of Internet Relay Chat (“IRC”), which was the most widely used Internet chat system in the early 1990s. Invented by graduate student Jarkko Oikarinen at the University of Oulu, Finland, in 1988, IRC was developed to provide an improved capability to talk programs then available on most Unix computers. IRC was one of the first chat systems around which standards evolved so it could be widely deployed and could interoperate between systems (e.g., IETF RFC 1459, IETF RFC 2810).

IM experienced significant growth in 1996 when the Mirablis company, later acquired by AOL, introduced ICQ (1-Seek-You) software. ICQ is a free, instant-messaging, client utility available to anyone with Internet connectivity and a Windows-based PC. ICQ, which popularized the notion of managed presence, is often perceived as the origin of the modern, client-server, IM model. See, e.g., U.S. Pat. No. 6,449,344. Since the inception of ICQ, many public networks, notably AOL, MSN, and YAHOO, have emerged with software equivalents of ICQ.

Currently, interactive communication over the Internet has several forms, principally e-mail, text messaging, audio messaging, video, white-boarding and application sharing. These forms of communication are used in a variety of different contexts. E-mail is generally not perceived as “real-time” or “immediate,” as messages may be read hours or days after they are sent, and due to a typical lack of feedback as to whether the message was received or read. Chat is principally used socially, or for information sharing; not for point-to-point communication. Video and audio are both real-time, but can be difficult to use because of proprietary software, proprietary protocols, bandwidth, and firewall/address translation issues; their widespread acceptance requires improvements in existing technology and special user interfaces.

IM differs from chat communication in multiple respects. First, chat users typically focus their attention on a chat window for the duration of communication, while IM users are generally alerted on a per-message basis, allowing them to pay attention to IM only when attention is required. Additionally, the chat model only makes sense for human-to-human communication, while instant messages may be used to transmit notifications from any source, such as a human user or automated system.

Firewalls commonly enforce and provide security to corporate and sometimes residential networks. Most business users therefore connect to the Internet through a firewall. Network Address Translation (“NAT”) routers are machines that translate one or more unique IP addresses to a plurality of IP addresses using table lookup translation techniques, allowing multiple PCs to share one Internet address using the Dynamic Host Configuration Protocol (“DHCP”). Most residential broadband users connect to the Internet through a NAT. Firewalls and NAT routers currently represent a significant impediment to systems attempting to provide real-time communication between Internet users. Firewall and NAT designs generally prohibit external entities on the Internet from directly connecting to internal entities protected by the firewall or translated through a NAT. While such security mechanisms prevent external entities from maliciously manipulating internal entities, they have had the side effect of preventing inbound asynchronous communication from an external entity. Existing protocols for real-time Internet text, audio, and video messaging are generally incapable of working well through a firewall or NAT without explicit security policy modifications by system administrators or explicit, and sometimes difficult, configuration settings by the user. Several solutions (uPnP, and ALG) have been proposed to remedy these problems; however, none are ubiquitous. As network systems administered by corporate entities and other organizations have advanced in popularity, the use of firewalls and related security techniques has increased. As data transmission rates have increased, the ability to send large amounts of data over the Internet between local area networks has also increased. The full potential of Internet communication has not been realized because of the difficulty in securely operating instant messaging and real time communication systems through one or more firewalls and one or more NATs.

Since the inception of ICQ, hundreds of similar messaging applications have appeared in both open (i.e., standardized) and closed (i.e., proprietary) forms. The sheer number of such disparate systems has raised interoperability issues in both legal and technical arenas. Internet Service Providers (“ISPs”) and portal providers such as AOL, MSN and Yahoo have popularized modern IM by making it freely available on their respective public networks. By design, there is essentially no interoperability between these networks. Each of AOL, MSN, and Yahoo has added capabilities to their messaging client software so as to manage the transmission and reception of audio (e.g., voice) messages between peers. They have also provided the capability to interface to a Public Switched Telephone Network (“PSTN”), allowing subscribing customers to place “Internet-to-PSTN calls.” Although these clients are capable of providing point-to-point, real-time voice conversations on the Internet, they do have several limitations:

If the party with whom voice conversation is desired is not available, there is no definite means to queue a message for later delivery.

There is no way to directly select a plurality (group) of peers to which a voice message is to be sent; moreover, there is no means to make a best effort (or best-alternative), real-time message delivery attempt to those who are on-line, or to store-and-forward the message for those who are not on-line or of a disposition to receive a message.

The client software and user interface is typically inefficient, often requiring several menu selections, multiple dialog boxes and the instantiation of a per-conversation window before a real-time voice dialog can be established and begin.

Client software often requires the use of a local store (e.g., RAM or disk) on the apparatus where media capture and encoding takes place should the encoded media message, e.g., a voice message, be sent by non-real-time means, such as store and forward.

There is no practical directory service—you must know the “handle” identity of the called party; there is no reliable way to locate an individual, as compared with PSTN directory assistance.

Firewall and NAT issues hinder real-time, peer-to-peer connections due to the limitations of IPv4 and the nature of most software program architectures.

One broadly available alternative for audio messaging that does not suffer from the above limitations is to use PSTN and hope for either one-to-one conversation with a live person or possibly with a voicemail system. Although generally effective, consider the inefficiencies of a typical real-time, two-party telephone call, especially those that involve interaction with a voicemail system in the business arena:

Both the calling and called parties must find enough privacy to conduct the real-time dialog; this may range from permitting bystanders to hear half the conversation to closing a door or escaping to a hallway with a wireless phone.

If a called party answers a phone call, there is a high percentage of “courtesy overhead” to establish a “friendly” dialog (e.g., “So, how are you.”), especially for short, infrequent inquiries, before the essence of the communication can realistically occur.

If the called party does not answer the phone, the chances of leaving a voice message are very high—people tend to “hide” from the commitment of answering the phone in real-time.

If the called party answers and has a call-waiting feature, there is a “toggle-distraction” delay after being placed on hold while the other party is distracted with another caller; lengthy holds are often abandoned.

If the voice mail system answers, the called party almost always listens to an insidious “You have reached . . . I'm sorry that . . . Leave a message at the beep . . . When you are done . . . ” discourse, sometimes lasting up to a minute. Reasonable voice mail systems sometimes have accelerators available to skip the announcement, but they are usually different between systems, and callers often wander off to different sub-menus by pushing “*” or “#” keys at the incorrect time.

The isolated and proprietary nature of existing voice mail systems provides for little, if any, interoperability. For example, even two voice messaging systems working in the same media may be incapable of transferring information and messages therebetween due to differences in message process and transfer protocols.

If a called party responds to voice mail, the original request and composed response are disjointed (it is not possible to interweave them); the return caller must often repeat the first message to again establish the context of the original query and then reply; and the caller must often repeats the original questions, sometimes with errors, sometimes out of context and often out of sequence.

There is no reasonable way to “markup” a multimedia message, such as a voice message, so that additional media content can be added, overlaid, deleted from, inserted into, mixed with, or concatenated without altering the original message content; moreover, there is currently no means in the prior art to perform this markup across disparate systems although some systems and methods do begin to address a simple annotation capability, e.g., U.S. Pat. No. 6,484,156.

An individual's or role's disposition (presence) in the PSTN is not visible; it is therefore not possible to know if someone is present and/or accepting calls without making the call itself; productivity is often sacrificed when callers hang up on voice mail, and pursue an alternate, possibly less efficient means of pursuing an answer or a directive.

More recent PTT (“Push-To-Talk”) voice communication systems, such as those offered by NexTel and Verizon, fix the groups to which PTT-messages are sent; there is currently no means to dynamically configure a group. The PTT messaging infrastructure is inherently real-time and there is currently no means to provide a best-alternative group delivery paradigm where a message is stored for one or more recipients of a group temporarily incapable of receiving the message, while being delivered to all others in the group able to receive the message in real-time.

Present media messaging terminal devices, embodied in either hardware and/or software, do not provide for the management of multiple simultaneous or concurrent multi-media sessions without an explicit change of a user interface (“UI”) context (e.g., selecting a different window or dialog), often involving a multiplicity of mouse, stylus or keyboard interactions.

The above limitations also hold true for residential telephone messaging. More particularly, voice messaging systems have not provided large-scale, integrated network functionality due to the following limitations:

Terminal equipment is usually a telephone, which can only communicate with audio signaling such as DTMF signals.

The methods of addressing are frequently short, fixed-length numerical addresses and currently deployed numbering schemes; the notion of presence, as embodied in current IM systems, does not exist.

Identity confirmation of the sender or recipient must be a spoken identification such as a numeric mailbox identifier or a name.

Communications protocols associated with voice messaging systems do not provide the facilities necessary to request or specify special services such as media translation, subject matter identification, routing and the like.

Managing message traffic in a packet-based networked environment creates additional resource and security concerns. As a message passes beyond the control of a local messaging system and into a network, the responsibility for routing and delivery of the message must also be passed to the network. This responsibility creates a need for a network fabric with significant message tracking and delivery management capabilities that do not exist in most real-time communication systems today.

Voice mail messaging systems are limited in functionality due to their inherent numerical addressing scheme (e.g., numeric mailbox identifier or numeric personal identification number (“PIN”)). The length of numerical identifiers is often limited to the sender/recipient's phone number, or some other local private numbering plan, or to the size of the addressing fields in any of the local networking protocols.

Text-based IM has gained significant popularity in residential and business arenas as a means to conduct quick, efficient and succinct near real-time interactive conversations, and is often used as an alternative to voice conversation and e-mail. Consider, however, how IM text differs from PSTN voice calls, voice mail, and e-mail:

IM advertises and utilizes presence, i.e., the disposition of an individual or an individual's surrogate or role in near real time—for IM to work effectively, it requires a persistent presence of an individual and/or role, in addition to an always-on persistent connection.

IM can be group-collaborative in nature, broadcasting messages that are visible to all who are present, which creates a compelling cooperation paradigm.

Enterprise IM has the ability to secure, log, archive and automate messages (“bots”); IM provides yet another form of communication that can be used in conjunction and mutual cooperation with applications; and a strategic benefit is achieved from IM's infrastructure for detecting presence, coordinated with a policy for how individuals or their surrogates communicate.

Text-based IM, however, also has efficiency issues and limitations:

The IM software client UI clutters the Windows desktop and often distracts the user of a productivity application (e.g., word processing or spreadsheeting).

Generating a response to an incoming IM requires the user to shift focus away from the current application to provide a response (e.g., type text)—this involves multiple mouse movements as well interrupting concentration.

Prior messaging schemes are somewhat insecure —IM text typically travels in clear form, visible to anyone with the means and desire to examine it.

The interoperability between the public AOL, MSN and Yahoo IM networks is, by design, discouraged and thwarted by the respective operators of those networks.

If a user's presence-mode indicates availability, others may expect immediate replies to their inquiries to that user; hence, users dwell on how to state their current presence-mode—sometimes on a minute-by-minute or task-at-hand basis.

Public IM forums (e.g., chat rooms where an individual's presence is anonymous) contain innocuous chatter; conversations are often irrelevant and sometimes vulgar.

Popular IM clients, utilizing public networks, flood users with advertising, typically annoying users, especially if unwanted, unsolicited web pages pop up on the computer screen, thus imposing further window focus change distractions.

Public IM forums often cannot be utilized by commercial businesses because of implicit lack of security and privacy, thus burdening organizations with the necessity to privately manage IM infrastructure to gain any useful benefit.

Although existing IM systems provide a means to store, archive and retrieve text messages, there is often no means to store, archive and retrieve multimedia messages such as voice and/or video sent between two or more parties.

To summarize, there is no known useful method or system that is economical, effective and efficient to capture, edit, transmit, receive, play, modify, markup, store, archive and retrieve digital media messages, such as audio messages, over a communications network (possibly coexisting in parallel or in tandem with IM infrastructure) that does not suffer from one or more of the issues and limitations summarized above.

### BRIEF SUMMARY OF THE INVENTION

In one embodiment, a messaging system includes a first computer and a second computer connected via a network. A first Edge Terminal Device (ETD) connects to the first computer and a second ETD connects to the second computer. The first ETD is responsive to a received message, transmitted by the second ETD, to reproduce content of the received message and to accept user input in response to the message.

In another embodiment, a software product includes instructions, stored on computer-readable media, wherein the instructions, when executed by a computer, perform steps for controlling the computer and an ETD connected to the computer, including: instructions for interpreting user inputs of the ETD; instructions for re-characterizing the user inputs as directive instructions for a second computer, the directive instructions comprising control information for a second ETD connected to the second computer; and instructions for capturing content from the ETD, through the computer and second computer, for delivery to the second ETD.

In another embodiment, a messaging system has a first ETD and a second ETD connected via a network. The first ETD is responsive to a received message, transmitted by the second ETD, to reproduce content of the received message and to accept user input in response to the message.

In another embodiment, a method is provided for best effort delivery messaging for a recipient user agent. One or more surrogate proxy user agents are formed for the user agent as directed by the recipient user agent. The surrogate proxy user agents operates to buffer multimedia data for the recipient user agent due to one or both of (a) unavailability of the recipient user agent and (b) request by the receiving user agent.

In another embodiment, a method is provided for best effort delivery messaging for a sending user agent. A list is formed of one or more receiving user agents as specified by the sending user agent. At least one surrogate proxy user agent is formed for each of the receiving user agents. The surrogate proxy user agent operates to buffer multimedia data for its respective receiving user agent until the receiving user agent is disposed to receive the multimedia data.

In another embodiment, a server system manages mark-ups of multimedia data of one or more communicating devices on a network, including: means for buffering first multimedia data; and means for accepting inputs from the communicating devices to mark-up the first multimedia data such that, for each mark-up, a node is added to a hierarchical list structure having child and peer relationships, and such that applying the mark-ups to the first multimedia data defines a second multimedia data that is of equal or different duration and content to the first multimedia data.

In another embodiment, a messaging system has a first ETD connected to a first computer connected with a network and a second ETD connected to a second computer connected with the network. The first ETD is responsive to a first received message transmitted by the second ETD to reproduce content of the first received message and to optionally accept user input in response to the first received message. The second ETD is responsive to a second received message transmitted by the first ETD to reproduce content of the second received message and to optionally accept user input in response to the second received message.

In another embodiment, a messaging system has a first ETD connected to a first computer connected with a network. A second computer connects with the network, and the first ETD is responsive to a received message transmitted by the second computer to reproduce content of the received message and to optionally accept user input in response to the received message.

### BRIEF DESCRIPTION OF DRAWINGS

FIG. 1A illustrates one exemplary network architecture implementing a plurality of Edge Terminal Devices (ETDs);

FIG. 1B illustrates one exemplary network architecture implementing a plurality of ETDs which also involve the use of a computer;

FIG. 2 illustrates a block diagram illustrating functionality of one ETD;

FIG. 3 illustrates one exemplary design of an ETD;

FIG. 4 shows a table with one exemplary design of user input key legends and associated functionality;

FIG. 5A illustrates one exemplary means of filtering of an RTP stream;

FIG. 5B illustrates one exemplary spectral component reorganization diagram;

FIG. 6 illustrates one exemplary network diagram of web service and remote-method usage;

FIG. 7A illustrates one schema for managing multimedia message;

FIG. 7B illustrates one schema for managing distributed markup of media messages;

FIG. 8A PRIOR ART illustrates one exemplary use of a session management protocol used to establish a session;

FIG. 8B PRIOR ART illustrates one exemplary use of a session management protocol used to deny a session;

FIG. 9A illustrates exemplary media message profile schema for a MediaMesageProfile;

FIG. 9B illustrates exemplary media message profile schema for a MediaMessageObject;

FIG. 9C illustrates exemplary media message profile schema for a FilterProfile;

FIG. 10 illustrates one exemplary block diagram of an ETD;

FIG. 11 illustrates one exemplary interrelationship among media messaging system components;

FIG. 12A illustrates one exemplary method of originating surrogate SIP UAC and UAS creation established by a user U1;

FIG. 12B illustrates one exemplary method of originating surrogate SIP UAC and UAS creation established by a user U2;

FIG. 12C illustrates one exemplary method of originating surrogate SIP UAC and UAS creation and a media stream proxy to receive multimedia content;

FIG. 12D illustrates one exemplary method of originating surrogate SIP UAC and UAS creation and a media stream proxy to transmit multimedia content;

FIG. 13A illustrates one exemplary process for managing a input from a user interface;

FIG. 13B illustrates one exemplary process for managing a user interface for a PTT session;

FIG. 13C is a continuance of FIG. 13B via a page connector;

FIG. 14A illustrates one exemplary process for managing a surrogate proxy for a “called” party;

FIG. 14B illustrates one exemplary process for managing a surrogate proxy for a “called” party for which a UAS is started;

FIG. 14C illustrates one exemplary process for managing a surrogate RTP proxy for a “called” party;

FIG. 14D illustrates one exemplary process for managing the spooling of multimedia content for a “called” party;

FIG. 15A illustrates on exemplary process for managing the initialization of sub-systems that can carry out the semantics of a “best-alternative” media message delivery;

FIG. 15B illustrates on exemplary process for managing the integrity of one, or more, sub-systems such as a “SessionServiceGroup;”

FIG. 15C illustrates one exemplary process for managing the inspection of a message, as may be contained in a REQUEST or RESPONSE object intrinsic to the MSLCS-2003 infrastructure;

FIG. 15D via a page connector to FIG. 15C, illustrates one exemplary process for managing a timer and monitor that supervise a thread;

FIG. 15E illustrates one exemplary process for managing a means to audit subsystems provided in any or all of the SessionServerGroups;

FIG. 15F illustrates exemplary processes for managing a means to ascertain the current and past performance characteristics of one or more RTPSurrogateProxy servers;

FIG. 15G illustrates exemplary processes for managing a means to direct the distribution of one or more multimedia RTP streams to one or more eligible clients; FIG. 15H, illustrates exemplary processes for managing a means to direct the distribution of a multimedia stream;

FIG. 15J illustrates exemplary processes for managing a means to stream (transmit) a predetermined media message to a calling SIP UA;

FIG. 15K illustrates an exemplary process for managing a means of distributing RTP multimedia content to one or more recipients;

FIG. 15L illustrates an exemplary process for managing a means of archiving an RTP stream from a originating (calling) entity;

FIG. 15M illustrates an exemplary process for creating a UASurrogateProxyStreamer object;

FIG. 15N illustrates an exemplary process for managing a means of transmitting a multimedia stream from a source S1.

### DETAILED DESCRIPTION OF THE INVENTION

The following illustrations and descriptions may be produced in different configurations, forms and materials without departing from the scope hereof. The embodiments provided herein are exemplary in nature, and are intended to be illustrative and non-limiting.

The terms audio message, media message, multimedia message and multi media are used throughout the specification to indicate a message content consisting of one or more of: video, audio, graphics and text. These terms may be used interchangeably.

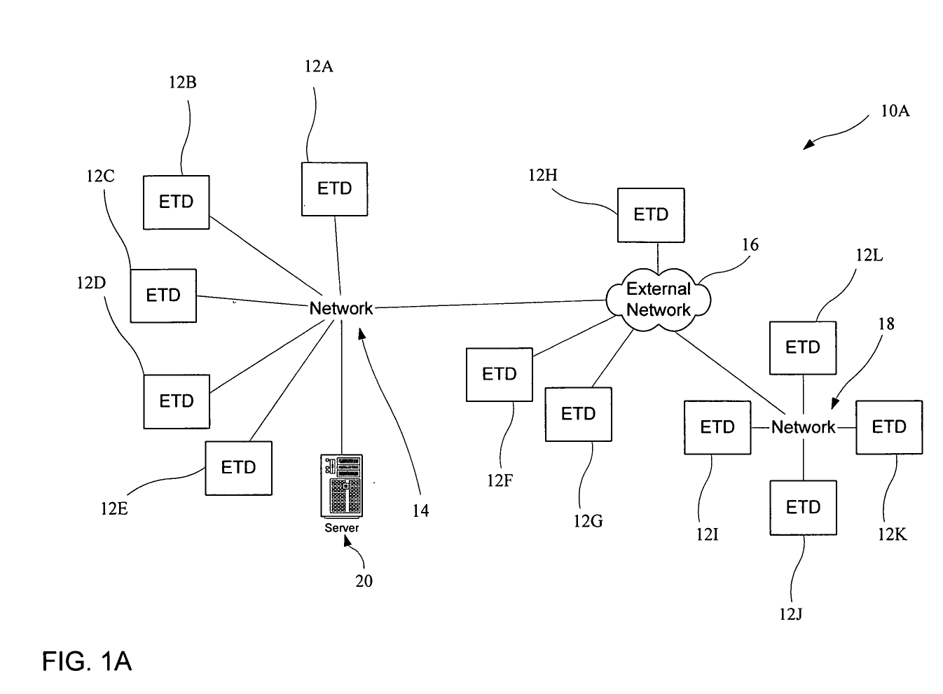

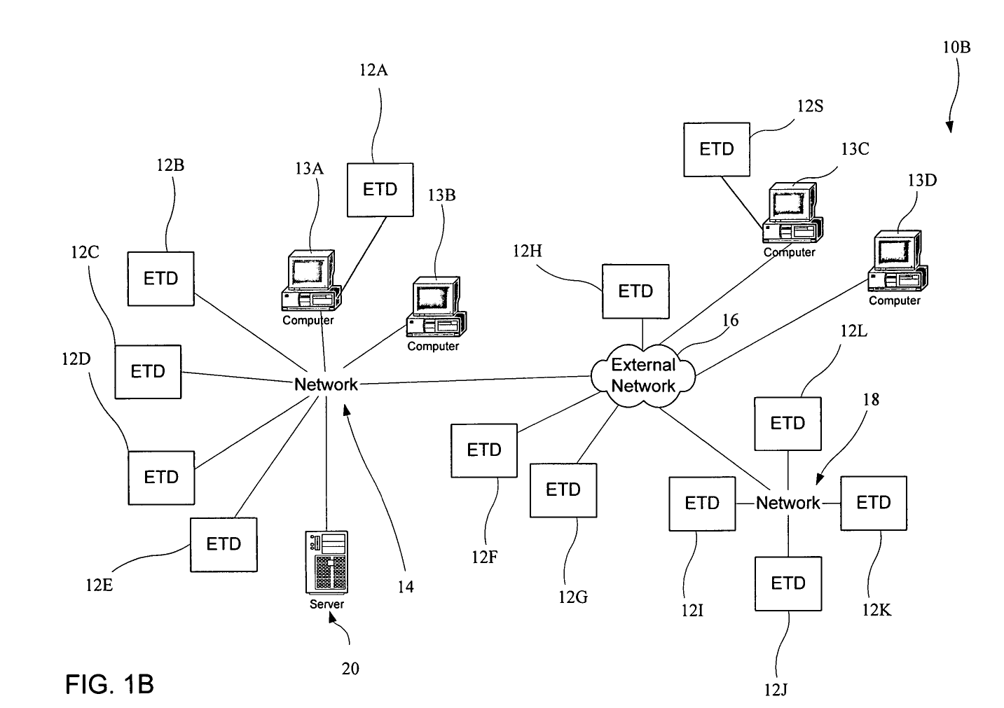

FIG. 1A and FIG. 1B illustrate exemplary network architectures 10A and 10B, respectively, showing a plurality of edge terminal devices (“ETDs”) 12. ETDs 12A, 12B, 12C, 12D and 12E are networked by a first network 14. First network 14 optionally connects to a second network 16 (e.g., Internet, wireless) external to first network 14. Second network 16 connects to ETDs 12F, 12G and 12H and, in this example, a third network 18. Third network 18 connects to ETDs 121, 12J, 12K and 12L. A server 20 is shown connected to first network 14 and may provide centralized processing and storage for systems and methods for media messaging, described herein. In FIG. 1A, ETD 12A connects to ETD 12B via first network 14 without intervening computers (i.e., computers directly coupled to either ETD 12A or ETD 12B). In this embodiment, ETDs 12A and 12B include functionality allowing communication across network 14 without requiring intervening computers.

FIG. 1B shows one embodiment illustrating ETDs 12A, and 12S connecting to intervening computers 13A and 13C, respectively. Intervening computers 13A, 13B, 13C and 13D are, for example, desktop PCs, Macintosh computers, workstations, notebooks or other personal computer systems. ETDs 12A and 12S utilize communication functionality of intervening computers 13A and 13B, respectively, thereby reducing complexity, and hence cost, of ETDs 12A and 12S.

Optionally, server 20 may also connect to other networks (e.g., second network 16 and third network 18).

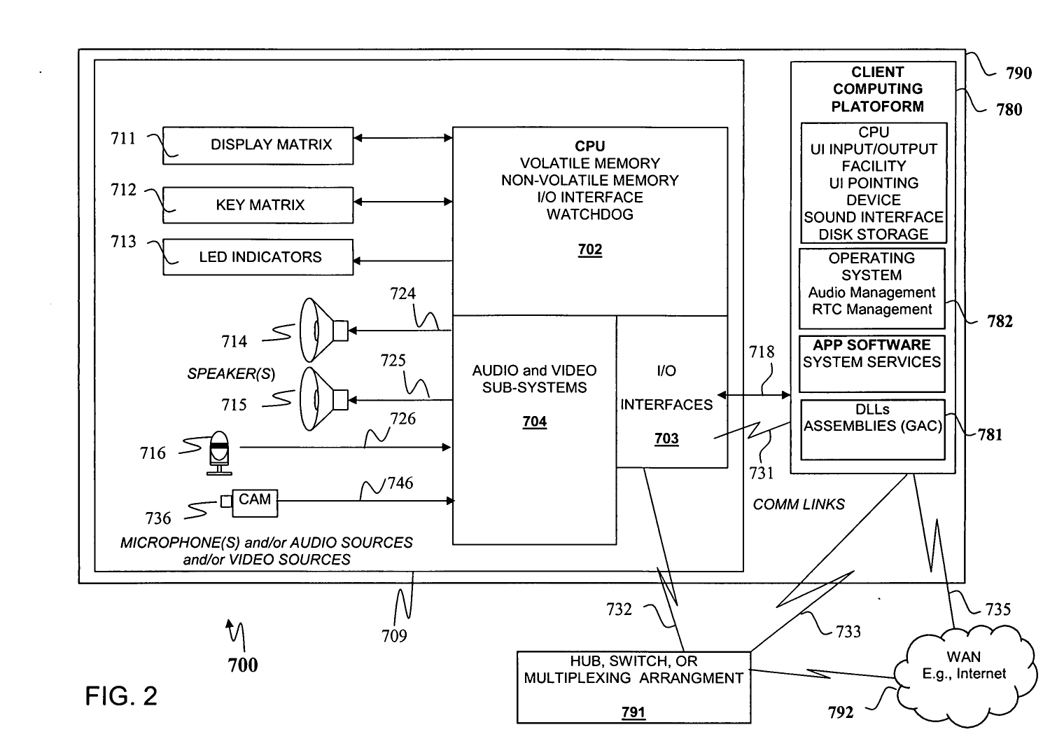

FIG. 2 is a block diagram illustrating exemplary functionality of one media messaging system 700. Media messaging system 700 includes an ETD 709 with a plurality of I/O interfaces for interacting with a user. ETD 709 includes a display matrix 711 for providing a textual display. Optionally, display matrix 711 provides graphical display information, receives tactile user inputs (i.e., display matrix 711 is a touch screen), and/or produces tactile output (i.e., display matrix 711 is a Braille display).

Key matrix 712 receives user input and provides UI context sensitive cues by selective key illumination. Key matrix 712 may be used to control the capture and processing of audio sound through audio input 716, control the presentation of audio sound through speakers 714, 715, control storing and execution of a machine readable program within processor unit 702, and control interfacing with other computing or communication facilities via communication channels 718, 731, 732.

LED indicators 713 also provide additional status and information to the user. Speakers 714, 715 provide audio output from one or more audio outputs 724, 725. Audio input 716 receives audio input and provides an audio source on input 726. Additional audio inputs may be implemented as a mater of design choice. Audio sources other than a microphone may utilize input 726. Input 726 and/or audio outputs 724, 725 may be attached to a headset or handset, for example.

Video camera 736 provides video signals to a video input 746. Video sources other than video camera 736 may connect to video input 746, and additional video inputs 746 may be implemented on ETD 709 as a matter of design choice.

Processor unit 702 provides processing and memory resources for ETD 709. Communications external to ETD 709 are provided by I/O interfaces 703. Audio and video subsystem 704 provides for one or more audio inputs (e.g., input 726), one or more audio outputs (e.g., audio outputs 724, 725), and one or more video inputs (e.g., video input 746). Optionally, subsystem 704 may also provide one or more video outputs (not shown).

ETD 709 is shown connected to a client computing platform 780 that provides storage, processing, and user interfaces resources. Operating system 782 may be contained within client computing platform 780. Client computing platform 780 may represent one of computers 13A, 13B, 13C and 13D of FIG. 1B, for example. Client computing platform 780 optionally connects to a network 792 and/or a hub 791. Hub 791 may be a switch, multiplexing or routing device connected to network 792. ETD 709 is shown connected to hub 791; however, ETD 709 may connect directly to network 792. Communication channels 731, 732, 733, and 735 may be implemented using wireless technology, as a matter of design choice.

In one embodiment, ETD 709 and functionality of client computing platform 780 are combined as shown by combined platform 790. Combined platform 790 represents ETDs 12 of FIG. 1A, for example.

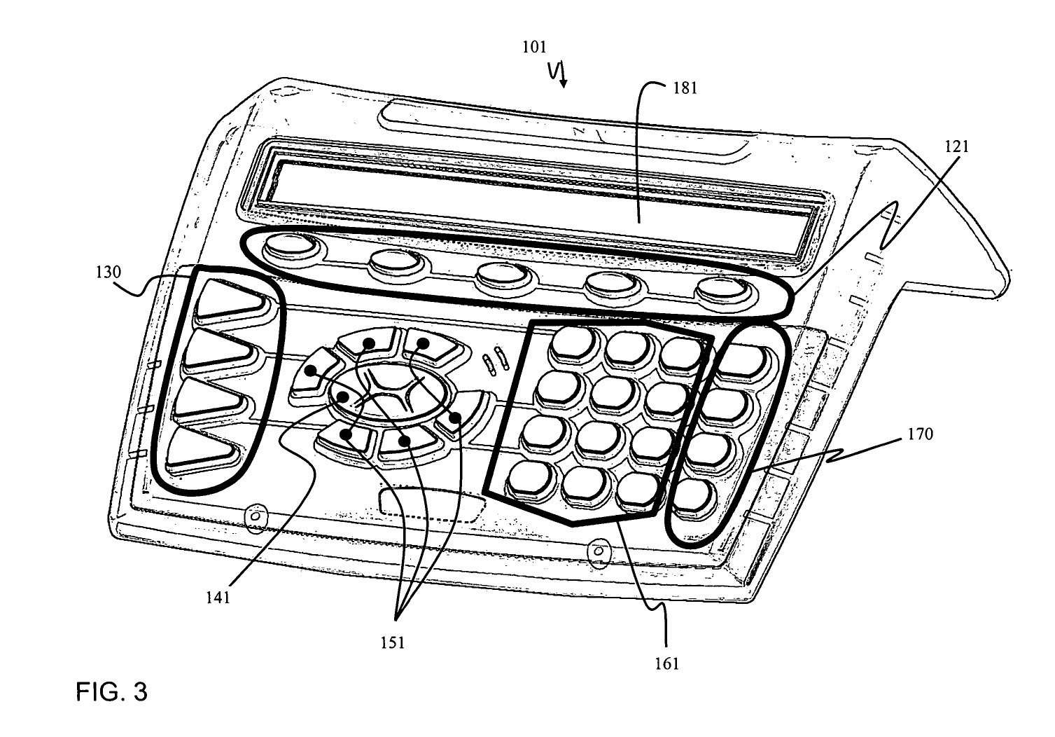

FIG. 3 illustrates one exemplary embodiment of an ETD 101, suitable for use as ETDs 12, FIGS. 1A and 1B. ETD 101 has a display 181 for displaying text and, optionally, graphics. ETD 101 also includes button groups 121, 130, 141, 151, 161, and 170, the buttons in each group receive user inputs and may be individually illuminated. In one example, buttons in button group 130 may be semantically configured to allow a user to manage a plurality of simultaneous and/or concurrent multimedia messaging sessions. Nothing precludes any button group from have more or less buttons as is shown in FIG. 3.

In one embodiment, ETD 101 operates to move a user's messaging UI from the PC ‘desktop’ (e.g., Microsoft Windows desktop client area, MacOS desktop client area, Unix/Linux desktop client area) onto ETD 101, external to the PC. ETD 101 may be co-located with, and/or attached to the PC by wired and/or wireless means.

The efficiency of an individual's messaging interactivity during a dialog where a response is required may be improved by ETD 101—the need for the user to break focus from an existing software application and proceed to a different software application to provide a response is removed. The inefficient of mouse movement, multiple mouse clicks, stylus taps, and/or the use of a QWERTY keyboard required for the response is also removed. Further, once the response is rendered, the user must “un-wind” (restore) his attention back to the original software application, which often involves multiple subsequent mouse clicks, stylus taps, and/or keystrokes.

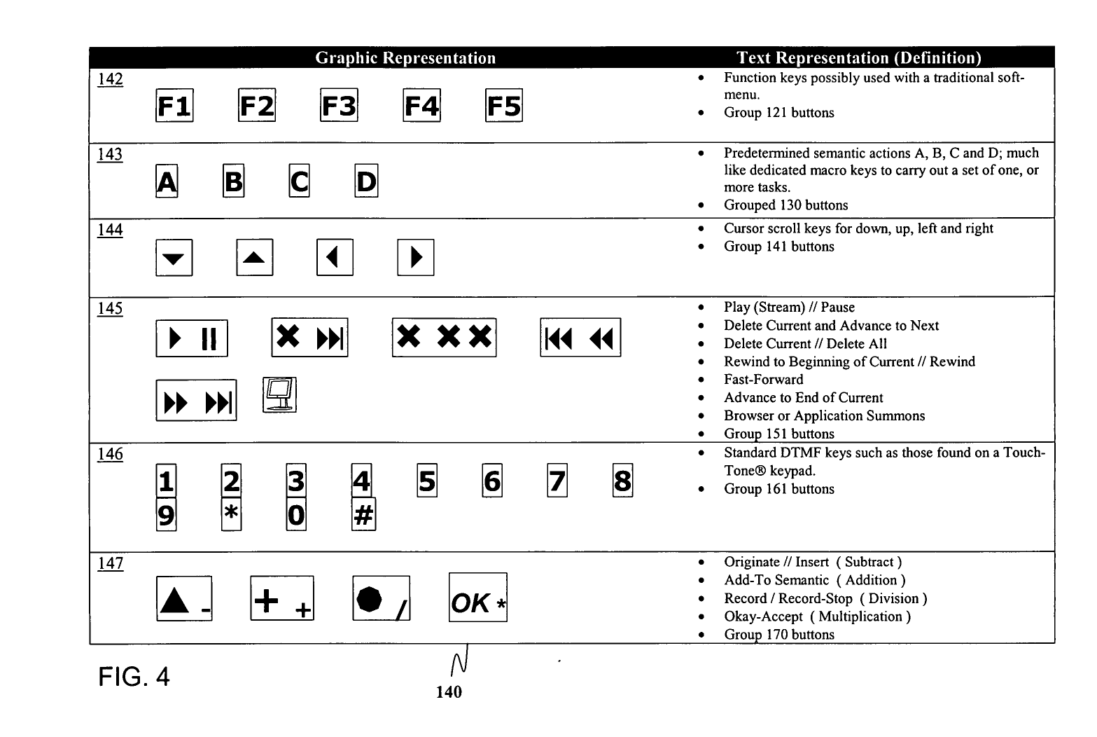

FIG. 4 is a table 140 illustrating exemplary button markings 141-147 and functionality assignment of button groups 121, 130, 141, 151, 161, and 170 of FIG. 3. Button group 121, marking 142 is located beneath display 181 and therefore may be utilized for soft-key menu selections associated with menu items displayed on display 181, for example. Buttons in button group 130, marking 143, may have predefined semantic actions; each button initiating a set of one or more tasks. Button group 141, marking 144, provides cursor control and scroll functionality, for example. In one embodiment, button group 141 is a single button with multiple ‘rocking action.’ In another example, button group 141 consists of four or more individual keys. Button group 151, marking, for example, is a group of buttons that control message playback, editing, and markup. In one embodiment, button group 151 provides control for: playing an audio message, pausing the audio message, deleting the current audio message, advancing to a next audio message, deleting the current audio message, deleting all audio messages, rewinding the current audio message, rewinding to the beginning of the current audio message, fast-forwarding through the current audio message, advancing to the end of the current audio message, and invoking a browser or other application to handle the current message. Button group 161, marking 146, may, for example, provide DTMF keys to allow Touch-Tone operation for PSTN dialing. Buttons in group 170, marking 147, may provide additional context-dependent functionality such as ‘originate’, ‘insert’, ‘add-to’, ‘record’, ‘record stop’, ‘overlay’, ‘mix’, ‘subtract’, ‘delete’, ‘attach filter’, ‘Okay’ and ‘Accept’. Other embodiments may contain differing functionality and button combinations without departing from the scope hereof.

Filters may be provided within ETD 101 for filtering inbound and/or outbound media messages (e.g., audio messages, audio streams, etc.). These filters are, for example, selectable by a user of ETD 101. In one example, the user's listening experience may be enhanced by applying one or more filters to an audio stream such that the content of the audio stream is enhanced to accommodate the listener's perception preference. These filters may, for example, be low pass, high pass, band pass, Gaussian, or other filter transfer function H(s) suitable to produce an altered and/or enhanced listening experience. In another example, a user with a hearing impairment may filter a multimedia message to better suit their hearing ability. Filters may also be applied by a sender of a media message. In one example, the sender applies one or more filters to the media message to intentionally disguise the sender's identity (e.g., voice print), while keeping the content of the message intelligible. Such filtering techniques “morph” the media message thereby providing individual aliasing capabilities. Such morphing alters a human voiceprint so that the originator is not discernable by the recipient, thus preserving anonymity.

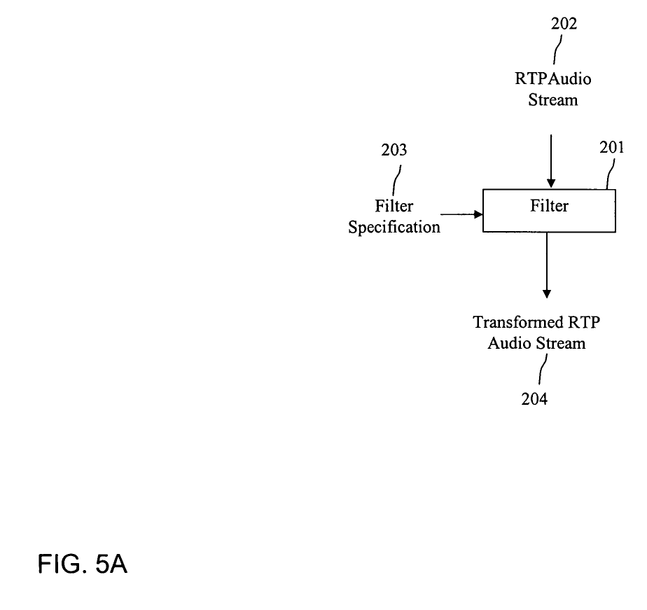

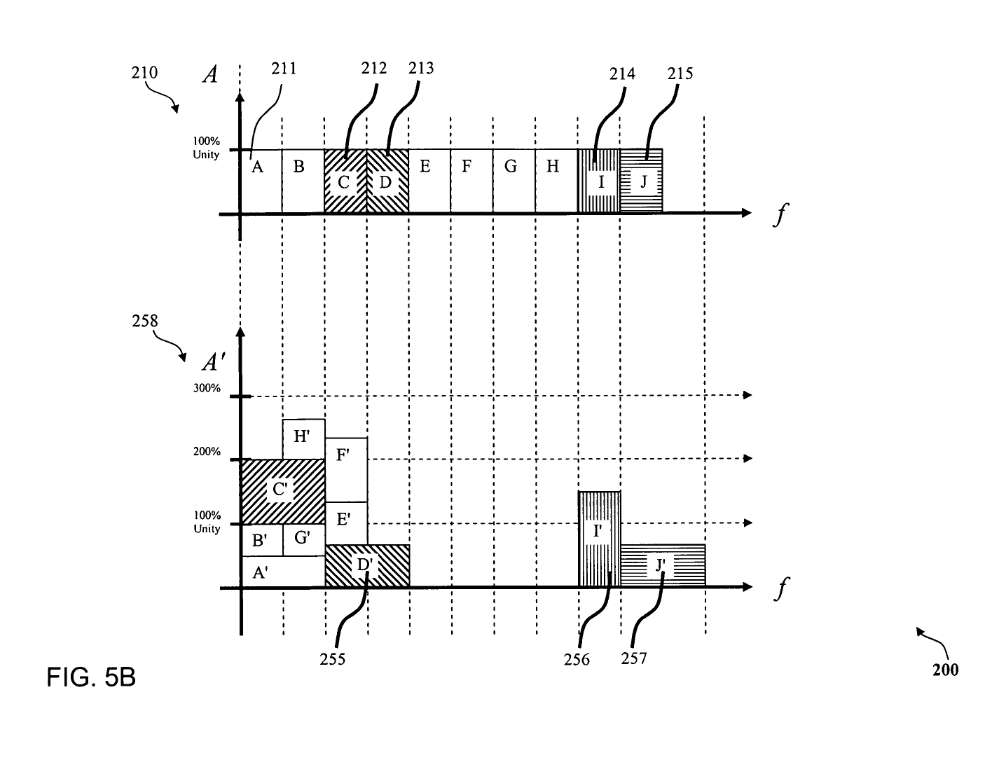

FIG. 5A shows exemplary operation of filter 201 within ETD 101, (FIG. 3), for example, operating with subsystem 704, operating system 782, FIG. 2. A filter specification 203 is input to filter 201 to specify filter parameters used during operation of filter 201. An RTP audio stream 202 is input to filter 201, and a transformed RTP audio stream 204 is output from filter 201.

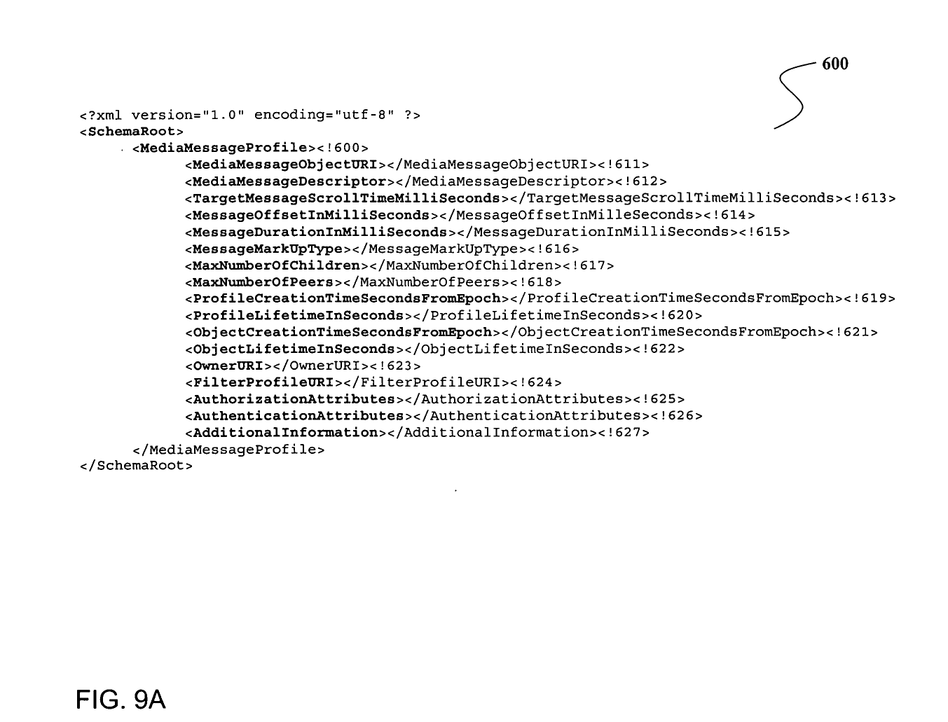

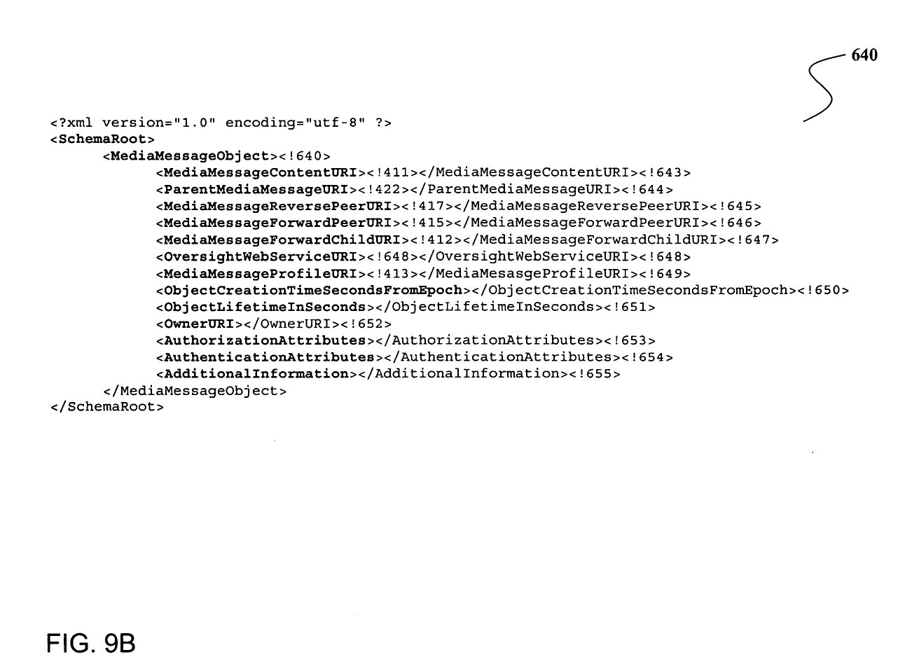

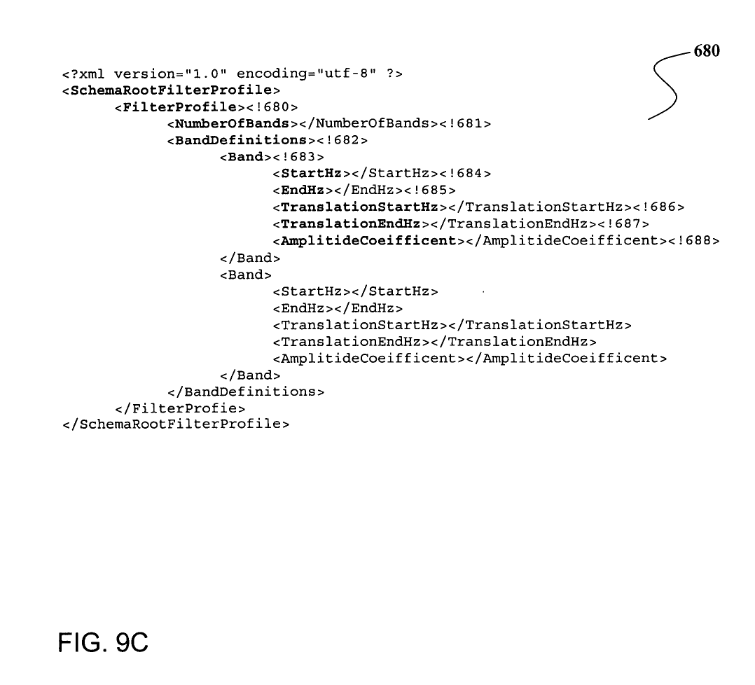

FIG. 5B shows one exemplary spectral component reorganization diagram 200 illustrating spectral shifting of frequency bands C and D resulting from use of filter 201, FIG. 5A. In one example, one or more frequency bands may be specified, where each band is defined by: a specification of a gain coefficient, positive or negative; a spectral shift, positive or negative; and/or an expansion or compression coefficient, positive or negative. FIG. 9C illustrates exemplary filter specification using XML markup schema to describe the layout of a data structure that can be deployed to manage a filter specification as required by filter 201. Filter profile schema 680 includes one or more descriptions that are used to specify the translation characteristic of a frequency band in a collection of one or more frequency bands 210, 211, 212, 213, 214 and 215. For a given band D 213, filter profile schema 680 provides a BandDefinition element which further contains elements: 1) StartHz and 2) EndHz that specify at which frequency band D 213 begins and at which frequency the band D 213 ends, respectively; 3) TranslationStartHz and 4) TranslationEndHz that specify a new band D′ 255 to represent the spectral energy components of the original band D 213 that may have endured a translation (shift), widening, narrowing, attenuation and/or amplification. Such a specification can be interpreted by a machine readable program that implements FFR and/or FIR filters, such as a hardware based DSP, or a software based CODEC filter arrangement as is provided in the publicly available WinRTP developer's kit from Vovida.Org. WinRTP is a Microsoft Windows based COM component which can originate RTP media from a microphone and terminate RTP media on a speaker, amongst much other alterable functionality. The WinRTP COM component can be further modified to implement software based filter 201, which interprets filter profile schema 680 and renders the spectral frequency band transformation as specified by filter specification 203 for a given RTP audio stream, to produce transformed RTP audio stream 204. Filter specification 203 may be referenced using a URI (FilterProfileURI) in a MediaMessageProfile 600, FIG. 9A, which can then optionally apply the filter specification to the transmission of a media message when it traverses an RTP stream managed by a modified WinRTP COM component, or functional equivalent.

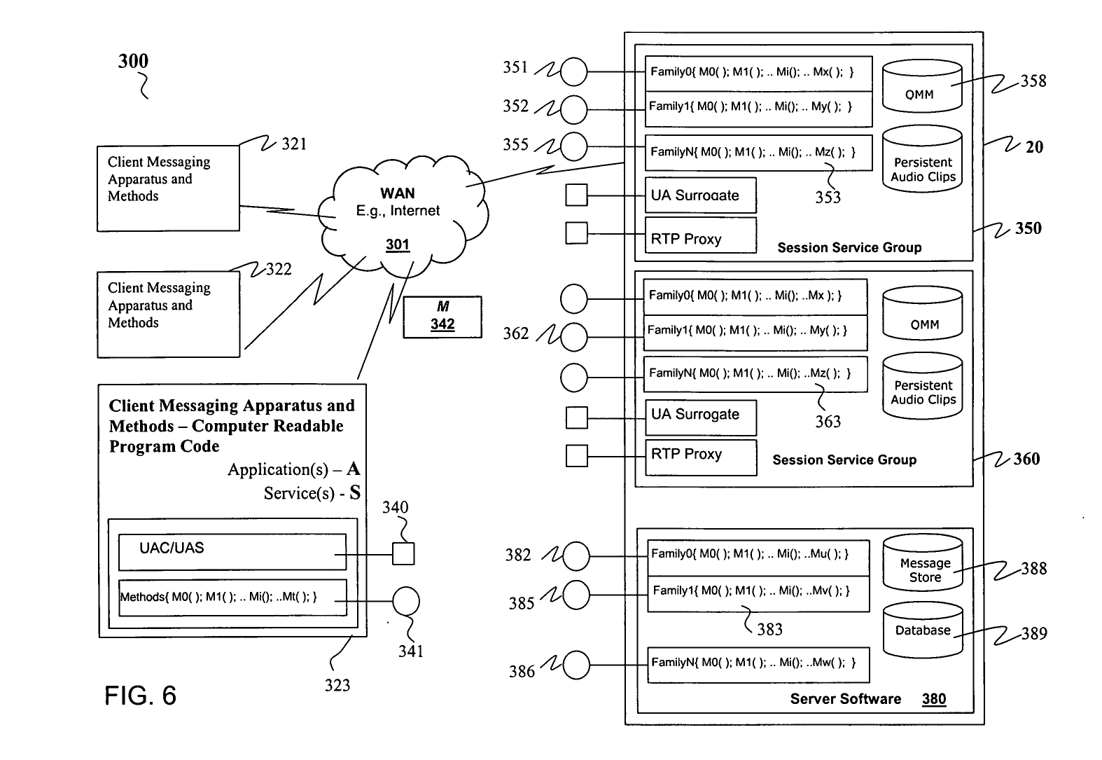

FIG. 6 is a network diagram 300 illustrating exemplary software architecture that may be used to manage transactions and sessions between server 20 and combined platform ETDs 321, 322 and 323. A transaction occurs, for example, when a media message is sent from ETD 321 to ETD 322. A session occurs, for example, when a real-time connection is made between ETD 321 and ETD 322 such that a media stream occurs between ETDs 321 and 322. ETDs 321, 322 and 323 may connect with server 20 via wide area network (“WAN”) 301.

A server architecture 380 within server 20 creates a session service group 350 that contains a plurality of method families 351, 352 and 355. More or fewer method families may exist as a matter of design choice. Session service group 350 does not necessarily reside within server 20, and may be distributed across multiple machines that are also geographically separated. Further, additional method families are created as needed and may be semantically unique or be semantically similar. For example, one method family may include one or more semantically similar methods with another method family, and also include some semantically unique methods. Method family 351, for example, includes methods M0( ), M1( ), . . . Mi( ), . . . , Mx( ) that manage reception, buffering, storage and distribution of media messages within server 20. Method family 352 may, for example, provide methods to manage distributed markup of media messages, and method family 355 may, for example, provide methods for transporting and storage of media messages. In one example, server architecture 380 creates session service group 350 to handle a transaction, or a session, for ETD 321. In another example, session service group 350 persists beyond the duration of any one transaction or session.

Methods M0( ), M1( ), . . . Mi, . . . , Mx( ) of method family 351 are, for example, invoked remotely using a remote procedure call (“RPC”) technique. Such techniques are know in the art and used, for example, within Java RMI, Net Remoting, or UDDI/SOAP/WSDL.

In one example, combined platform ETD 323 invokes one or more methods Mi( ) [i=0, 1, . . . , n] of method family 355 to transport a media message 342, including relevant parametric information that describes media message 342, to server architecture 380 that stores media message 342 and relevant parametric information within a message store 388. Message store 388 is, for example, a disk drive, a database, a memory buffer, a file, or a cache. Server architecture 380 examines a list of intended recipients of media message 342 and may notify intended recipients that media message 342 is pending and may be retrieved. If any intended recipient is capable of receiving media message 342, they may retrieve media message 342 using criteria defined by the recipient. If one or more intended recipient is not of a disposition (e.g., presence) to receive media message 342, then media message 342 is placed in a queued media message store 358 and a database 389 may be updated to indicate that media message 342 is pending for the intended recipient.

Server architecture 380 is made aware of disposition changes of any identified recipient, for example, by method calls that indicate the disposition change. If server architecture 380 determines that a disposition change of an identified recipient allows for reception of media message 342, the identified recipient is notified of queued media message 342, which may then be retrieved by the identified recipient as if received when originally sent.

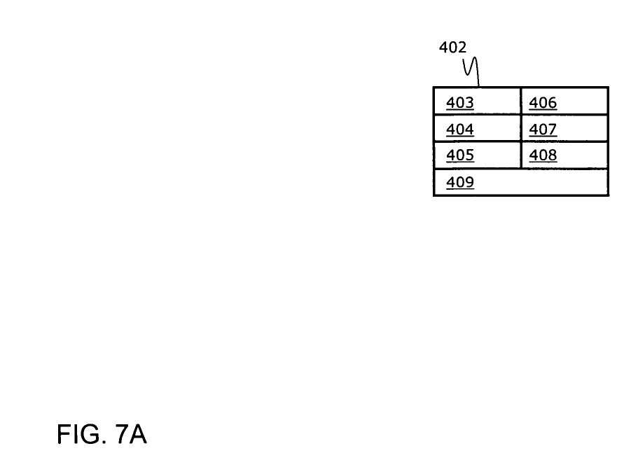

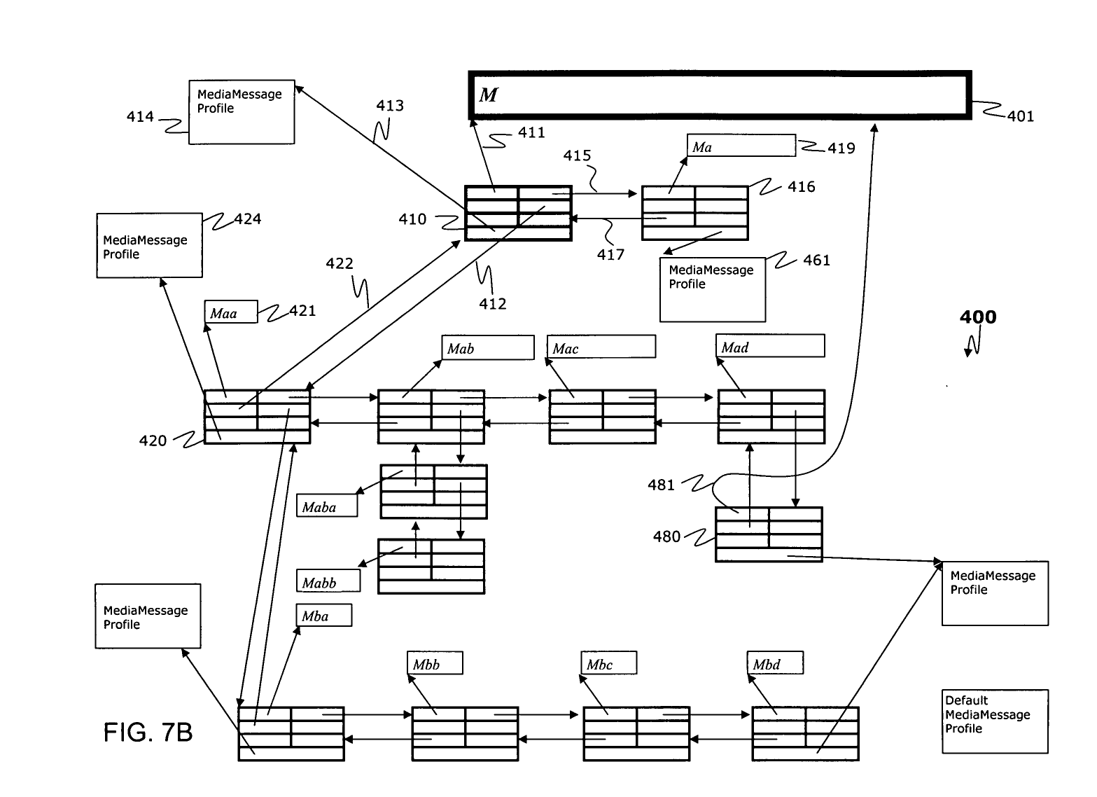

Server architecture 380 includes a plurality of method families 382, 385 and 386. One such method family 382, F₂ includes methods M0( ), M1( ), . . . , Mi( ), . . . , Mu( ), that manage distributed markup of multimedia messages. These methods may be invoked remotely, by ETDs 321, 322 and 323, for example, using conventional RPC techniques. A client application and/or service of ETD 323, for example, invokes one or more methods (e.g., method Mi( ) of method family 385) to transport media message 342, and relevant parametric information that describes media message 342, to server 20 that stores media message 342 appropriately. Nothing precludes a media markup method, such as shown in FIG. 7B, described herein below, from being used to manage the storage and retrieval of a message MM or a message QMM.

In one example, a client application A of ETD 323 utilizes method family 341 to contact server 20. Server 20 provides a plurality of method families. One such message family, F₁ 385 provides methods M0( ), M1( ), . . . Mi( ), . . . , Mv( ) available to manage the distributed markup of media messages. These methods may be invoked remotely using RPC techniques. Client application A and/or service S of ETD 323 then invoke one, or more, methods Mi( ) to transport content of message M 342, and relevant parametric information that describes message M, to the server, which then puts message Min a specified store. Method family 341 is, for example, provided as computer readable program code or an external apparatus (e.g., combined platform 790, FIG. 2) that interacts with an application or a system service (background daemon, service, thread, or process), which in turn, may utilize a collection of methods in method family 341, provided as a computer readable program code.

FIG. 7A shows one exemplary embodiment of a media message object 402 that includes a plurality of members that provide links to related data fields and structures of a media message. Media message object 402 includes: a message content link 403 that identifies associated message content storage (e.g., provides a link to message content 401, shown in FIG. 7B as link 411); a child-parent back link 404, 422 that provides a link to a parent media message object; a peer-peer back link 405, 417 that provides a link to a peer media message object; a peer-peer forward link 406, 415 that provides a link to a next peer media message object; a parent-child forward link 407, 412 that provides a link to a child media message object; link 408 is reserved for future reference; and a media message profile link 409, 413. Media message object 402 thus facilitates multi-linking (using multiple dual linked list constructs, for example) for construction of architectures to manage distributed markup of media messages.

FIG. 7B is a data description diagram illustrating one general architecture, or schema, for managing distributed markup of a media message 400. In one example, media message 400 is composed of one or more of: text, audio, video, and/or any other digital representation of time and/or spatially sequenced media.

In the example of FIG. 7B (and using FIG. 6), media message content M 401 is created by a first ETD (e.g., ETD 321) and marked-up by a second ETD (e.g., ETD 323). In a first scenario, ETD 323 utilizes methods of method family 341 to produce, compose, edit, review, and manage media message 400, media message content M401. These methods may be used to filter, mix, insert, overlay, and enhance the presentation of media message content M401. A sever S of ETD 323 then creates and initializes a media message profile 414. Server S then creates and initializes a media message object 410. In one embodiment, media message profile 414 and media message object 410 are described in XML, stored as text (see FIGS. 9A and 9B, respectively). Media message content M 401 may be stored as a binary data file or other suitable means to store multimedia information and/or content. In accordance with conventional software practices, pointers and handles (links) are used to track media message object 410 and media message profile 414. For example, one invoked remote method, Mi( ), may return a value HlocM that is a handle to locate media message object 410. HlocM may thus be used to retrieve, act upon, or modify media message 400, media message object 410 or media message profile 414. HlocM may also be a string of text that represents a URI or URL from which media message 400, media message object 410 or media message profile 414 can be retrieved or acted upon using facilities such as, but not limited to, HTTP/UDDI/SOAP servers and available method families (e.g., method families 382, 385 of server architecture 380).

The distributed markup schema of FIG. 7B provides one method to markup (e.g., insert, delete, alter, append, overlay, blank, extract and/or tag) media message 400 without necessarily altering media message content M401. For example, ETD 323 may use handle HlocM to make further markups to media message 400 by using RPCs to method families of server architecture 380. These markups can be applied recursively; the markups being stored in the n-ary tree structure, providing forward and reverse peering links, providing forward and reverse descendent (parent-child) links, of the general architecture illustrated in FIG. 7B.

In one example, the recursive decent of the n-ary tree of media message 400 produces a new message media content (possibly held in a buffer, media message store, or as new media message content in another n-ary tree similar to that of media message 400) which represents the application of media message profiles to media message objects in the tree. The new media message content can then be used to produce a media message source, one such example being a source for a multi media RTP stream.

In one example, a peer markup of media message 400 is made by ETD 323. Assuming ETD 323 has the appropriate authentication and authorization, ETD 323 creates a new media message object 416 that is linked to media message object 410 via peer-peer forward link 415 of media message object 410. In one example, peering media message object 416 and its associated media message content 419 are created using an authoring scenario similar to that described above. Once a handle HlocMa is obtained for this markup, an RPC to a method family of server architecture 380 is made to modify values in both media message objects 410 and 416 to reflecting their peering relationship, i.e. peer-peer forward link 415, peer-peer back link 417, and hence create a distributed markup tree with at least two nodes. Message media profile 461 describes the context of the relationship between media message content M401 and message content 419. This context may, for example, include elements described MediaMessageProfile 600, FIG. 9A, although additional markups from alternate markup schemas or methods may be used. In one example, message media profile 461 specifies whether media message content 419 is reviewed (played) before, during, after, inserted in to, combine with, or replaces a segment of, media message 400, media message content M401.

In another example, a child markup to media message object 400 is made by ETD 323, assuming appropriate authentication and authorization has been established. A media message object 420 is created and linked to media message object 410, as shown by child-parent back link 422 relationship. Child media message object 420, and its message content 421, may, for example, be created using an authoring scenario similar to that described above. Once handle HlocMaa is obtained, one, or more, method call(s) may be made to modify values in both media message object 410 and media message object 420 to reflecting their parent-child relationship, i.e., child-parent back link 422, parent-child forward link 412 and hence create a distributed markup tree with multiple nodes. Message media profile 424 for media message object 420 describes a context for the relationship between media message content 401 and message content 421. This context may, for example, include elements described MediaMessageProfile 600, FIG. 9A, although additional markups from alternate markup schemas or methods may be used. In one example, message media profile 424 specifies whether content of media message 421 is reviewed (played) before, during, after, inserted in to, combine with, or replaces a segment of, media message content 401. This contextual relationship may hold for all nodes that reference one another; one exemplary peer-peer and parent-child relationship is shown in the distributed markup schema of FIG. 7B.

Media message object 410 may be referenced as a peer, parent, or child in other distributed markup trees as long as handle HlocM of media message 400 is known, appropriate authentication and authorization is obtained, and media message content 401 is accessible. This also applies recursively to peer and child sub-trees to which HlocM may refer. Further, media message content 401 may be referenced (link 481) from media message object 480, as illustrated in FIG. 7B. Message media profiles 414, 424, 461, media message objects 410, 416, 420, 480, and media message contents 401, 419, 421 may exist on one machine, or may be distributed across different machines that may or may not be disparate or similar, spatially collocated or geographically separated.

Any number of independent and/or dependent markups can be generated using a text-based markup language syntax (e.g., XML or an XML derivative). Each markup may have a root node that may incorporate other markup nodes. Accordingly, markups may be entirely distributed across a multiplicity of clients and/or servers.

In another embodiment, when a primary multimedia stream (e.g., audio) is received it is stored for “best-alternative” distribution and delivery. The storage format of the multimedia stream is machine-readable. One or more secondary multimedia streams (which may have been previously stored) of equal or unequal length may then be combined with the primary multimedia stream, e.g., by mixing means suitable for the format of the multimedia stream's encoding. The aggregate stream may then be used as a surrogate for the original primary stream. Should a secondary stream be shorter in length than the primary stream, the mixing of the secondary stream may either conclude when the secondary stream is exhausted, or the secondary stream may replay, or “loop,” from its beginning (over as many times as necessary or desired to combine it with the entirety of the primary stream).

Further, should the secondary stream be longer in length than the primary stream, only a set of one or more fragments of aggregate time length equal to that of the primary stream is used from the secondary stream when combined with the primary stream.

Further, users may catalog and archive all messages in order to meet regulatory requirements imposed by federal law, state law, or other governing or regulating authorities.

In another embodiment, markups provide for insertion, cropping, and deleting one or more original message segments and for adding audio-over, subtracting audio-under, and/or filtering without affecting content of the original message.

In yet another embodiment, peering markups may provide for:

Augmenting (e.g., combining) media-over at a time-tagged point; this can include a silence or blanking interval as well as an active interval;

Inserting (e.g., interjecting) media-in into a media message at a time-tagged point;

this can include a silence or blanking interval, as well as an active interval; and

Specifying a media-filter to be applied to the entire message or a predetermined segment of the message.

In another embodiment, child markups may start an independent set of peering markups.

In another embodiment, a terminal apparatus is provided as a user input/output device for messaging, one example being that of combined platform 790, FIG. 2. Certain methods herein may be employed with the terminal apparatus. The terminal apparatus may attach and/or integrate into other telecommunications and computer systems.

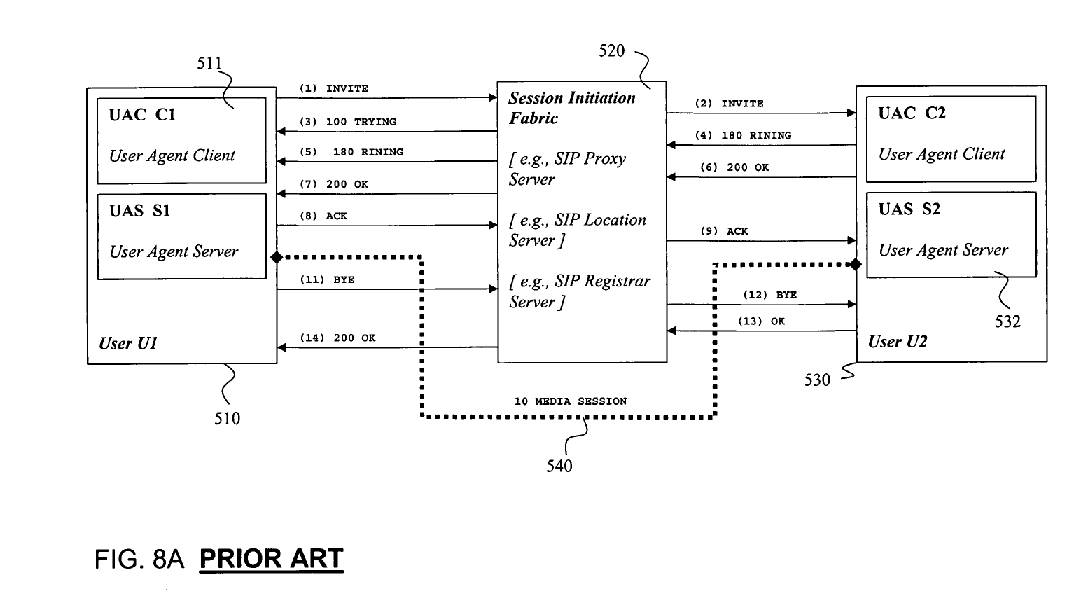

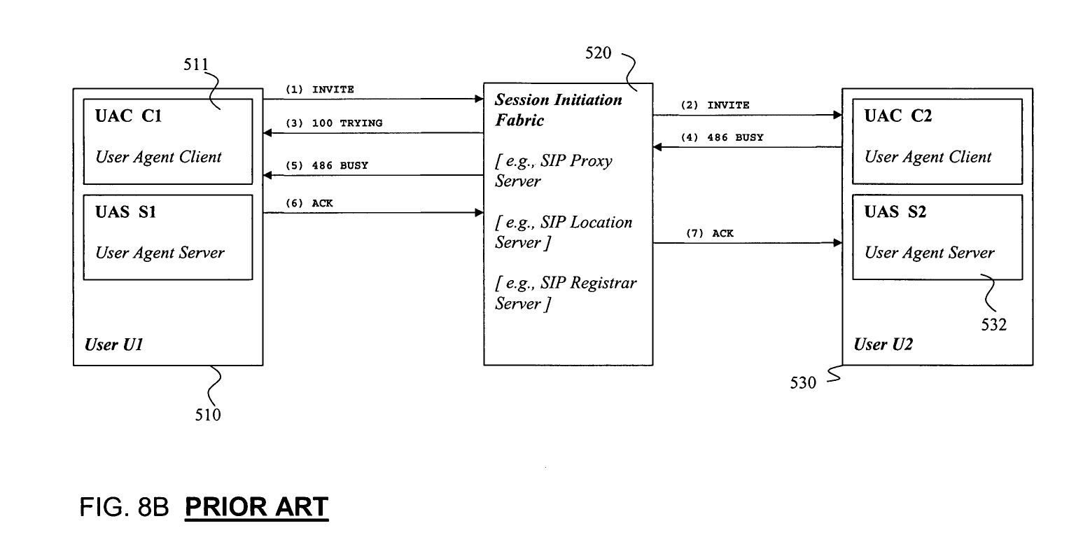

FIG. 8A, representative of the prior art, illustrates one exemplary use of the Session Initiation Protocol (SIP) as described by IETF RFC 3261. A first user at an ETD 510 instructs an SIP user agent client (“UAC”) 511 to contact a second user at an ETD 530 who is represented by an SIP user agent server (“UAS”) 532. Said contact may or may not occur using the facilities of one or more proxy, location, or registrar SIP servers 520 as defined by IETF RFC 3261. If UAS 532 is capable and is of a disposition to accept a session request and message, a session is established and the message is transmitted as media stream 540, as prescribed by a session description and a real time transport protocol. Such transactions are described in IETF RFCs 1889 (RTP), 2327 (SDP), and 3261 (SIP).

FIG. 8B, representative of the prior art, is exemplary of a session initiation attempt which is denied by a called user U2. For example, if UAS 532 is not able or in a disposition to accept a session and multimedia message, or there is a network anomaly, then user U1 is denied the session or may be routed or forwarded to a distinctly different endpoint, which may or may not be desirable or efficient.

A common scenario occurs when the called user is currently not willing or able to take additional calls at his or her end system. A “Busy Here” could be returned in such a scenario. If the UAS knows that no other end system will be able to accept the call, a “Busy Everywhere” response may be sent instead (However, it is unlikely that a UAS would be able to make this determination, in general, and thus this response would not usually be used). The response is passed to the INVITE server transaction, which deals with its retransmissions. A UAS rejecting an offer contained in an INVITE may return a 488 (Not Acceptable Here) response. No multimedia session is established.

FIG. 9A illustrates an exemplary media message profile using an XML markup schema 600 to describe the layout of a data structure that can be deployed to manage media markup (see FIG. 7B). Schema 600 includes descriptions for: 1) MediaMesssageObjectURI which may be used to store the location of where the managed media resides using one or more forms as described by IETF RFC 2396; 2) MediaMessageDescriptor which can embody a text string that can be used to briefly describe the current markup, the text string of a varying length; 3) TargetMessageScrollTimeMilliSeconds which is the duration of the media message in milliseconds; 4) MessageMarkUpType can reflect an enumerated value indicating the type of markup, the enumeration containing one or more of, but not limited to, BASE, INSERT, DELETE, BLANK, OVERLAY, AGUMENT, MIX, PRE-PEND or APPEND; 5) MaxNumberOfChildren which contains an integer value, zero or greater, and can be representative of the number of sub-trees that may exist as child media message objects 420, via child-parent back link 422; 6) MaxNumberOfPeers which contains an integer value, zero or more, and can be representative of the number of sub-trees that may exist as peer media message object 416, via peer-peer forward link 415);

7) ProfileCreationTimeSecondsFromEpoch, an integer value that represents the date/time at which the MediaMessageProfile was created; 8) ProfileLifetimeInSeconds an integer value that represents the amount of seconds at which the MediaMessageProfile is considered in-active or expired, this value can be zero to represent there is no expiration; 9) OwnerURI can reference any arbitrary resource to suggest the owner of the object, one such resource might be a SIP URI, such as SIP:John.Doe@DomainName.Com; 10) FilterProfileURI, a URI which may be used to obtain a filter profile schema 680, said filter profile optionally applied to an audio based media message when rendered for transmission; 11) AuthorizationAttributes can represent a string of text that can be used in an authorization scheme, such as providing a logon and/or password; 12) AuthenticationAttributes can represent a string of text that can be used in an authentication scheme, such as providing an X.509 certificate in a PKI key exchange; and 13) AddititionalInformation is a text string of arbitrary length that can optionally be used to provide additional information such as remarks from readers and/or writers.

FIG. 9B illustrates an exemplary media message object using an XML markup schema 640 to describe the layout of a data structure that can be deployed to manage media message object 402 (FIG. 7). Schema 640 includes descriptions for: 1) MediaMesssageContentURI, a URI which may be used to store the location of where the managed media resides; 2) ParentMediaMessageURI, a URI which is used to reference a parent media message in a hierarchical arrangement of media message objects (e.g., media message object 402); 3) MediaMessageReversePeerURI, a URI which is used to reference a peer media message in a hierarchical arrangement of media message objects (e.g., peer-peer back link 417), said peer could appear as a prior sequential element in a list; 4) MediaMessageForwardURI a URI which is used to reference a peer media message in a hierarchical arrangement of media message objects (e.g., peer-peer forward link 415), said peer could appear as a subsequent sequential element in a list; 5) MediaMessageForwardChildURI a URI which is used to reference a peer media message in a hierarchical arrangement 412 of media message objects 410, said peer could appear as a prior sequential element in a list; 6) OversightWebServiceURI a URI which can be used to identify a web service that can be utilized to manipulate a media message object; 7) MediaMessageProfileURI a URI to a media profile as described by XML markup schema 600; 8) ObjectCreationTimeSecondsFromEpoch, an integer value that represents the date/time at which the MediaMessageObject was created; 9) ObjectLifetimeInSeconds an integer value that represents the amount of seconds at which the MediaMessageObject is considered inactive or expired, this value can be zero to represent there is no expiration; 10) OwnerURI can reference any arbitrary resource to suggest the owner of the object, one such resource might be a SIP URI, such as SIP:John.Doe@DomainName.Com. 11) AuthorizationAttributes can represent a string of text that can be used in an authorization scheme, such as providing a logon and/or password; 12) AuthentiicationAttributes can represent a string of text that can be used in an authentication scheme, such as providing an X.509 certificate in a PKI key exchange; and 13) AddititionalInformation is a text string of arbitrary length that can optionally be used to provide additional information such as remarks from readers and/or writers.

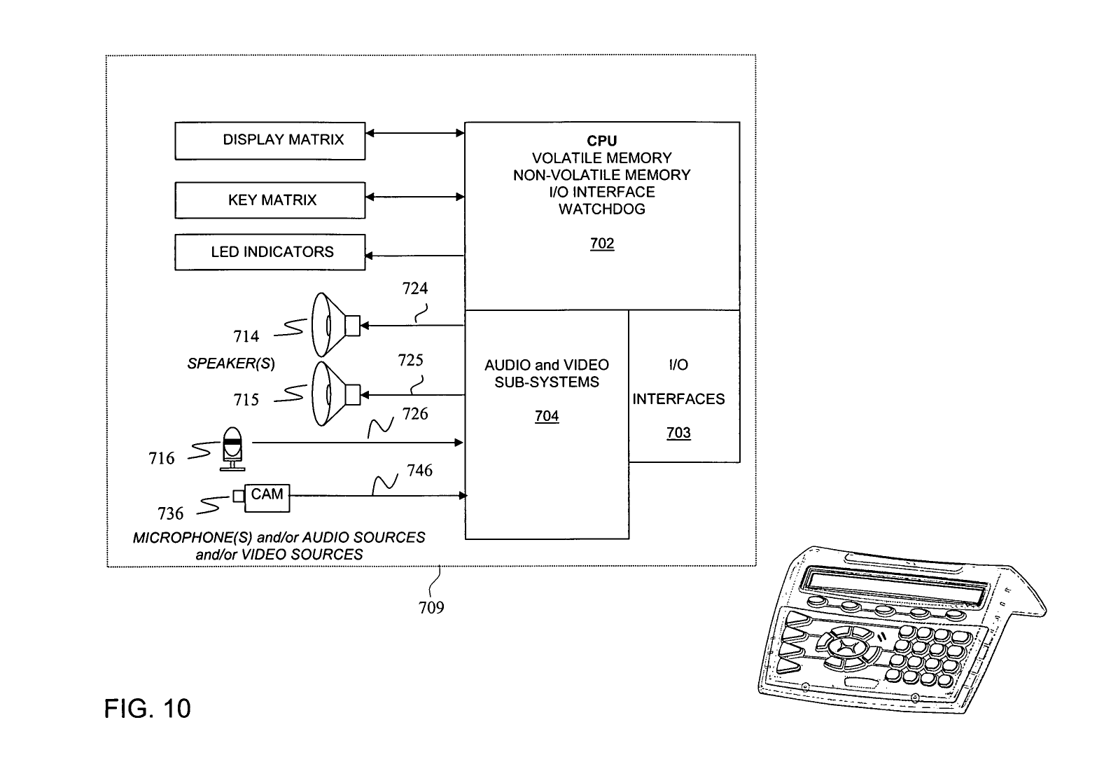

FIG. 10 illustrates one exemplary block diagram of ETD 709, FIG. 2, for further discussion. One method to conduct real-time communications using ETD 709 is to employ SIP (Session Initiation Protocol; IETF 3261), SDP (Session Description Protocol; IETF RFC 2327), and RTP (Real-time Transport Protocol; IETF RFC 1889).

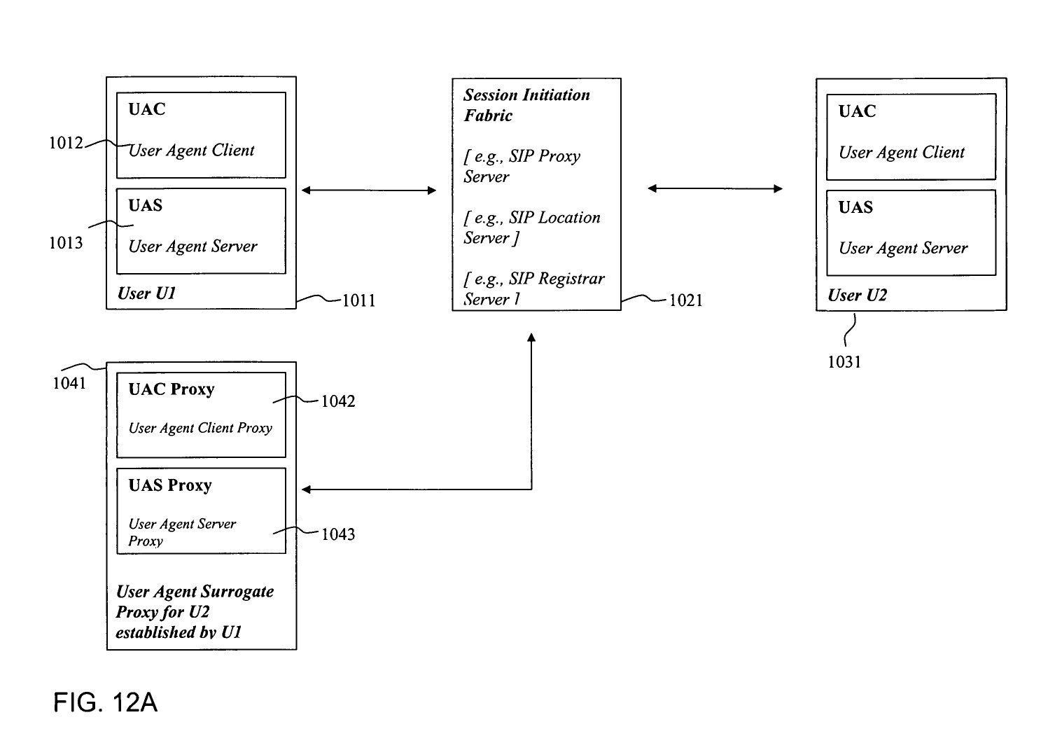

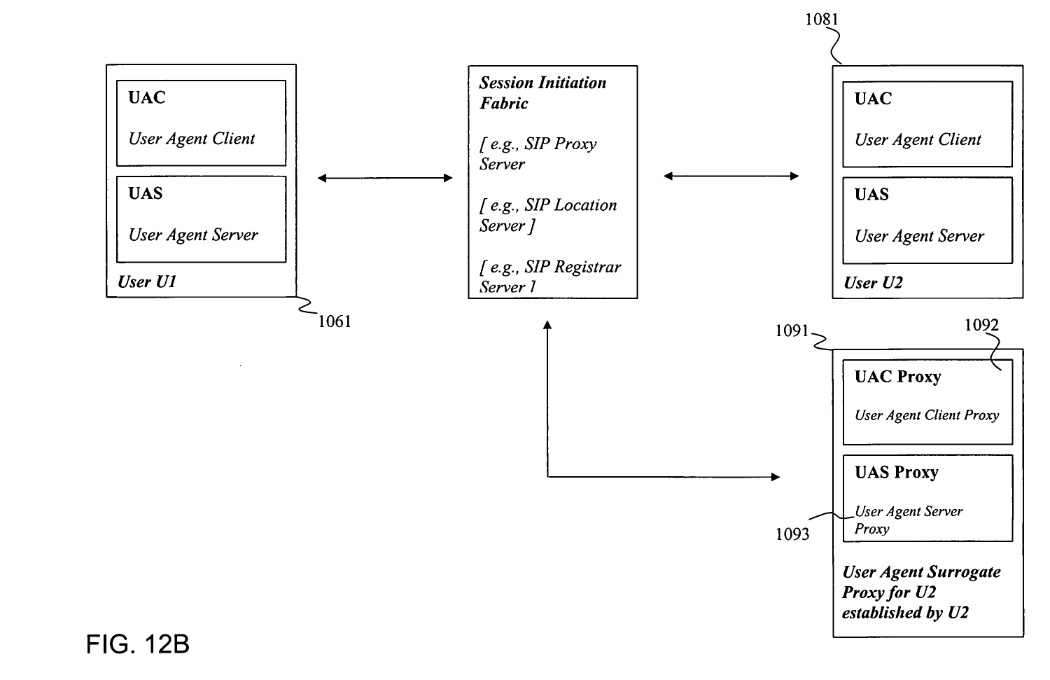

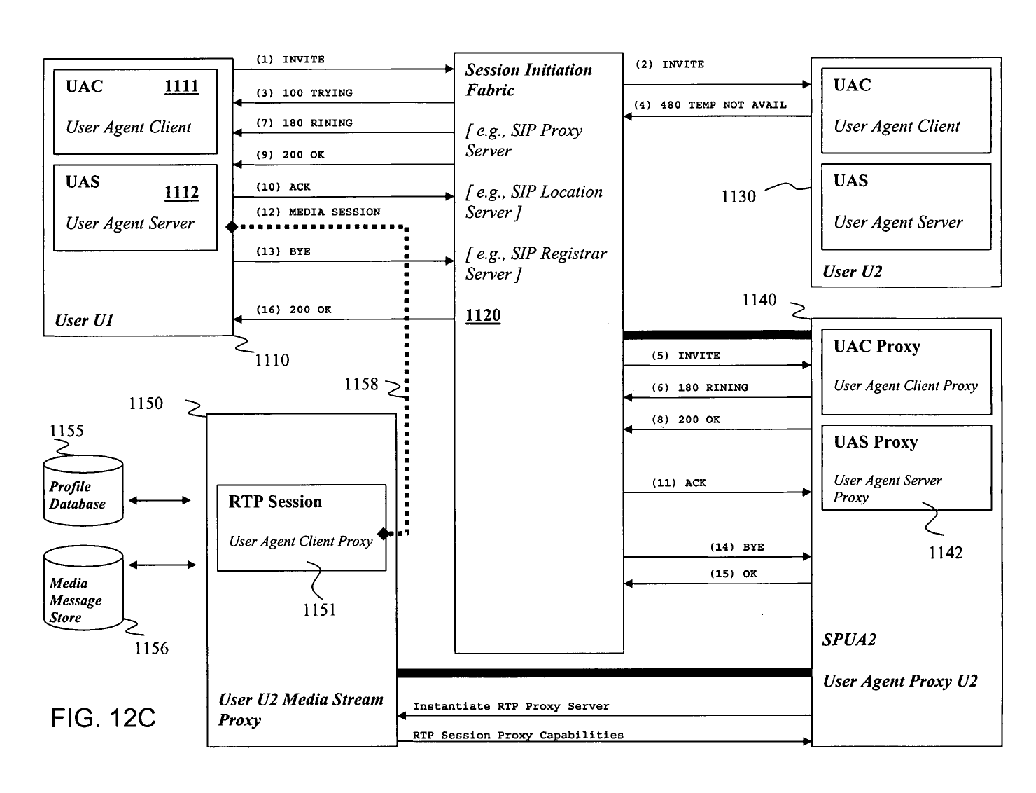

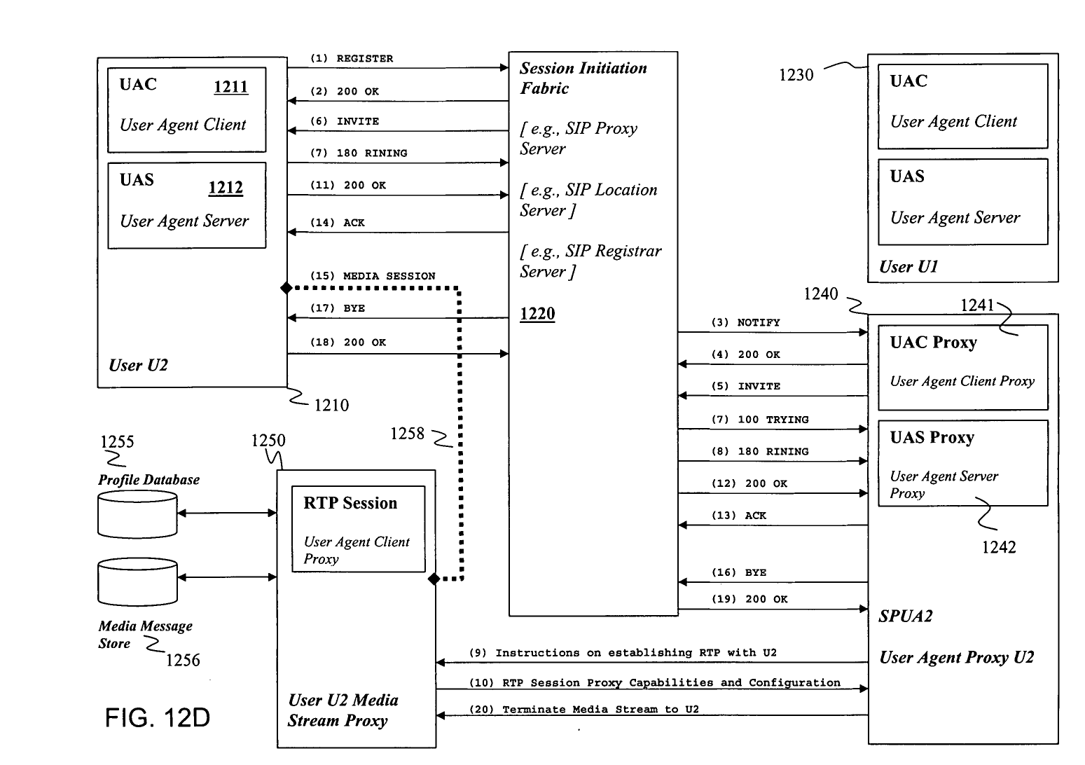

In one embodiment, a user may record, review, and edit a message using an ETD before transmitting to one, or more, recipients (e.g., individuals, groups, or message store), possibly utilizing a set of keys that may have markings 144, 145, 147 (FIG. 4). This is different from using a conventional multimedia program such as a Sound Recorder found in a standard Microsoft Windows installation, creating a .WAV file and transmitting it via e-mail using a program such as Outlook™ or other equivalent means, as it differs in one or more of the following ways: 1) only one application and one UI is involved; the experience is simpler; 2) it does not require a user to break focus with an existing application (such as a word processing program) on a Windows desktop to compose a message as the ETD 101 (FIG. 3) is juxtaposed and can operate autonomously from a Windows UI interface devices, such as the mouse and keyboard; 3) since it is physically juxtaposed to a Windows desktop, it does not clutter the Windows desktop (client area on the display's desktop) with per-session, per-conversation or per-login windows; 4) it offers much simpler semantics whereby a message can be composed and sent to a list of predetermined recipients with one button press, i.e., one button in button group 130 (FIG. 3), marking 143 (FIG. 4); the required interaction from a user is negligible; 5) the media message (audio and/or video) can be recorded on server 1150 by directly capturing the RTP stream 1158 on the server 1150, FIG. 12C, and thus not require local storage resources on the client platform; 6) it provides a set of editing controls, e.g., marked by markings 145, FIG. 4, not normally found with telecommunication or messaging hardware apparatus that are used to mange composition, review, edit and markup (see FIG. 7) of media messages.

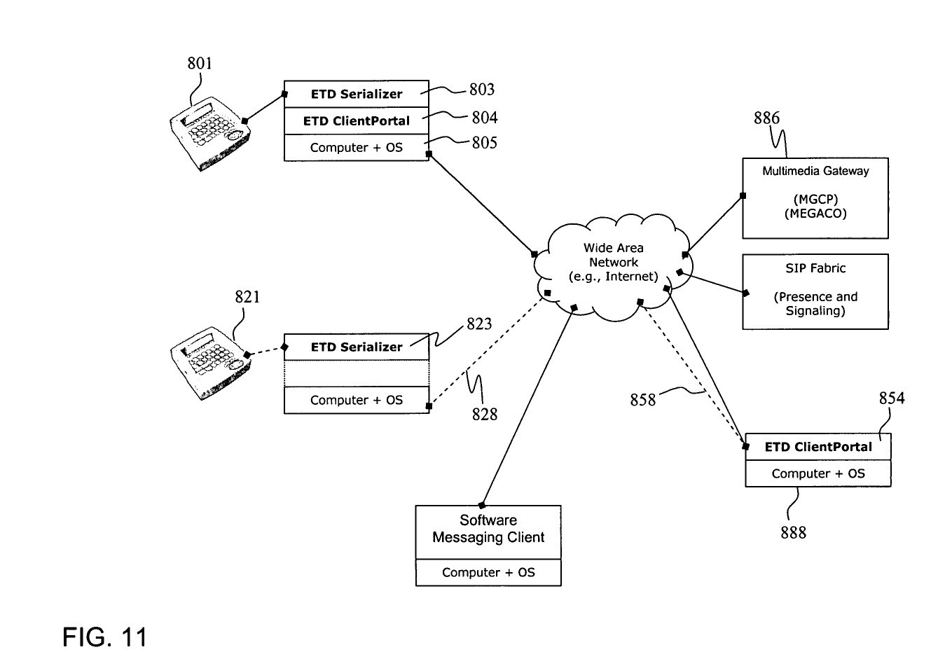

FIG. 11 illustrates one exemplary interrelationship among media messaging system components. Users operating ETDs 801 and 821 may perform a plurality of tasks to manage composition, combination, storage, transmission and reception of multimedia messages, thus freeing a user from having to interact with application software on a computing device such as a PC, PDA, or tablet. In one example, ETDs 801 and 821 may represent ETD 709, and/or combined platform 790, FIG. 2.

As user interacts with ETD 801 and provides input keystroke events that are detected and assigned to processes or threads that carry out one or more predefined semantic execution assignment(s). Some examples of specific predetermined semantic assignments may be: injecting an event in to a Windows™ message loop, resuming a blocked process or thread, pulsing a monitor, and/or signaling an event. These semantics provides a general-purpose facility by which Windows™ based applications and services can directly interact with an external peripheral device whose function can represent, but not be limited to, a telecommunications apparatus, which can be employed to compose, edit, organize and review multimedia messages.

UI event management may be accomplished by creating message serializer 803, 823 to package, or encapsulate, messages containing display instructions or detected events for transmission to and/or from a listening entity, such as a local processing element ETD client portal 804 or remote processing element ETD client portal 854. This arrangement provides a means to assign different UI semantics (behavior) to an ETD on a dynamic basis without requiring the alteration of the program store at the ETD 801, 821. Nothing precludes the use of a URL/URI to define which UI semantics are selected and used to interpret serialized stream from ETD serializer 823 that is then processed remotely by ETD client portal 854.

ETD 801 may detect a plurality of different keystroke actions, which may include one or more of: 1) a single key press event recognized as a momentary press-hold-release operation, where hold time does not exceed a predetermined maximum duration; 2) a double key press event recognized as two consecutive single key press events where the time in between two single key press events does not exceed a predefined maximum duration; 3) a triple key press event recognized as three consecutive single key press events where the time in between three single key press events does not exceed a predefined maximum duration; 4) a key-down event recognized as a press-and-hold operation where the hold time meets or exceeds a predefined minimum duration; and 5) a key-up event recognized when a key, which is currently in the key-down state, is released.

In another embodiment, ETD 801 and a computer 805 may be in close proximity (e.g., in a local area). ETD 801 UI and its processing elements are bifurcated so that events, such as presses of key matrix 712, FIG. 2, may be detected and serialized by serializer 803 for transmission to entities desiring to listen for them. Such listening entities may be locally attached with a short-haul communications link (e.g., communication channel 718) or such entities may be located anywhere on a LAN (e.g., accessed by hub 791) or WAN (e.g., network 792 and Internet). One method provides for remote control of ETD 821 where ETD UI display instructions (such as graphic and text displays of display 181, FIG. 3, or LED indicatiors 713 (FIG. 2), for example, under any or all keys, e.g., keys/buttons in button groups 121, 130, 141, 151, 161 and 170 (FIG. 3)) and UI events, such that operation of key matrix 712 is managed by remote computer 888, accessible via a network 828, 858, such as a server including ETD client portal 854.

In another embodiment, this system provides a means by which multi media messaging is managed external (e.g., using an ETD 821) to a client PC desktop, and optionally employs a remote server (e.g., server 20, FIG. 1B) to deduce the semantics of user input and provide an appropriate response to the user. Thus, the experience for each user may depend upon a dynamically assigned profile that directs the behavior of the remote server, and its response.

In one embodiment, techniques are provided for delivering audio messages using a “best-alternative” delivery method. One best-alternative method considers a user's currently advertised disposition (presence) and profile preferences and then routes multimedia messages, such as audio messages, for either instantaneous, near instantaneous, or delayed store-and-forward delivery.

In certain embodiments, apparatus and methods are provided to assist in best-alternative delivery of a media message MM, whereby a predetermined set of transport and delivery facilities are considered in rank order and an appropriate transport and delivery facility is selected. Selection may include criteria based on a user's profile, which may dictate preferences, associations with other users, a disposition and presence of other users, and possibly but not necessarily, network conditions. Transport and delivery facilities may consist of 1) a real-time communications channel such as one employing RTP; 2) a near-real-time channel that buffers and streams media messages (i.e., media message 400, FIG. 7), but does not necessarily place emphasis on real-time delivery constraints such as latency, QoS (Quality of Service), packet loss, Automatic Gain Control (“AGC”), Automatic Echo Cancellation (“AEC”), etc.; and/or 3) a channel may explicitly store messages (i.e., media message 400) with an imposed delay in delivery of the message.

FIG. 12A illustrates one exemplary method of creating a SIP UAC/UAS surrogate and RTP surrogate proxy 1041 on behalf of a client 1012, and an interaction with it. A first user at ETD 1011 attempts to send a media message to a second user at ETD 1031. ETD 1031 is unable or not of the disposition to accept the media message, and session initiation fabric 1021 informs ETD 1011 that delivery is not possible. ETD 1011 may therefore dynamically create a surrogate SIP UAC 1042 and a surrogate UAS 1043 (using ETD 1041), which may persist as a surrogate to manage delivery of the multimedia messages on behalf of ETD 1011. The delivery may be a best-alternative delivery means to ETD 1031, such as when it is disposed to accept incoming sessions, messages, and media streams. FIG. 12A is not limited to using an ETD as a SIP UA for user U1 at ETD 1011 and or user U2 at ETD 1031; the ETD may serve as one example embodiment of an SIP UA 1011, 1031.

FIG. 12B illustrates one exemplary method of creating a SIP UAC surrogate proxy 1091 where the originating calling client may not create a surrogate proxy. A first user at ETD 1061 sends a media message to a second user at ETD 1081. However, ETD 1081 is unable or not of the disposition to accept the media message. In this example, ETD 1061 is unable to create a surrogate proxy. Therefore ETD 1081 creates surrogate UAS/UAC proxies 1092 and 1093. ETD 1081 dynamically creates surrogate proxy 1091 to persist as a surrogate proxy on its own behalf. Surrogate proxy 1091 may manage the delivery of a multimedia message on behalf of receiving (called) ETD 1081, using best-alternative delivery semantics, from another originating or sending endpoint, such as ETD 1061. Nothing precludes the surrogate proxy 1091 from attempting to contact a plurality of “called” parties, or endpoints, simultaneously (concurrently) to deliver a multimedia message (e.g., in a broadcast fashion). FIG. 12B is not limited to using an ETD as a SIP UA for user U1 of ETD 1061 and/or user U2 of ETD 1081; the ETD may serve as one example embodiment of an SIP UA 1061, 1081.

FIG. 12C illustrates one exemplary method of originating surrogate SIP UAC 1111 and UAS 1112 and a media stream proxy 1150 to receive and possibly store multimedia content. A first user at ETD 1110, attempts to send a media stream 1158 to a second user at ETD 1130. However, user U2 and its UA, ETD 1130, is unable or is not a disposition to receive the media stream and therefore, optionally using session initiation fabric 1120, ETD 1130 may create a surrogate proxy 1140. Surrogate proxy 1140 may then act as virtual SIP UAS 1142 on behalf of ETD 1130 to establish a multimedia communication session, instantiate media stream proxy 1150 to receive media stream 1158 as specified by UAC 1111 of ETD 1110, and insertion of the media stream 1158 in storage 1156. Upon completion of receiving and storing of the media stream, surrogate proxy 1140 may persist for a predetermined amount of time and monitor the disposition of ETD 1130 and then attempt a best-alternative delivery of the stored media message of media stream 1158 from storage 1156. FIG. 12C is not limited to using an ETD as a SIP UA for user U1 of ETD 1110 and/or user U2 of ETD 1130; the ETD may serve as one example embodiment of a SIP UA 1110, 1130.

FIG. 12D illustrates one exemplary method of retrieving stored multimedia content and transmitting it to one or more recipients. A surrogate SIP UAC 1241, surrogate SIP UAS 1242 and a media stream proxy 1250 exist, and the multimedia content is stored on media message store 1256 of a media stream proxy 1250. When ETD 1210 becomes of a disposition to accept the multimedia content stored by a media stream proxy 1250, it is then delivered on behalf of a first user of ETD 1230 by surrogate proxy 1240, which acts as a surrogate (or virtual) SIP UAC 1241 on behalf of ETD 1230, establishes a session with UAS 1212 of ETD 1210, and spools (as in media stream 1258) the stored multimedia content from storage 1256 as specified by UAS 1212. The message may be delivered to a surrogate representing an original “called” endpoint 1212, and if not, it is forwarded to another uniquely distinct endpoint (e.g., a voicemail system or client) or rejected. When an original endpoint is capable of receiving a message, it may then be delivered by the UAS/UAC Surrogate Proxy. Surrogate proxy 1240 (and proxy 1140, FIG. 12C) is not a presentity or a distinct end-point, rather it becomes a virtual surrogate UAS/UAC for the presentity and distinct endpoint ETD 1210 (ETD 1130, FIG. 12C). Multiple active instances of UA surrogate proxy 1240 on behalf of UAC/UAS of ETD 1210 may be concurrently active. Multiple active instances of media stream proxy 1250 may be concurrently active. Multiple active instances of a media stream proxy 1250 may be used to broadcast a multimedia stream or message to one or more presentities as defined by a predetermined group list—as individual presentities become available, or disposed to accept a multimedia session, the multimedia message, comprised of text, and/or audio and/or video, is then delivered. There may be a timer or expiration interval, managed by session profile 1255, monitoring messages queued or stored in storage 1256 in a surrogate media stream proxy, which may optionally redirect a message at a later time. An originating (calling) client's session management protocol service provider created virtual UAC proxy 1240. In one embodiment, the WinRTP open source platform can be used in combination with Microsoft's Live Communication Server to exercise the semantics of the User Agent surrogate proxy described herein. FIG. 12D is not limited to using an ETD as an SIP UA for user U1 of ETD 1230 and/or user U2 of ETD 1210; the ETD may serve as one example embodiment of an SIP UA 1210, 1230.

The session initiation fabric 1220 creates surrogate UAS/UAC proxy 1240 and media stream proxy 1250 on behalf of either user U1 or user U2, or both, depending on parameters specified in one or more predetermined configuration databases accessible by the session initiation fabric 1220. In another embodiment, certain methods are provided to manage a media storage and delivery system that utilizes a session management protocol (e.g., SIP) and network signaling fabric. Such methods may not require a calling party, calling a non-multimedia enabled party, to endure redirection to a multimedia enabled party. Redirection may include other endpoints in a network fabric capable of accepting a call request.

In another embodiment, methods are provided for dynamic creation of a surrogate SIP UAC (User Agent Client) and UAS (User Agent Server) that may persist as a proxy to deliver a multimedia message on behalf of a sending (i.e., calling) client, using predetermined best-alternative delivery strategy, to a recipient. On behalf of a user (“U1”), an SIP UAC (“C1”) attempts to contact another user (“U2”), as represented by an SIP UAS (“S2”). If S2, representing user U2, is capable and willing to establish a session and accept a multimedia message stream, the message is then transmitted utilizing a session initiation and management fabric and a real time transport protocol. If, however, the S2 representing user U2 is not capable of or willing to accept the session or message, or if there is another reason that precludes real-time session establishment, a server element then creates a virtual SIP UAC (“VC1”) on behalf of user U1. VC1 first acts as virtual SIP UAS (“VS2”), on behalf of user U2 (S2), and accepts the incoming session, receives the multimedia message from U1, and stores it. After receiving and storing the message, VC1 then persists for a predetermined length of time and monitors the disposition of user U2 through notifications (e.g., SIP NOTIFY) and/or repeated session initiation attempts (e.g., SIP INVITE). When user U2 becomes available by establishing a session in order to accept the multimedia message stored by VC1, it is then delivered on behalf of user U1 by VC1 to user U2's UAS (S2).

In another embodiment, user UI may perform other tasks, or go off-line, having conducted a “real-time conversation” with a surrogate proxy. The surrogate proxy queues the message for delivery, under the guidance of U2's presence and disposition, for delivery to the recipient U2. In one aspect, calling users are not required to use a voice-mail system to store the message. In one aspect, the session and message are not forwarded to a recipient other than the one originally sought—it is stored and delivered at the most appropriate time. This method is symmetric and allows for a surrogate proxy VC2 to be established by U1, U2, or a session initiation and signaling fabric to act on behalf of U2.

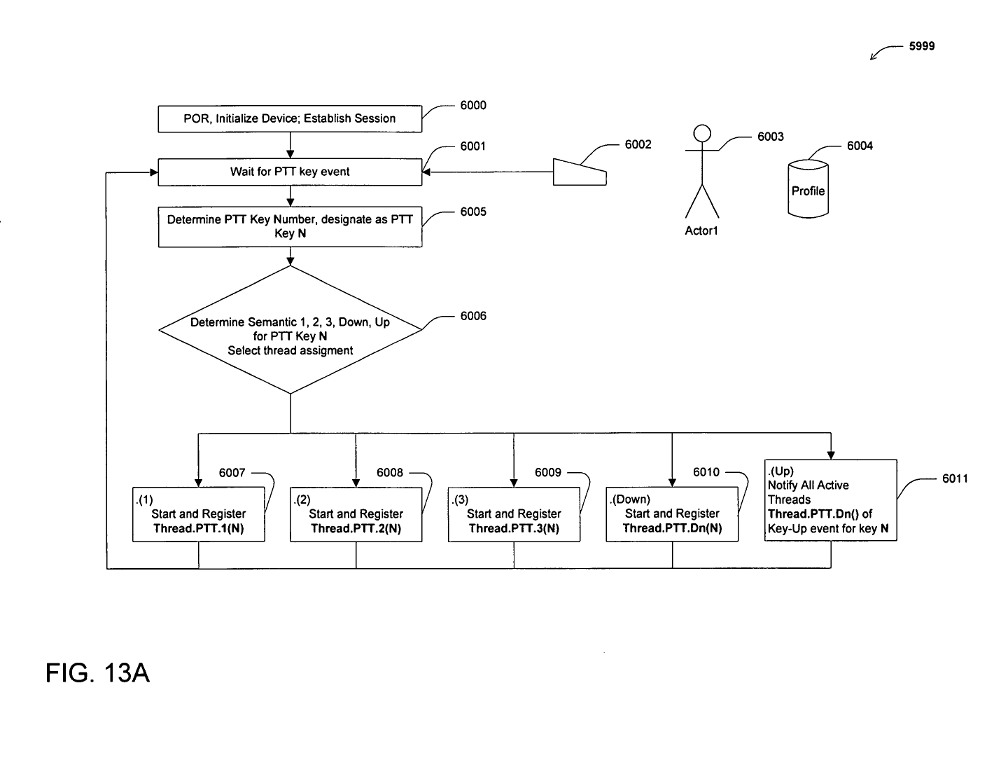

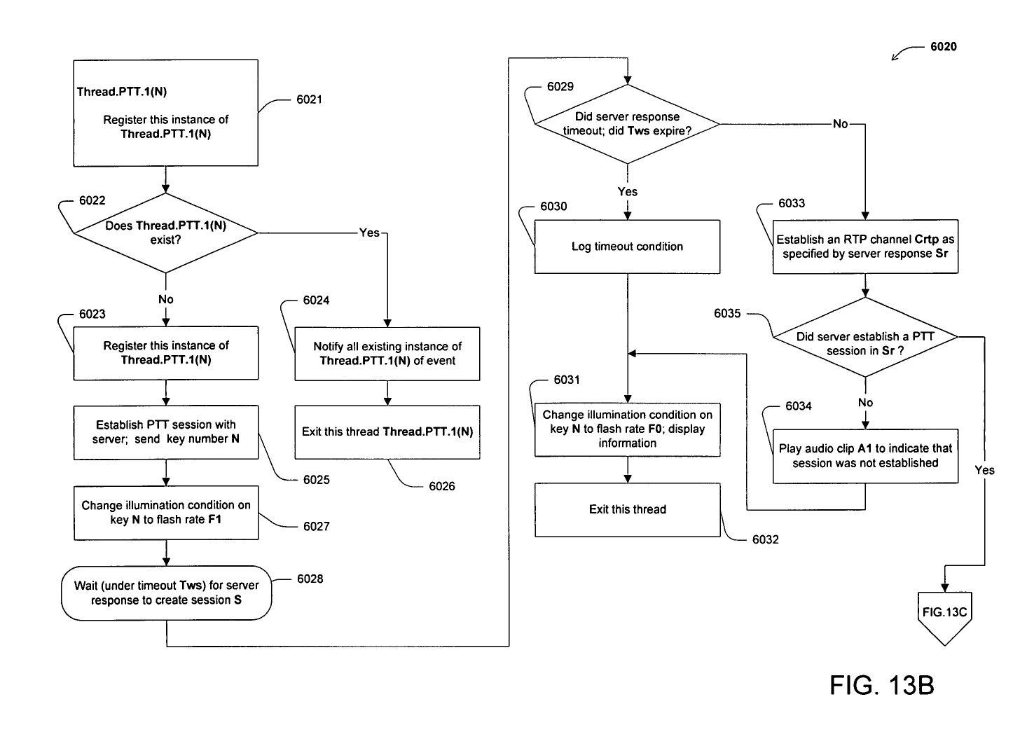

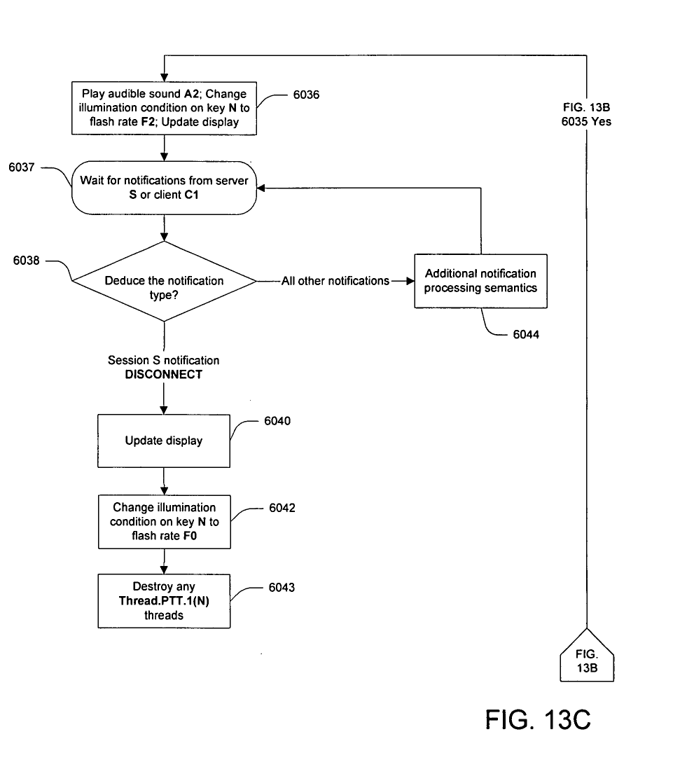

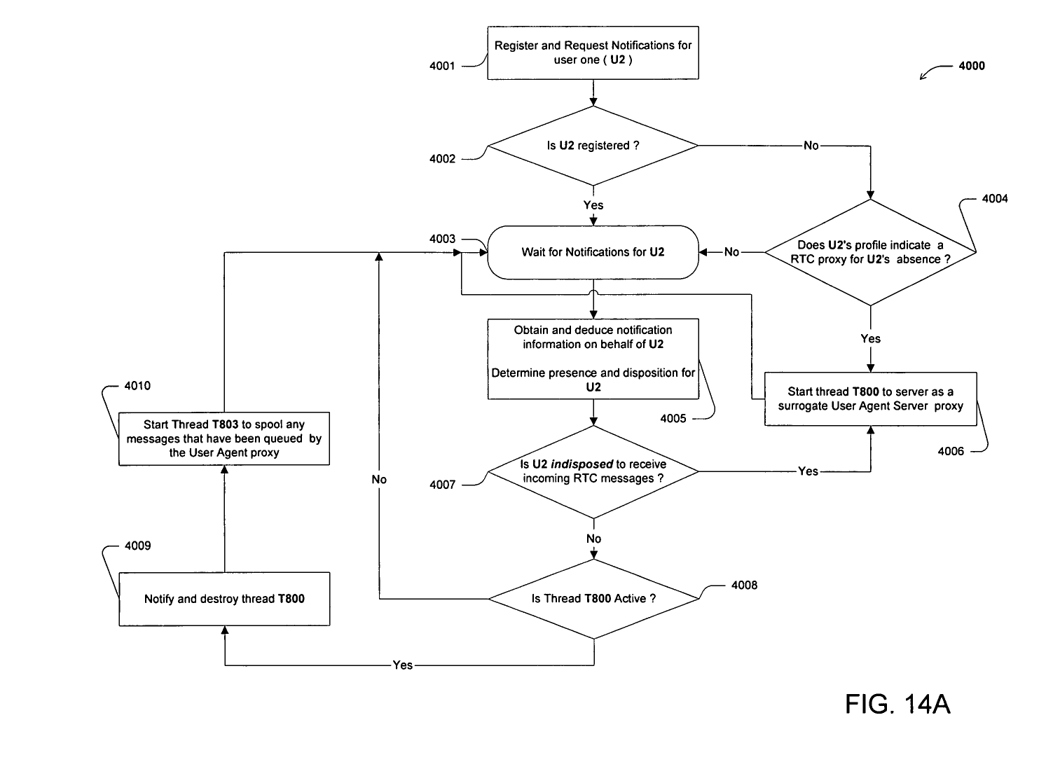

FIG. 13A is a flowchart illustrating one exemplary process 5999 for managing a UI where a user 6003 operates one or more keys on a keypad 6002. As keystrokes are detected they are examined to see if they are pre-designated as a PTT (Push To Talk, Intercom) key 6001, 6005. For a given PTT key N, an operation semantic of one, two, or three clicks. In one example, an architecture provides for user event generation. Such events may include a single key press, double key press, triple key press, key-down and/or key-up. A single key press event may be recognized as a momentary press-hold-release operation, where the hold time does not exceed a predetermined maximum duration. A double key press event may be recognized as two consecutive single key press events where the time in between the two single key press events does not exceed a predefined maximum duration. A triple key press event may be recognized as three consecutive single key press events where the time in between the three single key press events does not exceed a predefined maximum duration. A key-down event may be recognized as a press-and-hold operation where the hold time meets or exceeds a predefined minimum duration. A key-up event may be recognized when a key, which is currently in the key-down state, is released.

Process 5999 begins with step 6000 where a power on reset causes a device initialization and a session to be established. In step 6001, process 5999 waits for a PTT key event. In step 6005, process 5999 determines which key (N) was pressed to cause the key event detected in step 6001. In step 6006, process 5999 determines the semantic of key N, detected in step 6001. If, in step 6006, process 5999 determines that a single click event occurred for key N, then process 5999 continues with step 6007. If, in step 6006, process 5999 determines that a double click event occurred for key N, then process 5999 continues with step 6008. If, in step 6006, process 5999 determines that a triple click event occurred for key N, then process 5999 continues with step 6009. If, in step 6006, process 5999 determines that a key-down event occurred for key N, then process 5999 continues with step 6010. If, in step 6006, process 5999 determines that a key-up event occurred for key N, then process 5999 continues with step 6011.

In step 6007, process 5999 starts and registers a thread (Thread.PTT.1(N)) to handle the single click event (for key N) detected in step 6001. Process 5999 then continues with step 6001. In step 6007, process 5999 starts and registers a thread (Thread.PTT.2(N)) to handle the double click event (for key N) detected in step 6001. Process 5999 then continues with step 6001. In step 6007, process 5999 starts and registers a thread (Thread.PTT.3(N)) to handle the triple click event (for key N) detected in step 6001. Process 5999 then continues with step 6001. In step 6007, process 5999 starts and registers a thread (Thread.PTT.Dn(N)) to handle the key-down event (for key N) detected in step 6001. Process 5999 then continues with step 6001. In step 6007, process 5999 starts and registers a thread (Thread.PTT.Up(N)) to handle the key-up event (for key N) detected in step 6001. Process 5999 then continues with step 6001. Process 5999 repeats steps 6001, 6005, 6006, 6007, 6008, 6009, 6010 and 6011 for each key event detected in step 6001.

FIG. 13B illustrates one exemplary process 6020 for Thread.PTT.1(N), created in step 6007 of process 5999. In step 6021, process 6020 attempts to register itself. Step 6022 is a decision. If, in step 6022, process 6020 determines that other instances of process 6020 (Thread.PTT.1(N)) exist, process 6020 continues with step 6024 and then exits in step 6026; otherwise, process 6020 continues with step 6023. In step 6023, process 6020 continues to register itself. In step 6025, process 6020 establishes a session with an associated server S and sends a message to the server indicating that key N is currently being processed by process 6020. Associated server S comprises of at least one Session Service Group (see session service group 350, 360 FIG. 6) and the thread Thread.PTT.1(N) running on a client C1 terminal (FIG. 2) 701, 712. In step 6027, process 6020 (Thread.PTT.1(N)) changes the illumination of key N to a predetermined flash rate (e.g., flash rate F1) to indicate that key N operation was recognized and server S was notified. In step 6028, process 6020 waits for a predetermined amount of time (e.g., using a timer Tws) for a response from server S. Step 6029 is a decision. If the timer set in step 6028 (i.e., timer Tws) expired, process 6020 continues with step 6030; otherwise process 6020 continues with step 6033. In step 6030, process 6020 logs the timeout, and in step 6031, process 6020 sets the flash rate for illuminating key N to F0. Process 6020 then terminates in step 6032.

In step 6033, process 6020 opens and establishes an RTP channel Crtp as specified in the server's response Sr, (one such example of channel Crtp using the SurrogateProxy as described in FIG. 12A, B, C, D). Step 6035 is a decision. If server S did not indicate that the session (e.g., the session of type PTT_SESSION) was created, process 6020 continues with step 6034; otherwise process 6020 continues with step 6036, FIG. 13C. In step 6034, process 6020 plays a predetermined audio clip (e.g., audio clip A1) for the user (e.g., user of ETD 709, FIG. 10) via audio outputs 714, 715. Process 6020 then continues with step 6031. Audio clip A1 may be one of, but is not limited to: 1) one or more tones; 2) a prerecorded spoken help message; 3) music.

FIG. 13C is a continuation of FIG. 13B as indicated by page connectors. In step 6036, process 6020 plays a predetermined audio clip (e.g., audio clip A2) for the user, the illumination for key N is changed to a flash rate F2 and a display (e.g., display matrix 711) may be updated in step 6037, process 6020 then waits for notifications from either server S or client C1. Step 6038 is a decision. If the notification received in step 6037 is of type DISCONNECT, then process 6020 continues with step 6040; otherwise process 6020 continues with step 6044. In step 6040, process 6020 updates the display (e.g., display matrix 711) and in step 6042, process 6020 sets the flash rate for key N to a predetermined flash rate (e.g., flash rate F0). Process 6020 then terminates in step 6043.

In step 6044, process 6020 applied additional processing semantics, and continues with step 6037. Steps 6037, 6038 and 6044 may therefore repeat until a DISCONNECT notification is received from server S or client C1.

Nothing precludes process 6020 from handling double-click and triple-click events key in a similar fashion.

In one embodiment, as events are recognized, they may be forwarded via a communications link (e.g., USB, EIA-232, Bluetooth, 802.11a, 802.11b, 802.11g, etc.) between a terminal apparatus and a PC. A dedicated driver or service on the PC interprets each of these events and, if appropriate, injects a representative message into a message loop or provides a notification to an event handler or dispatcher for all applications eligible and desiring to receive these event notifications. As a benefit, application software developers may continue to write programs using standard techniques for UI event and message management and multiprogramming techniques without having to learn and manage another API and/or protocol in order to interact with a terminal apparatus used for media messaging.

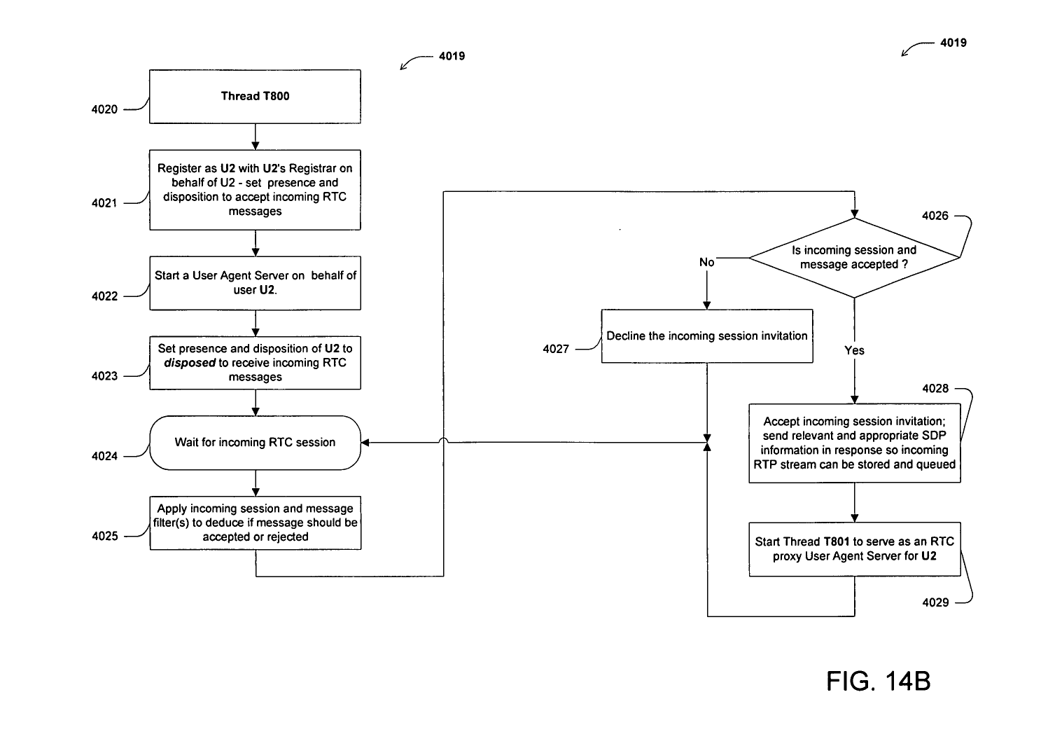

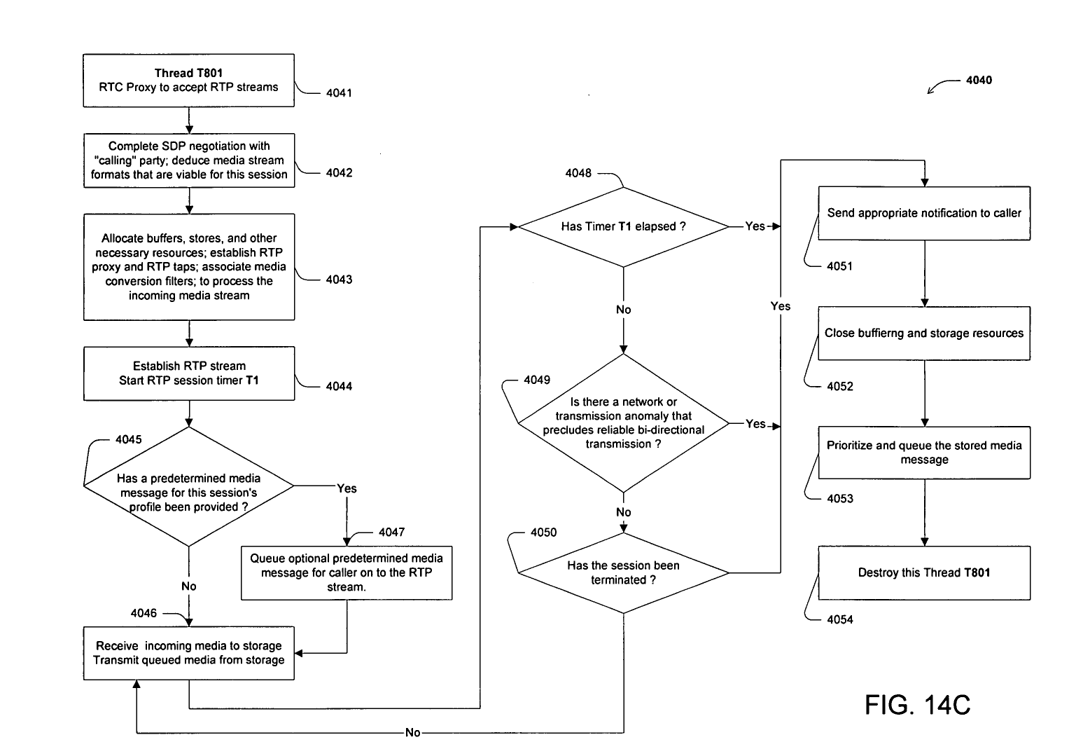

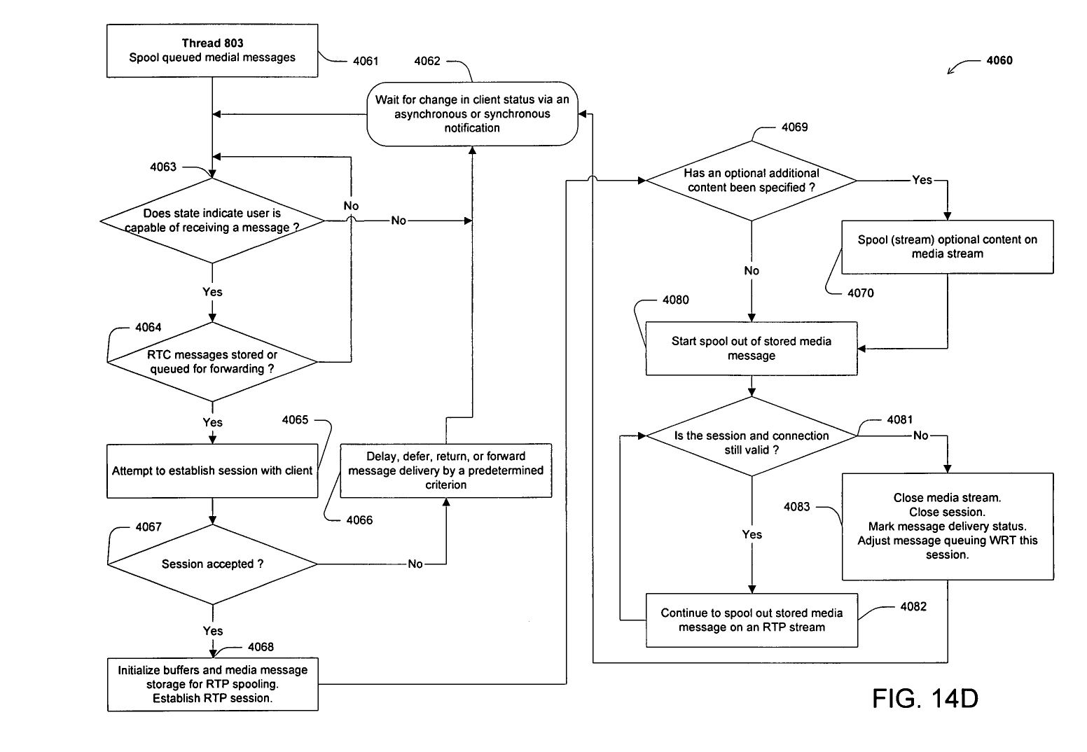

FIG. 14A illustrates one exemplary process 4000 representing a surrogate proxy for a “called” party, (e.g., a party being called by a “calling” party establishes a surrogate proxy). An independent entity, such as U2's UAC/UAS 1081, FIG. 12B, may instantiate a process by which a surrogate proxy acts on behalf of U2 allowing U2 to go “off-line,” or assume a disposition that would normally reject or refuse a request for a real time communication session. The surrogate proxy 1091 (i.e., process 4000) may act on behalf of U2 to accept incoming sessions.

In step 4001, process 4000 registers to receive notifications of the disposition of a user (e.g., user U2). Step 4002 is a decision. If user U2 is off-line or is not registered, process 4000 continues with step 4004; otherwise process 4000 continues with step 4003. Step 4004 is a decision. In step 4004, process 4000 examines an optional profile to determine if U2 desires a surrogate proxy. If U2 does not desire a surrogate proxy, then process 4000 continues with step 4003; otherwise process 4000 continues with step 4006.

In step 4003, process 4000 waits for notifications of U2's disposition. In one example, process 4000 may repeatedly poll U2's disposition at a predetermined interval. In step 4006, a thread T800 is started to manage responsibilities of a surrogate proxy. Process 4000 then continues with step 4003.

In step 4005, process 4000 obtains or deduces a change in U2's disposition (presenece). Step 4007 is a decision. If U2 is indisposed to receive incoming RTC messages, process 4000 continues with step 4006; otherwise process 4000 continues with step 4008.

Step 4008 is a decision. If thread T800 is active, process 4000 continues with step 4009, otherwise process 4000 continues with step 4005. In step 4009, process 4000 notified and destroyed thread T800. In step 4010, process 4000 starts a thread T803 that spools any messages queued by the User Agent Proxy, arrange to send these queued messages to user U2 (e.g., of ETD 1210, FIG. 12D), and then may optionally suppress the surrogate User Agent Proxy, should U2 now indicate that it is of a disposition to receiving incoming sessions. Process 4000 then waits for notifications from U2 4003.

FIG. 14B illustrates one exemplary process 4019 representing a thread a surrogate proxy (e.g., thread T800). Process 4019 is started by step 4020, corresponding to step 4006 of process 4000, FIG. 14A. In step 4021, process 4019 registers the disposition (presence) of user U2 with a registrar (e.g., a SIP registrar, or equivalent; e.g., session initiation fabric 1120, FIG. 12C) or other entity suitable to advertise the presence of user U2's surrogate proxy user agent. In step 4022, process 4019 starts a user agent server on behalf of user U2. In step 4023, process 4019 sets the disposition of user U2 as able to receive incoming RTC messages. In step 4024, process 4019 waits for an incoming RTC session requests. In step 4025, process 4019 examines a predetermined set of criterion to deduce as to whether or not in incoming should be accepted. Step 4026 is a decision. If the incoming RTC session detected in step 4024 is accepted, process 4019 continues with step 4028; otherwise process 4019 continues with step 4027. In step 4027, process 4019 declines the incoming RTC session, and processing continues with step 4024.

In step 4028, process 4019 accepts the incoming RTC session. In step 4029, process 4019 starts a thread T801 to manage the accepted incoming session request and negotiates a format of media streams. Process 4019 then continues with step 4024. Steps 4024 through 4029 are repeated for each incoming RTC session until process 4019 is terminated.

FIG. 14C is a flowchart illustrating one exemplary process 4040 representing a RTP surrogate proxy (one such example shown in media stream proxy 1150, FIG. 12C). Process 4040 (e.g., thread T801) is started by step 4041, corresponding to step 4029 of process 4019, FIG. 14B. In step 4042, process 4040 considers and selects an optimal media format, depending on information provided by a “calling” entity, and allocates appropriate resources in step 4043. In step 4044, process 4040 establishes the RTP stream and starts an RTP session timer Ti. Step 4045 is a decision. In step 4045, if a profile indicates that a predetermined media message has been provided, process 4040 continues with step 4047; otherwise process 4040 continues with step 4046. In step 4047, process 4040 queues the predetermined media message for the caller on the RTP stream. This responding media message may be spooled out (e.g., streamed out) at anytime before, during, or after an incoming media content begins to stream. Process 4040 continues with step 4046.

In step 4046, process 4040 receives the incoming media (e.g., streaming from a “caller” entity) and it sends the outgoing media (e.g., streaming from a “called” entity) from a predetermined message store (e.g., message storage 1256, FIG. 12D). Any multimedia streams that are spooled out may endure a translation that presents the media in a format most suitable for a recipient (e.g., a G.711 stream could be converted to a G.723 stream).

Step 4048 is a decision. If the RTP session timer, Ti, started in step 4044 has elapsed, process 4040 continues with step 4051; otherwise process 4040 continues with step 4049. Step 4049 is a decision. If there is a network or transmission anomaly that precludes reliable bi-directional transmission, process 4040 continues with step 4051; otherwise process 4040 continues with step 4050. Step 4050 is a decision. If the session has been terminated, process 4040 continues with step 4051; otherwise process 4040 continues with step 4046.

Steps 4046 through 4050 are thus repeated until the caller terminates session, an explicit external termination request has been made (e.g., from another process or thread), a predetermined timer elapses 4048, or necessary network facilities are no longer available.

In step 4051, process 4040 sends appropriate notifications to the caller. In step 4052, process 4040 closes buffering and storage resources. In step 4053, process 4040 prioritizes and queues the stored media message, and a transaction history is updated. Process 4040 then terminates at step 4054.

FIG. 14D is a flowchart illustrating one exemplary process 4060 representing a surrogate proxy thread (e.g., thread T803) for the transmission of stored multimedia content. Process 4060 is started in step 4061, corresponding to step 4010 of process 4000, FIG. 14A, when user U2 is again of a disposition to accept incoming sessions (see step 4007, FIG. 14A).

Step 4063 is a decision. If user U2 (e.g., U2 of FIG. 12D 1210) is of a disposition to receive a message, process 4060 continues with step 4064; otherwise process 4060 continues with step 4062. Step 4064 is a decision. If an RTC message is stored or queued for delivery, process 4060 continues with step 4064; otherwise process 4060 continues with step 4063.

In step 4065, process 4060 attempts to contact user U2 and establish a session. Step 4067 is a decision. If the attempted session of step 4065 is accepted, process 4060 continues with step 4068; otherwise process 4060 continues with step 4066.

In step 4066, process 4060 delays, defers, returns or forwards the message delivery as defined by a pre-determined criterion. Process 4060 then continues with step 4062. In step 4062, process 4060 waits for asynchronous or synchronous notification of a change in the client status. On notification of a change in client status, process 4060 continues with step 4063.

In step 4068, process 4060 spools out (streams out) media messages that were accepted and stored by a surrogate proxy (e.g., process 4040, FIG. 12A, or surrogate proxy 1091, FIG. 12B) acting on behalf of user U2. Step 4069 is a decision. If a predetermined profile indicates that additional media streams should be provided, process 4060 continues with step 4070; otherwise process 4060 continues with step 4080.

In step 4070, process 4060 spools optional contents of the media stream established in step 4065. The additional media streams may take any relative time ordering WRT message spooling out (e.g., streaming out) 4080. Process 4060 continues with step 4080.

In step 4080, process 4060 starts the output spooling (streaming). Step 4081 is a decision. If the session is still connected and still valid, process 4060 continues with step 4082; otherwise process 4060 continues with step 4083. In step 4082, process 4060 continues to spool (stream) out the stored message on the RTP stream. Process 4060 continues with step 4081. Steps 4081 and 4082 repeat while the session remains connected and valid.

In step 4083, process 4060 closes the media stream and the session, marks the delivery status of the message and adjusts message queuing with respect to this session.

Using additional media streams may provide, for example, timestamp announcements in serial order between a plurality of spooled (streaming) media messages or overlaying a background (sound over sound) using standard mixing (combining) techniques in processing of a plurality of audio signals. Nothing precludes the use of the media markup tree (as is illustrated by FIG. 7B) to provide a directed source of additional media streams. Processing continues while the session state network facilities are valid 4081, 4082.

Clients may also connect to a server and optionally establish a User Agent (UA) Surrogate Proxy that may persist beyond a user's interactive session and represent the user in their absence, temporary inactivity, or unavailability. Moreover, because the UA Surrogate Proxy may be multi-treaded, it may handle multiple in-bound media connections concurrently and prioritize queued messages, forwarding those with the highest priority first. Optionally, a queued inbound media message may initiate a reply/response message to the sender that is representative of a predetermined set of semantic actions—e.g., an audio prompt such as a beep or a “please leave a short message” announcement—to indicate that the message is being buffered, queued or stored. An optional set of predetermined parameters, such as timer values, may be used to limit the extent resource consumption in the processing of messages based on a predetermined profile for the incoming message (e.g., its priority, its source, etc.).

Standard session management protocols, such as SIP, may be used to establish, manage, and terminate connections.

In another embodiment, a proxy is provided for real-time multimedia (e.g., audio, video) communications by providing a SIP UA Surrogate Proxy, at a predetermined IP address and port, if the client is off-line, indisposed to take the message, or unavailable because of inbound and/or outbound NAT and/or firewall/router issues. The UA Surrogate Proxy may:

advertise a representation of the client if the client is unwilling or unable to receive a multimedia message or stream;

allow multiple concurrent inbound connections to be serviced;

allow multiple concurrent outbound connections to be serviced;

issue a multimedia announcement at the beginning, during, and/or end of a session.

In another embodiment, a set of predetermined profile lists are provided such that a user may specify a plurality of handling options for incoming messages.

In another embodiment, prioritization of RTC and Queued Media Messages (“QMM”) is provided. As QMM managers, or SIP UAC and UAS Surrogate Proxies, are instantiated, they maintain a set of stored messages that are queued for delivery when the presence of a user indicates an ability and disposition to receive said messages. The order of message delivery may be rank-ordered by time of receipt (e.g., FIFO) or another predetermined criterion. A FIFO rank-order (i.e., time-order) ranking may be usurped by a predetermined set of priority specifications. Each priority specification embodies a set of rules that are evaluated as each message is extracted from, or added to, the FIFO queue. The priority specification may be generalized and applied to each message.

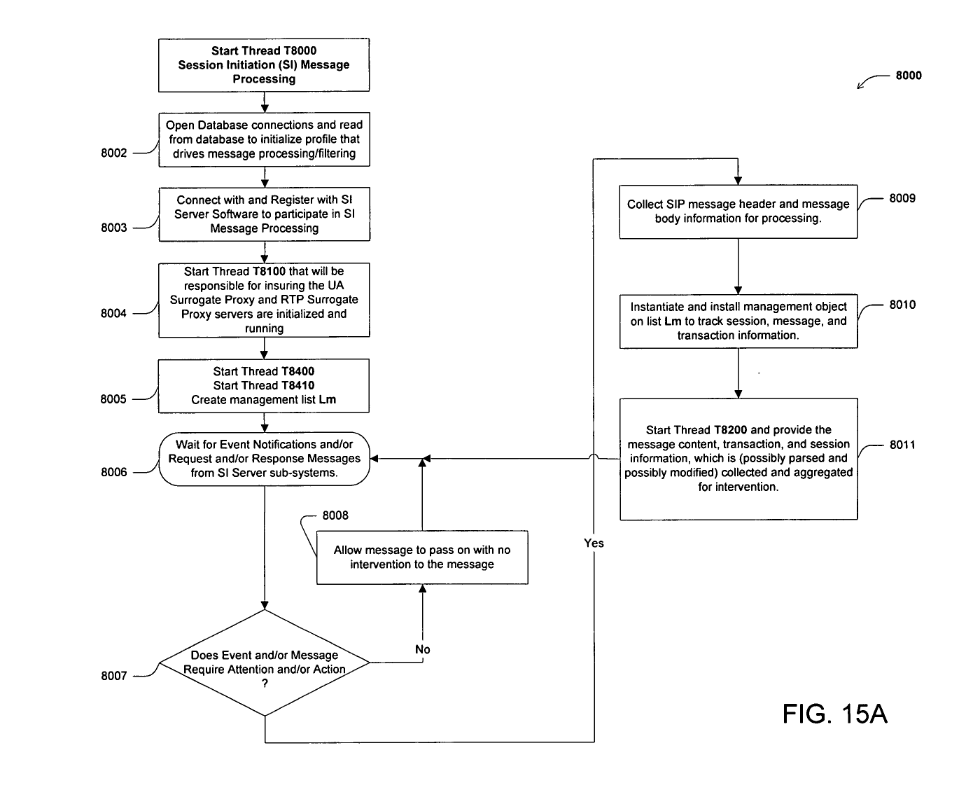

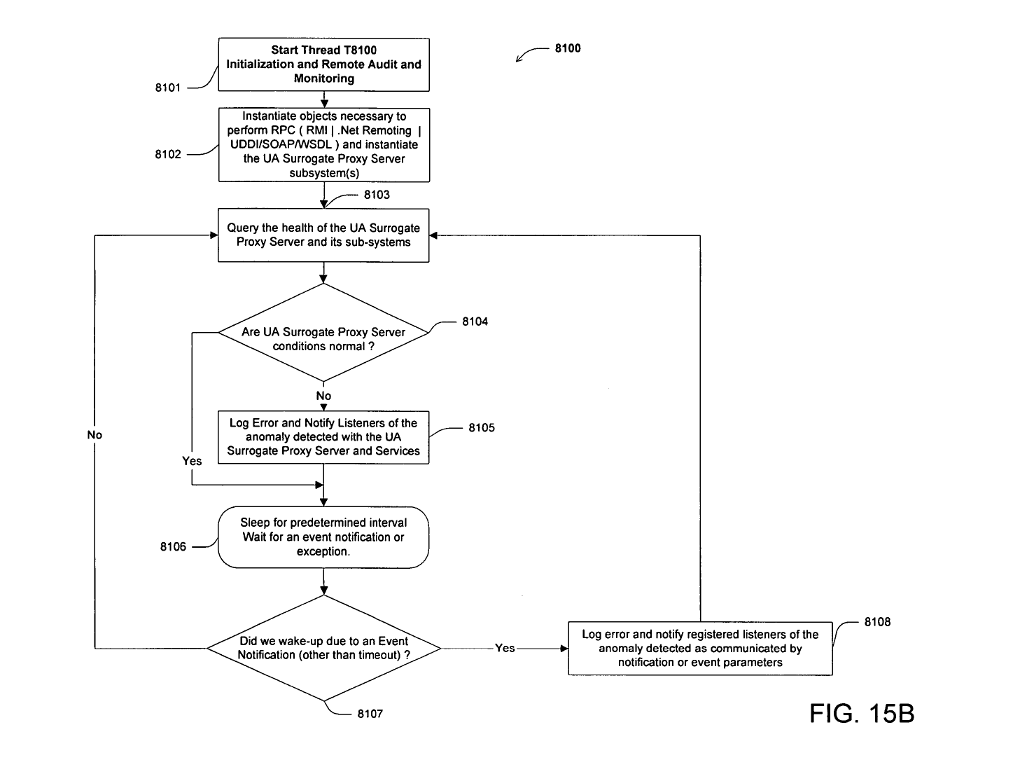

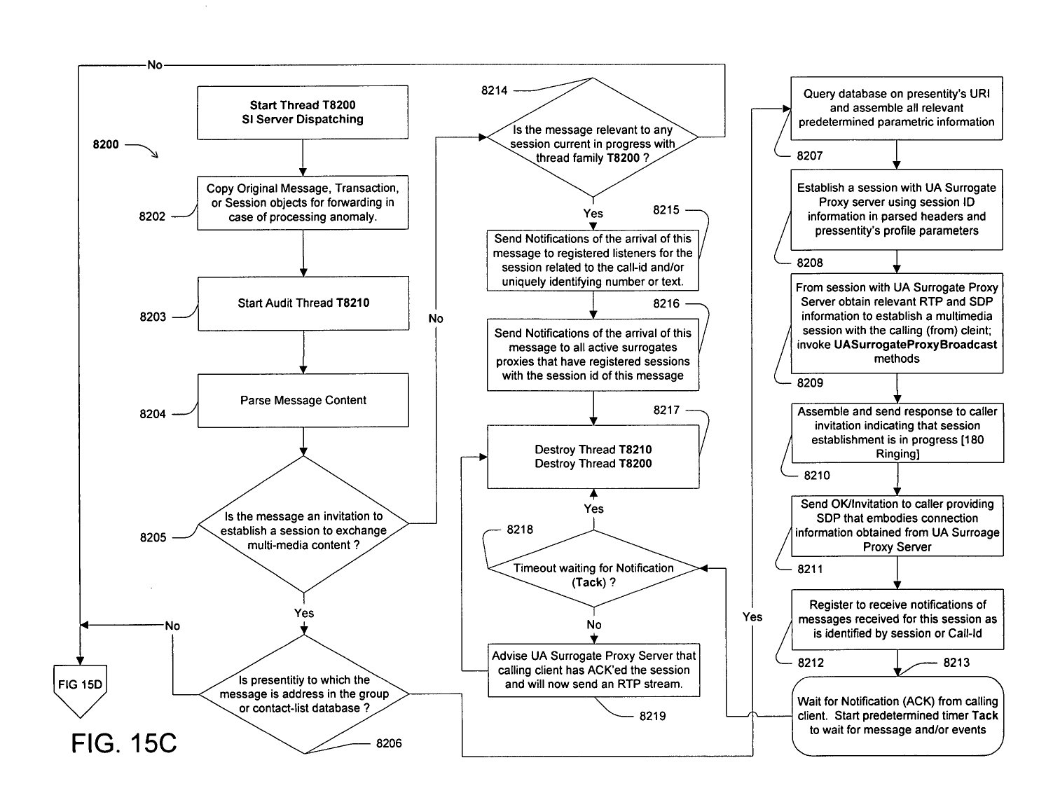

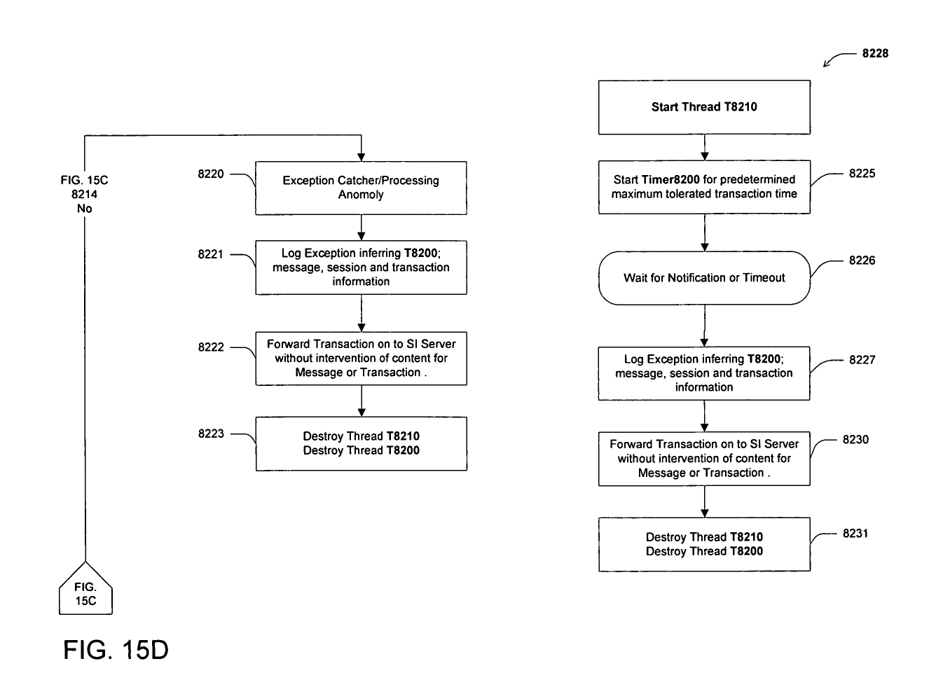

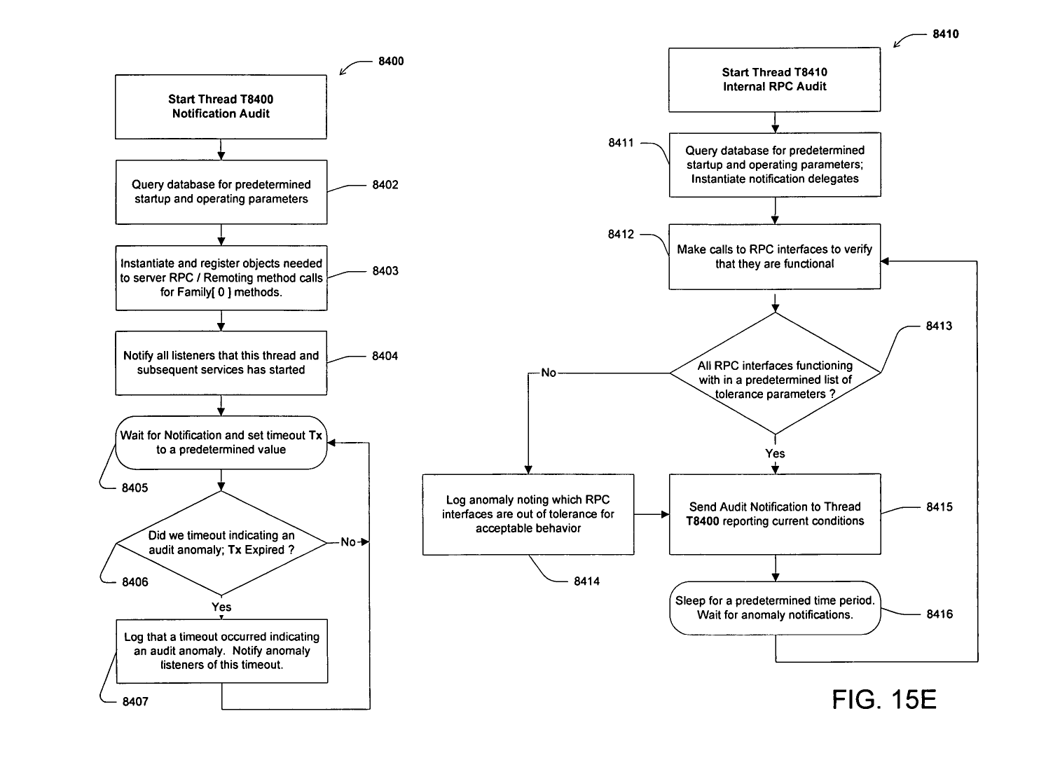

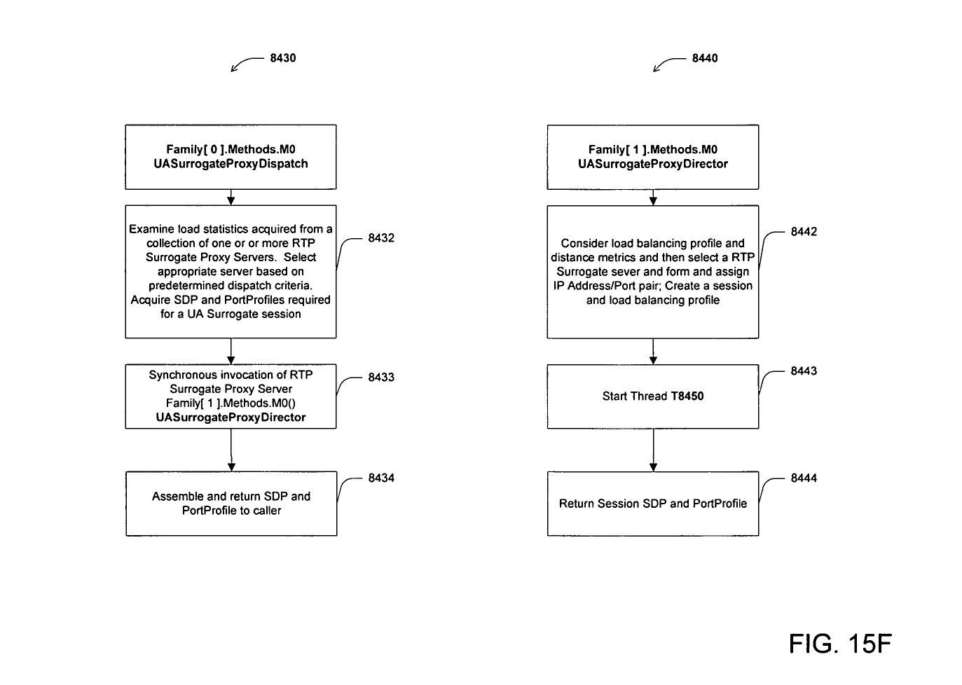

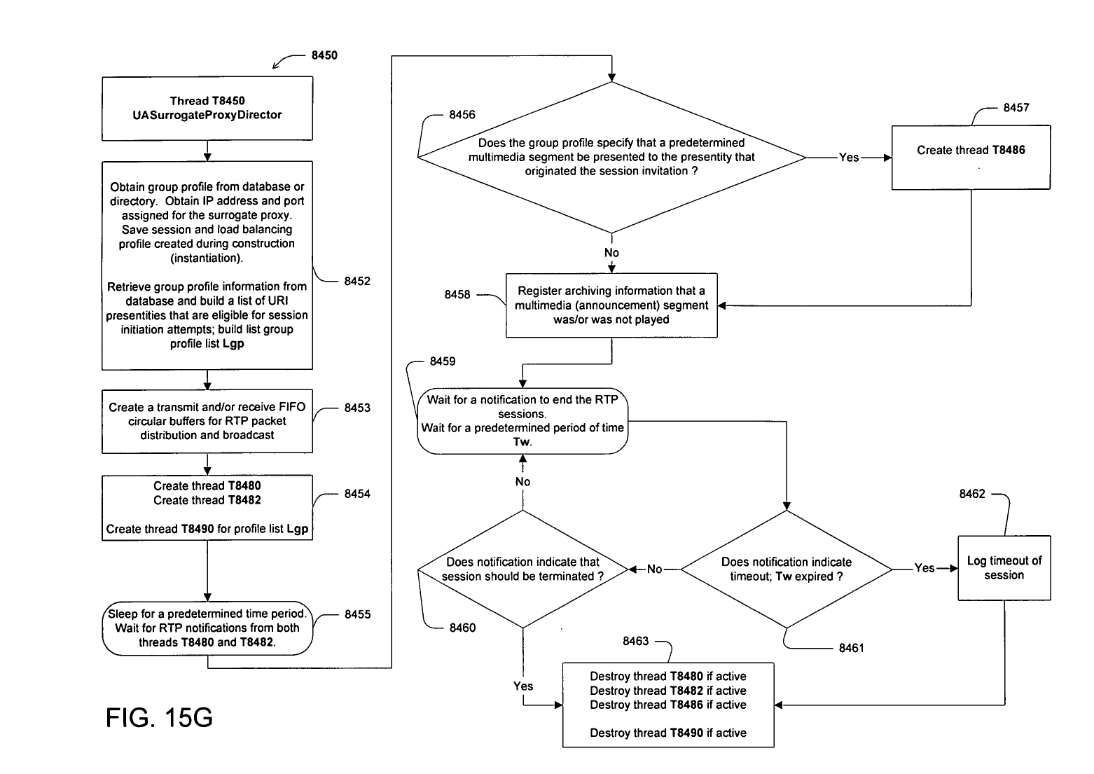

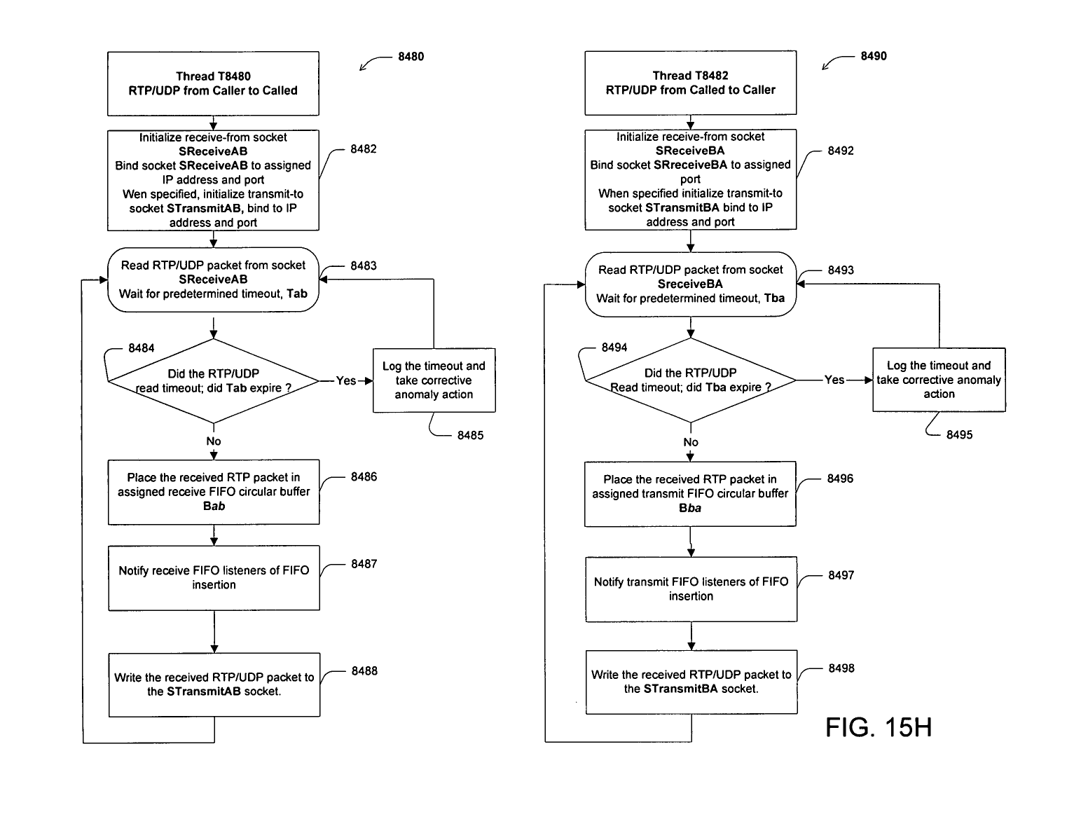

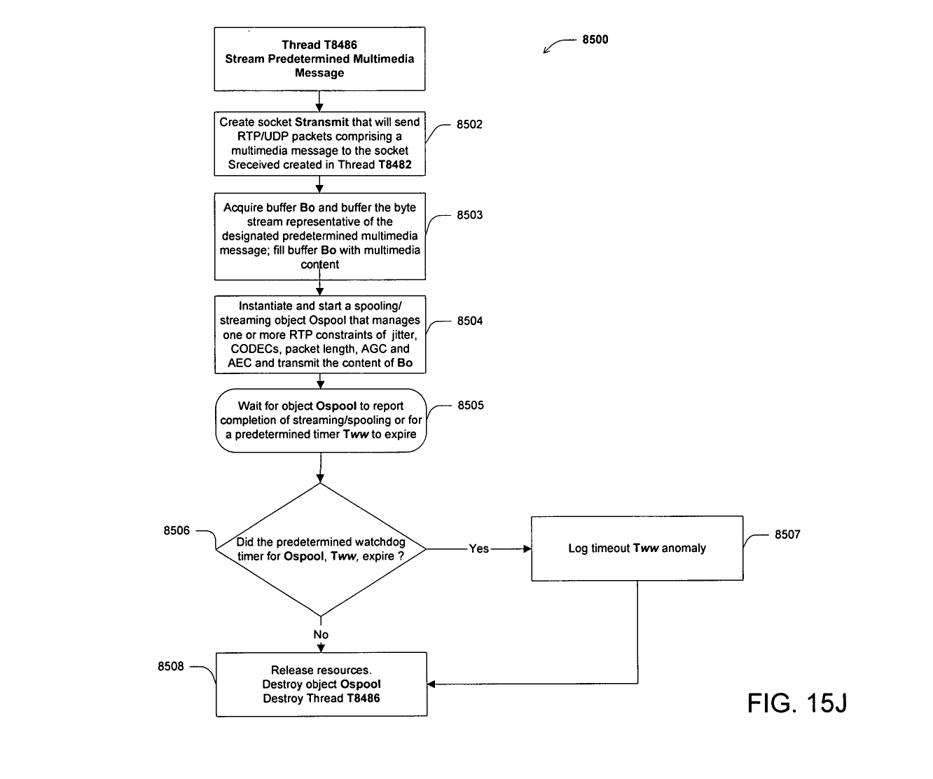

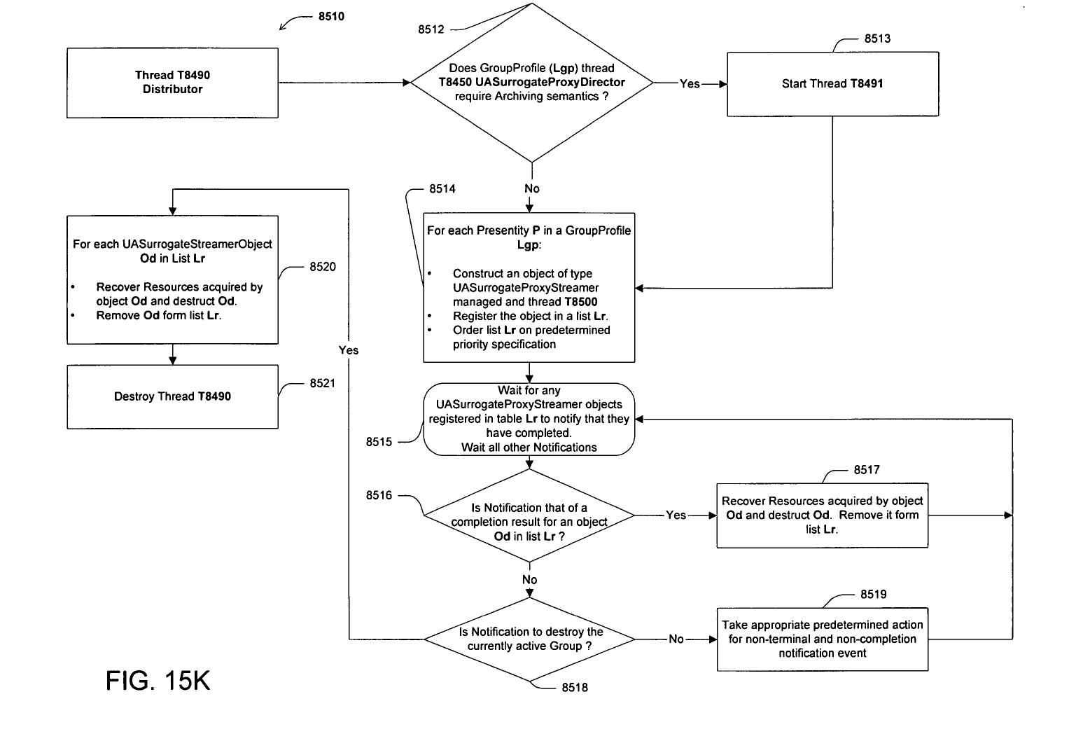

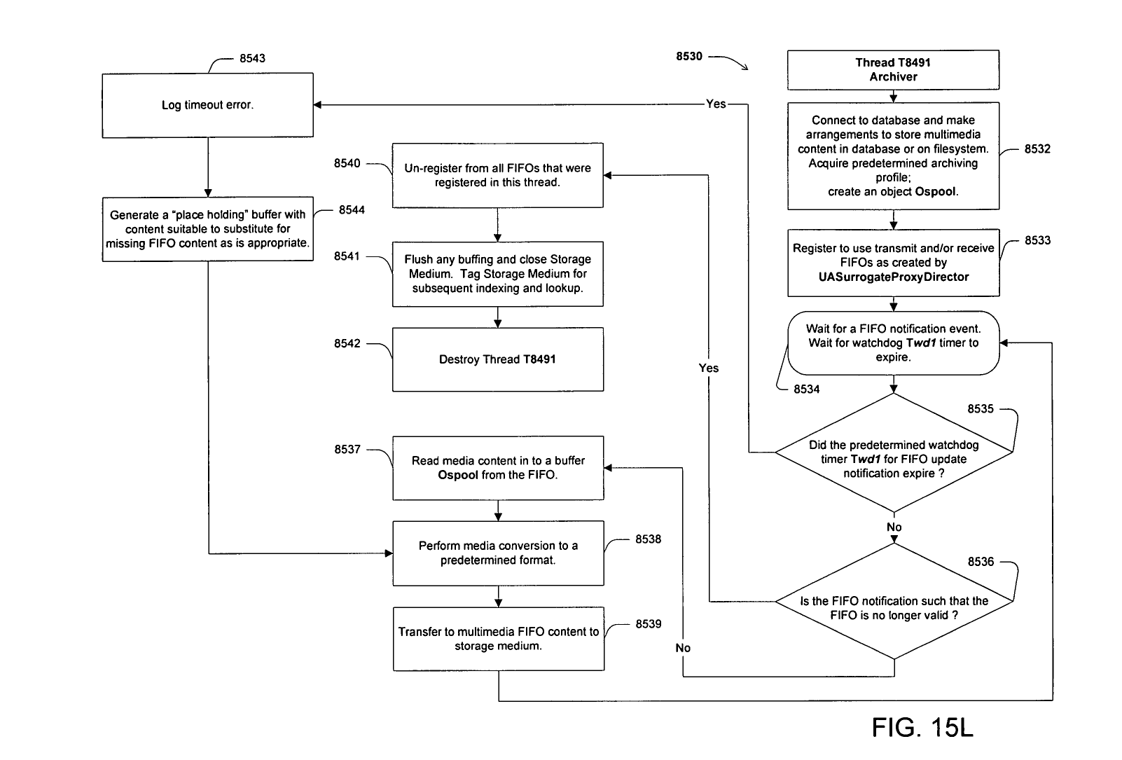

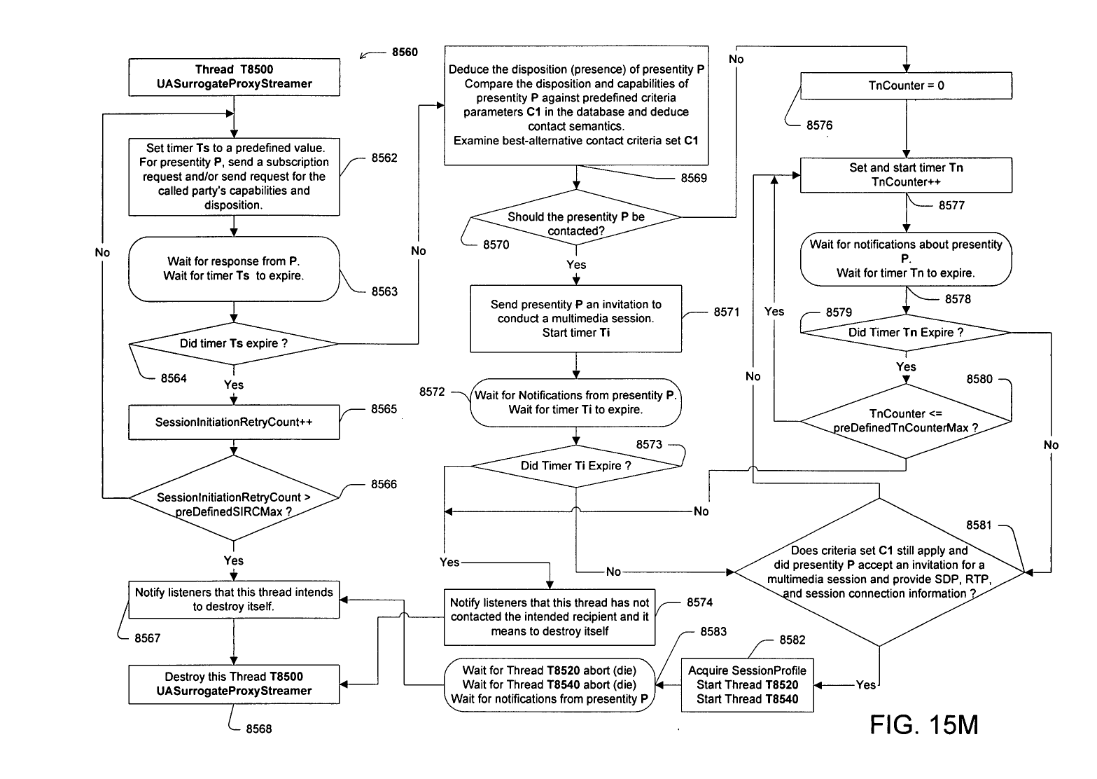

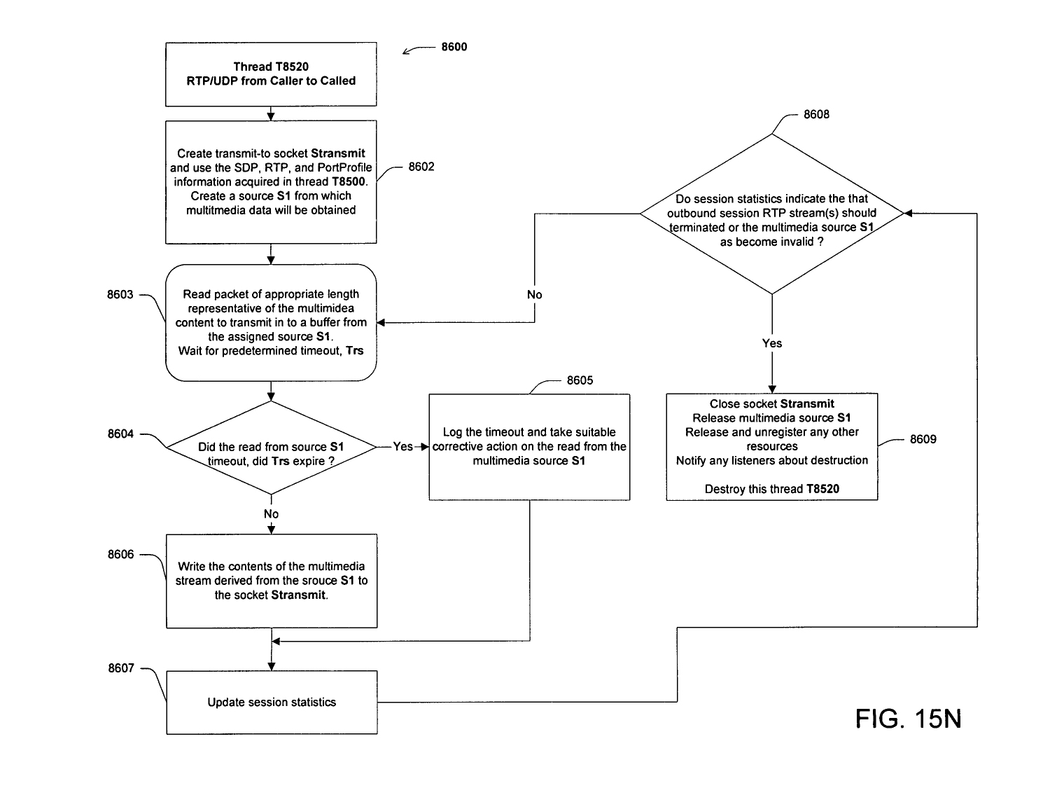

FIGS. 15A-H and J-N illustrate one exemplary process for managing a best-alternative delivery of multimedia messages such as text, voice, and/or video, based on a multi-threaded client-server model that utilizes a web service (SOAP/UDDI/WSDL) and/or RPC remoting paradigm. One such embodiment can utilize the Microsoft .Net framework and a SessionServiceGroup architecture as in session service groups 350, 360 of server architecture 380 of FIG. 6. One method to conduct a “best-alternative” media message delivery is to provide a group of software objects, any of which whose execution can be managed under an independent thread or process, any of which can interact with one another by sending and receiving messages, waiting and/or signaling on one or more software based monitors, semaphores, and/or notification objects which are available under most operating systems such as UNIX and Windows as well as platform infrastructures such as Microsoft's Net and Sun's J2EE.

FIG. 15A illustrates on exemplary process 8000 (e.g., thread T8000) for managing the initialization of sub-systems that can carry out the semantics of a “best-alternative” media message delivery. In steps 8002 and 8003, process 8000 makes one or more queries to one or more databases to ascertain an initial configuration profile for related sub-systems. In step 8004, process 8000 starts a thread T8100 that is responsible for insuring the UA surrogate Proxy and RTP surrogate proxy server service groups are initialized and running. In step 8005, process 8000 starts thread T8400 and thread T8410. In step 8006, process 8000 waits for notifications from any of the created threads and/or objects that were initiated in steps 8004, 8005 and requested in step 8006. Several types of notification are possible, some of which require that a session initiation REQUEST/RESPONSE message intervention, where messages are inspected and acted upon, begin with the creation of a list Lm (instantiated in step 8010) that is used to manage the semantics of subsequent actions and the start of thread T8200 (in step 8011). In step 8007, process 8000 determined if an intervention can begin for any received event or message. Process 8000 allows the message to pass in step 8008 if no intervention is required, continuing with step 8006, or process 8000 continues with steps 8009, 8010 and 8011 if intervention is required, before returning to step 8006. Received messages can be SIP messages, as managed by REQUEST or RESPONSE objects in the Microsoft Live Communications Server 2003 platform, and may carry information that includes, but not be limited to, INVITE, ACK, BYE, CANCEL, REGISTER, OPTIONS, INFO, PRACK, COMET, REFER, SUBSCRIBE, UNSUBSCRIBE, NOTIFY and MESSAGE methods as described by IETF RFC 3261, RFCs which extend RFC 3261, and/or IETF working group drafts related to RFC 3261.

FIG. 15B is a flowchart illustrating on exemplary process 8100 (e.g., thread T8100) for managing the integrity of one, or more, sub-systems such as the session service groups 350, 360 of FIG. 6. In steps 8102 and 8103, process 8100 attempts to establish a session with services available from such a group and wait for notification events and/or exceptions that may be examined to indicate the health of the sub-system. This may be accomplished by binding to remoting services channels provided by a TCP/IP service provider utilizing the Microsoft .Net framework, registering to use the channel, and then by making remote method calls. On detection of abnormal conditions in step 8104, process 8100 makes a log entry in step 8105. In step 8106, process 8100 waits for an event notification. Should an event notification or an exception be received, step 8107, further logging is performed, and any listeners that have made subscription arraignments, such as those waiting on a notification object to be signaled or an exception to be raised, are notified in step 8108. Steps 8103, 8104, 8105, 8106, 8107 and 8108 repeat as shown.

FIGS. 15C, 15D are flowcharts illustrating one exemplary process 8200 for managing the inspection of a message, as may be contained in a REQUEST or RESPONSE object (such as those intrinsic to the MSLCS-2003 server agent infrastructure), and dispatching any or all of the content of the REQUEST or RESPONSE object to one, or more, methods contained in a session service group (e.g., service session groups 350 and 360, FIG. 6). On receipt of the dispatched message in process 8200, process 8200 copies the message content in step 8202. In step 8203, process 8200 starts an audit thread T8210, and then parses the message content in step 8204 in order to decide which semantic is the most appropriate for a “best-alternative” delivery, the “best-alternative” being one of, but not limited to, a) establish one or more real-time multimedia RTP streams (e.g., media stream 540, FIG. 8) between a caller and called party; b) establish one or more real-time multimedia RTP streams between a caller and a plurality of called parties identified in a group utilizing a multimedia gateway (e.g., multimedia gateway 886, FIG. 11) or other means that provides for 1-to-many broadcast, such as a multi-thread based surrogate proxy (e.g., media stream proxy 1250, FIG. 12D); c) establish one or more RTP streams between a caller and a surrogate proxy (e.g., media stream proxy 1250) which can store the RTP streams for subsequent transmission and delivery at a later time to one or more called parties; the “best-alternative,” any of which are selected based on predetermined parameters stored in a profile database. Step 8205 is a decision. If the parsed message content 8204 specifies that the message does indicate a request to exchange multimedia content, then process 8200 continues with step 8206, otherwise, process 8200 continues with step 8214. Step 8214 is a decision that determines if the non-multimedia request is relevant to any threads instantiated from the thread family T8200, if so, process 8200 continues with step 8215, otherwise it continues with step 8205. In step 8215, process 8200 sends notifications to entities that have registered to receive notifications and continues with step 8216 where notifications are sent to active surrogate proxies that have registered to receive notifications the pertain to the session identification that was deduced in stop 8204; process 8200 then proceeds to step 8217. After determining if the message embodies the intent of the calling party to establish a multimedia session with one, or more, called parties in step 8205, in step 8206 a database is then queried about the calling party's (presentity's) profile, which can then be used to further direct “best-alternative” delivery semantics in step 8207, by providing additional parametric information such as, but not limited to, delivery policy, delivery priorities, preferred message ordering, and schedules to be use for delivery to one, or more, called parities. In step 8208, process 8200 establishes a session with a UA Surrogate Proxy server and information containing at least an SDP (Session Description Protocol) description, SIP Call-Id, session handle, and in step 8209 relevant profile information is passed as method parameters to one or more methods in the method family UASurrogateProxyBroadcast in a SessionServicesGroup (e.g., session service group 350, method family 353). In step 8210, process 8200 assembles and sends a response to the caller to indicate that session initiation has commenced and the “call” is in-progress. Such a response, for example, can take the form of a SIP 180 “Ringing” response. The UASurrogateProxy server then provides SDP information that may be used to construct a subsequent response that suggests an offered SDP specification, were a desired IP proxy address and port, CODEC, media, and RTP map is specified. In step 8211, process 8200 may also send this specification to the “caller” managed by thread T8100 and list Lm (step 8010, FIG. 15A). In step 8212, process 8200 registers to receive notifications of messages received for this session as identified by the session (e.g., such as the Call-ID). Both the caller and UASurrogateProxy may deploy standard semantics as specified by IETF RFC 3261 for a SIP UAC and UAS in these transactions. In step 8213, process 8200 sets a timer Tack and then waits for a subsequent response from the caller indicating that they are ready to begin the transmission of one or more RTP streams that will be received by the UASurrogateProxy. Step 8218 is a decision. If the timer Tack expires, Threads T8210 and T8200 are destroyed in step 8217; otherwise, in step 8219, the associated UASurroagateProxy is advised that the RTP streams are inbound and it then execute the selected “best-alterative” delivery semantics. The UASurroageProxy server may persist beyond the life of thread T8200. If, in the decision of step 8206, the caller is not present in a contact list as managed by a database, then process 8200 continues with step 8220, FIG. 15D, where an anomaly is processed and logged, in step 8221, the transaction is serviced, in step 8222, and threads T8200 and T8210 are destroyed, in step 8223. An anomaly does not necessarily preclude the completion of the call by using a standard means provided by the underlying SIP infrastructure, such as that provided by the MSLCS-2003 infrastructure 8222.

FIG. 15D also illustrates one exemplary process 8228, started in step 8203 of process 8200, for managing a timer and monitor that supervises process 8200. Process 8228 sets a timer (Timer8200) to a predetermined amount of time in step 8225, and then waits, in step 8226, for its expiration and/or subsequent notification events, the subsequent notification events possibly being independent of the timer Timer8200. On Timer8200 expiration, notification, or a raised exception, process 8228 then logs message, session, and transaction information managed by process 8228 in step 8227 and proceeds to step 8230 that allows the session transaction to complete by using a standard means provided by the underlying SIP infrastructure (e.g., such as those provided by the MSLCS-2003 infrastructure) 8230. Process 8228 then proceeds to destroy the associated instantiated threads T8200 and T8210 in step 8231.

FIG. 15E is a flowchart illustrating one exemplary process 8400 (e.g., Thread T8400) for managing a means to audit subsystems provided in any or all of the session server groups (e.g., session server groups 350, 360, FIG. 6), of server architecture 380. Process 8400 can be started from methods in any SessionServiceGroup, or a subsystem entity that deploys the resources of a SessionServiceGroup. In step 8402, process 8400 makes one, or more, queries of one, or more, databases to deduce which entities in any given subsystem can be monitored; the directing elements of the query may be specified by the entity that instantiates process 8400. The directing elements can be communicated as parameters to constructor method for the object that embodies process 8400. Monitoring may consist of, but not be limited to, the periodic invocation of available services with in a SessionServiceGroup, to insure that the service is available and is functioning correctly and in a timely fashion. Process 8400 then advertises one or more delegate properties as are available, for example, when using the Microsoft .Net framework delegate model, so that notifications can be sent to listeners that register with one, or more, of the delegate properties in step 8403. Notifications are then dispatched in step 8404 to all listeners to indicate that process 8400 is now monitoring events and notifications. In a similar fashion, in step 8404, process 8400 then registers as a listener with monitored services in one or more associated SessionServiceGroups. In step 8405. process 8400 sets a timer Tx to a predefined value 8405 and waits for notifications or timer Tx expiration. Step 8406 is a decision. If timer Tx has expired, process 8400 continues with step 8407 where a log entry is made and listeners are notified of the expiration of timer Tx. On receipt of a notification and/or the expiration all registered listeners are then notified. This continues indefinitely until thread T8400 is destroyed.

Process 8410 (e.g., Thread T8410), which can be started from methods in any SessionServiceGroup, or a subsystem entity that deploys the resources of a SessionServiceGroup, makes one, or more, queries of one, or more, databases in step 8411 to deduce which entities in any given subsystem can be monitored; the directing elements of the query may be specified by the entity that instantiates process 8410. The directing elements can be communicated as parameters to constructor method for the object that embodies process 8410. Monitoring may consist of, but is not limited to, the periodic invocation of available RTP proxy services made available from one or more SessionServiceGroups, to insure that the RTP proxy services are available and are functioning correctly and in a timely fashion; in particular, UDP packet proxy latency is measured, amongst other criterion such as, but not limited to, connect time, and packet loss. In step 8411, process 8410 advertises one or more delegates so that notifications can be sent to listeners that register with one, or more, of the delegate properties. In step 8412, process 8410 makes calls to RPC interfaces to verify that they are functional. On detecting abnormal conditions in the RTP Proxy Services in step 8413, notifications are then dispatched in step 8414 to all registered listeners to indicate that a potential service degradation may exist and the abnormal conditions are logged in step 8415. Process 8410 then sleeps, in step 8416, for a predetermined amount of time and wakes when the predetermined sleep interval elapses or a notification has been received. This continues indefinitely until process 8410 (thread T8410) is destroyed.

FIG. 15F is a flowchart illustrating exemplary processes 8430 and 8440 for managing a means to ascertain the current and past performance characteristics of one or more RTPSurrogateProxy servers. One such means is to make a family of methods available (e.g., method families 353, 363, 383, FIG. 6) by instantiating an object from a classification, which can be coded using an object oriented language such as C++, C#, Java or VB.Net, the classification. Once instantiated, a collection of public methods, possibly advertised using WSDL (Web Services Description Language) as WEBMETHODS, become available for use by other, possibly autonomous, software programs (e.g., method family 341) running on a client platform 340 or software programs running on session server groups 350, 360 of server architecture 380, FIG. 6. Once such use of a family of methods is to interrogate one or more RTPSurrogateProxyServers by making calls (method invocations) to obtain current and historical information. In step 8432, process 8430 selects an appropriate server, based on predetermined dispatch criteria, and aquires SDP and PortProfiles-required for a UA Surrogate session. In step 8433, process 8430 invokes the RTP Surrogate Proxy Server selected in step 8432, and in step 8434, process 8430 returns the SDP and PortProfiles to the invoking caller.

Similarly, UASurrogateProxyDirector process 8440 utilizes method calls in step 8442 to determine a session load balancing profile that can be used to direct the semantics of a process 8450 (e.g., thread T8540) when started in step 8443. A session and load balancing profile is then returned to the entity invoking process 8440 in step 8444. Nothing precludes method family 353, 363, 383 from being managed in a procedural fashion. Nothing precludes a family of methods from being managed through an object oriented classification means. Nothing precludes a family of methods from using an instruction set native to the CPU under which execution takes place. Nothing precludes a family of methods from using a virtual machine instruction set as those provided by a Java JVM (Java Virtual Machine) or a .Net CLR (Common Language Runtime) environment under the Microsoft Net framework or their equivalents.

FIG. 15G is a flowchart illustrating one exemplary process 8450 (e.g., thread T8450 UASurrogateProxyDirector) for managing a means to direct the distribution of one or more multimedia RTP streams to one or more eligible clients, such as SIP presentities and representative SIP UAs. In step 8452, process 8450 obtains a group profile from one, or more, databases (e.g., database 389, FIG. 6) which can then be used to make further queries of the database to create a group profile list of presentities Lgp, the list which then can be subsequently used to direct the RTP media streams from an originating UA presentity to one or more terminating presentities with the instantiation, in step 8454, of threads T8480, T8482 and T8490. In step 8453, process 8540 creates transmit and receive FIFOs, the receive FIFO utilizable to buffer one or more incoming RTP streams from an originating presentity (calling client) for subsequent distribution to terminating presentities (called client(s)). Both of the receive and transmit FIFOs are available for inspection, reading, and/or writing from public methods exposed by the object that embodies the UASurroageProxyDirector. One embodiment of a FIFO being a circular ring buffer queue that may dynamically grow or shrink.

In step 8455, process 8450 sleeps for a predetermined time period, waiting for RTP notifications from threads T8480 and T8482. Step 8456 is a decision. Should the obtained session profile indicate that a predetermined multimedia segment be presented to the originating presentity, in step 8457, thread T8486 is instantiated. Thread T8486 is not precluded from using one or more media message profile(s), i.e., schema 900, FIG. 9A and/or media message objects, schema 640, FIG. 9B, or a hierarchy of media message markups, consisting, for example, of media message profile objects and media message objects 410 which, when traversed, produce a final result media message product that can be used as a source to generate an RTP stream of multimedia content. Any of media message profile, media message object available from a markup repository. Process 8450 then provides a means for registering as to whether or not a predetermined media message segment was scheduled for streaming back to the originating (calling) presentity's RTP stream in step 8458. Nothing precludes thread T8451, and subsequent actions resulting from the execution of thread T8451, from using from using well known standard SIP messages, as specified in IETF RFC 3261, to negotiate with the UA (UAC/UAS) elements of the originating client platform 340. One means of performing such standard SIP UA negotiations being the utilization of the REQUEST and/or REPSONSE objects, and their associated semantics, as provided by the MSLCS-2003 infrastructure. In step 8459, process 8450 waits for notifications from any of the threads T8480, T8482, and T8490, instantiated in step 8454, and/or a timeout period Tw to expire. Steps 8460 and 8461 are decisions. On receipt of any notification indicating termination 8460 the threads T8480, T8482, T8486, and T8490, if active, are terminated. Should the timer Tw have expired, the expiration is logged in step 8462, and the threads T8480, T8482, T8486, and T8490, if active, are terminated in step 8463.

FIG. 15H illustrates exemplary processes 8480 (e.g., thread T8480) and 8490 (e.g., thread T8482) for managing a means to direct the distribution of a multimedia stream, one such stream being an RTP stream, using process 8480 which creates a socket SReceiveAB, in step 8482, which is then used, in step 8483, to read the content of the multimedia stream and place the content, which can be comprised of a UDP packet, in to a FIFO circular buffer Bab, in step 8486, all FIFO buffer Bab listeners (readers) are notified that there is content available in the FIFO Bab, in step 8487. Should transmit socket STransmitAB be instantiated in step 8482, the content written to the FIFO Bab in step 8486, can be written to socket STransmitAB in step 8488. One example of using a transmit socket STransmitAB is to send an RTP multimedia stream to an archiving entity as described in FIG. 15L or a multimedia gateway (e.g., gateway 886, FIG. 11) which may optionally participate. On attempting a read operation from socket SReceiveAB in step 8483, process 8480 sets a predetermined timeout interval Tab. Should the read operation timeout, as detected in step 8484, a log entry of said timeout is made in step 8485, the read operation is re-attempted in steps 8483 through 8488.

In a similar fashion, process 8490 (thread T8482) directs the distribution of a multimedia stream, one such stream being an RTP stream. In step 8492, process 8490 creates a socket SReceiveBA which, in step 8493, is then used to read the content of the multimedia stream and place said content, which can be comprised of a UDP packet, in to a FIFO circular buffer Bba, in step 8496. In step 8497, all FIFO buffer Bba listeners (readers) are notified, by process 8490, that there is content available in the FIFO Bba. Step 8494 is a decision. Should transmit socket STransmitBA be instantiated in step 8492, the content written to the FIFO Bba in step 8496, can be written to it in step 8498. On attempting a read operation from the socket SReceiveAB in step 8493, process 8490 sets a predetermined timeout interval Tba. Should the read operation timeout in step 8494, a log entry of said timeout is made in step 8495; the read operation is re-attempted in steps 8493 through 8498.

In another embodiment, methods are provided for transmitting one or more audio messages to a pre-determined list of users, some of which may be anonymous and others of which may, or may not, be currently enabled (i.e., as discerned from a disposition) to receive said messages in real-time or near real-time.

FIG. 15J is a flowchart illustrating one exemplary process 8500 (e.g., thread T8486) for managing a means to stream (transmit) a predetermined media message content to a calling SIP UA. In step 8502, process 8500 creates a socket Stransmit that will be used to send RTP/UDP packets that comprise a predetermined multimedia message, the multimedia message being made available from a direct storage means such as a database, a file, a URI, or derivation of media content produced from a database, and/or a file, and/or a URI source. One such derivation being media message produced by traversing a markup tree (see media message content 401, link 411, FIGS. 7A-B) and applying the semantics of one or more MediaMessageProfiles 402, (schema 600, FIG. 9A) to one or more MediaMessageObjects (schema 640, FIG. 9B) producing a final derived content to be transmitted by process 8500. Process 8500 then acquires a buffer suitable to store the predetermined media message and fills the buffer with predetermined media message content in step 8503. In step 8504, process 8500 creates one or more objects, one such object Ospool, that will transmit the contents of the buffer as an RTP stream to a SIP UA recipient. The object Ospool, created in step 8504, can be instantiated by using one or more method calls in a session service group (e.g., session server groups 350, 360 of server architecture 380, FIG. 6). One exemplary embodiment of an object Ospool being a CCCNMeidaTerm object as provided by the WinRTP developer's kit in which combinations of RTP sources, RTP sinks, and RTP transformations can be specified; sources and sinks identifying a media stream source and media stream destination respectively; transformations comprising, but not limited to, the functional elements of a CODEC, a jitter buffer, and/or one or more predetermined filter or transform specifications. The object Ospool is then directed to commence a streaming operation in step 8504 and process 8500 then waits, in step 8505, for an asynchronous notification that indicates that spooling has completed or a timeout interval Tww has expired. Should the timeout interval Tww expire in step 8506, a log entry is made in step 8507. Upon spooling completion or the expiration of Tww, resources are released, the object Ospool is destroyed, and process 8500 is destroyed in step 8508.

FIG. 15K illustrates an exemplary process 8510 (e.g., Thread T8490) for managing a means of distributing RTP multimedia content to one or more recipients, such as one or more SIP UA presentities. Process 8510 can be instantiated, for example, by process 8450 in step 8454 (see thread T8450, FIG. 15G). In step 8512, process 8510 inspects a GroupProfile Lgp, provided by process 8450 (i.e., thread T8450), or another means, and determines if an archiving semantic is specified. If so, process 8510 instantiates thread T8491, FIG. 15L, in step 8513.

Instep 8514, process 8510 initializes a list Lr and then iterates over items in the list Lgp, each item Pitem representative of one SIP UA presentity, and instantiates a UASurrogateProxyStreamer object (see thread T8500, FIG. 1 SM) for each item Pitem. Each object UASurrogateProxyStreamer can be managed by a separate, autonomous, and unique instance of thread T8500. Each item, Pitem, when successfully instantiated, constructed and running under its respective thread T8500, is added to a list of registered items Lr. Once the list Lr has been completed, it is then ordered using a predetermined priority specification as may be contained in the GroupProfile Lgp.

In step 8515, process 8510 waits for notifications from any one of the UASurrorgateProxyStreamer objects, the any one object Od in the list Lr. Step 8516 is a decision. If a completion notification is received, then resources consumed by object Od are released, Od is removed from list Lr, and Od is destroyed in step 8517, and thread T8490 again waits for notifications in step 8515. Step 8518 is a decision. If the notification, received at step 8515, indicates that the entire group, as manage by list Lr should be destroyed, an iteration over this list Lr commences in step 8520 and each object Od in the list Lr is released, Od is removed from list Lr, and Od is destroyed; when the iteration is complete, process 8510 (thread T8490) is destroyed in step 8521.

If a received notification is not a completion notification for an object Od in the list Lr, or a group destruction notification, then other predetermined semantic actions can be taken in step 8519.

In another embodiment, upon a server's receipt of the message and list Lgp (e.g., as in step 8514) of message recipients, the server may then select a “best-alternative” to deliver the multimedia message, such as an audio message, in real-time by enumerating over the list of recipients and starting an independent thread T8500 of execution for each recipient in the list. Each thread T8500 may then attempt to establish a real-time communications session with the recipient by using an associated identifying handle (e.g., an SIP URI). If a real-time communications session is possible, and accepted by the recipient, another thread Ts may be started to spool the contents of the audio message. The thread Ts may decode, filter, encode, compress and/or decompress, in the time and/or frequency domains, when spooling the real-time media stream (e.g., RTP). The message may then be considered as delivered by one or more elements in the messaging fabric.

FIG. 15L illustrates an exemplary process 8530 (e.g., thread T8491) for managing a means of archiving an RTP stream from an originating (calling) entity, such as a calling SIP UA presentity. In step 8532, process 8530 obtains a predetermined parametric profile from a database and also makes arrangements to store multimedia content in either of a local or remote database, or a local or remote file system, or other suitable means of message storage. As an example, the arrangements being made by making method calls of web services, such and WEBMETHODS provided under the Microsoft .Net infrastructure, or its equivalent and/or remoting methods as provided by a family of methods (e.g., method family 383 of server architecture 380, FIG. 6). In step 8533, process 8530 makes one or more method calls to obtain a reference to a FIFO object (created in step 8453, FIG. 15G) from which to either read and/or write. The reference to the FIFO object may be sent to thread T8490 (FIG. 15K) 8515 in process 8510 via a notification. In step 8534, process 8530 sets a timer Twd1 to a predetermined value and waits for notification events, as managed by step 8487, FIG. 15H, from the referenced object managing the FIFO. Step 8535 is a decision. If the timer Twd1 expires, then the timeout is logged in step 8543 and in steps 8544 place holding media content is inserted in to the storage medium covering a “gap” that would be present due to the absence of streaming media, such content for example, being the media equivalent of silence 8538, 8539. If, in decision 8535, the FIFO notification indicates that the FIFO is no longer valid then, in step 8540, process 8530 cancels any and all FIFO notification arrangements, flushes, in step 8541, any buffering that may exist between the FIFO and the storage medium and destroys process 8530 in step 8542. In the decisions of steps 8535 and 8536, if the FIFO notification is not a Twd1 expiration or a notification that the FIFO is no longer valid, then the FIFO can be read in step 8537 and the media content read can be placed in to a buffer, the appropriate media conversion can be applied, in step 8538, to the buffer and the media content buffered from the FIFO can be transferred to the storage medium in step 8539. One embodiment of a buffering means is to utilize an object Ospool as is described in FIG. 15J. Nothing precludes the archiving process from tagging or marking-up the content transferred to a storage medium as in described by FIG. 7B.

FIG. 15M illustrates an exemplary process 8560 (e.g., thread T8500) for creating a UASurrogateProxyStreamer object and managing the object to perform one or more embodiments of a “best-alternative” media message delivery. In step 8562, process 8560 sets timer Ts to a predefined value for a give presentity P to which a reference is provided on construction of the UASurrogateProxyStreamer object. One example of a reference to a presentity P is a SIP URI such as sip:name@domain.com. Also in step 8562, process 8560 makes a query of one or more session management servers, such as a proxy, location, or registrar SIP server to inquire about the current disposition of presentity P. Such servers can be provided by the MSLCS 2003 platform. One example query to determine the disposition of a presentity P to originate a SIP INVITE request to presentity P. A second example is to send a SUBSCRIBE request to the presentity P and wait for subsequent notifications about the disposition of presentity P. A third example is to directly make a query of a database maintained by a SIP server, such as utilizing a QueryEndpoints( ) method call using SPL (Sip Programming Language) as provided by the MSLCS-2003 platform which can be made accessible by web methods exposed through a web service interface (e.g., server group 360, method family 363, FIG. 6). After deducing the current disposition of presentity P, in step 8562, process 8560 makes a subscription request of a session initiation fabric so that subsequent changes in presentity P's disposition (presence) are received as notifications by process 8560; one example being an SPL (Sip Processing Language) script SI that has been attached to the intrinsic REQUEST and RESPONSE message routing fabric of the MSLCS-2003 infrastructure. As REQUEST and RESONSE messages are intercepted by script SI, SI can deduce as the current disposition of a given presentity P. Process 8560 waits for a response from P in step 8563. Step 8564 is a decision. If the request for the disposition of presentity P or the presence notification subscription request is not accommodated in the timer interval as specified by timer Ts, a predetermined number of retries preDefinedSIRCMax are attempted, controlled by steps 8565 and 8566, and if unsuccessful, in step 8567, process 8560 notifies any subscribing listeners that it will attempt to destroy itself, and then attempts to destruct in step 8568.

If process 8560 is successful in deducing the current disposition of presentity P in step 8569, and has successfully registered so as to receive notifications about the state, or changes in state, of presentity P, it then makes a database query to obtain a predetermined set of parameters that can be used to direct a “best-alternative” contact and delivery process. Such parameters can include, but not be limited to, criteria set C1 such as 1) time-of-day, day-of-week; 2) an accept-reject list; 3) a relationship between the calling and called party's (P) assigned role(s); 4) a allowed maximum number of attempts to reach presentity P; 5) the current disposition (presence) of presentity P; 6) the location of presentity P. Step 8570 is a decision. If the evaluation of the criteria set C1 indicates that presentity P should not be contacted, then process 8560 re-attempts contact at a later time by setting a timer Tn expiration value, in step 8577, to a predefined value and initializes a loop (steps 8577 through 8581), at step 8576, which can only execute a maximum number of times preDefinedTnCounterMax. During each iteration of the loop, process 8560 waits, in step 8578, for notifications that communicate the current disposition, or change of disposition (presence) for presentity P. Step 8581 is a decision. If presentity P's disposition has changed so that P is willing and capable to accept an incoming multimedia audio session, then a SessionProfile is created, in step 8582, which contains at least a SDP profile derived form session negotiation, and then threads T8520 and T8540 are instantiated and started to negotiate and carry out the delivery of multimedia audio content. In step 8583, process 8560 waits for both of T8520 or T8540 to abort (die) or subsequent notifications from presentity P. When threads T8520 and T8540 abort process 8560, in step 8567, notifies any subscribing listeners that it will attempt to destroy itself, and then attempts to destruct in step 8568.

Step 8570 is a decision. If, in step 8569, the evaluation criteria set C1 indicates that the presentity P should be contacted, then in step 8571, process 8560 sends an invitation to presentity P to establish an multimedia session and, in step 8572, waits for predetermined amount of time Ti for an acknowledgement from P. Step 8573 is a decision. If the timer Ti expires before an acknowledgement (indicating that it is capable and willing to accept a multimedia session), is received from P, then process 8560 notifies any subscribing listeners, in step 8574, that it will attempt to destroy itself, and then attempts to destruct in step 8568. If an acknowledgement from P indicates that it is capable and willing to accept a multimedia session, then, in step 8582, a SessionProfile is created which contains at least a SDP profile derived from session negotiation, and threads T8520 and T8540 are instantiated and started to negotiate the delivery of multimedia audio content. Process 8560 then waits, in step 8583, for both of T8520 or T8540 to abort (die) or subsequent notifications from presentity P. When process 8560 determines that threads T8520 and T8540 abort or die in step 8583, process 8560 notifies any subscribing listeners in step 8567 that it will attempt to destroy itself, and then attempts to destruct in step 8568.

FIG. 15N illustrates an exemplary process 8600 (e.g., thread 8520) for managing a means of transmitting a multimedia stream from a source S1, the source S1 possibly originating from a buffer, a permanent store, a semi-permanent store, or a network connection such as, but not limited to, 1) a FIFO ring buffer as maintained by thread T8480 (see step 8487, FIG. 15H); 2) a storage medium (see step 8451, FIG. 1 SL), in which the content may be marked-up, (see media message object 410, link 411, media message profile link 413, FIG. 7B); and 3) a real time source of RTP UDP packets, such as a socket that has been opened (see step 8482, FIG. 15H) and written to be read by step 8483 through 8488, FIG. 15H. In step 8602, process 8600 creates transmit-to socket Stransmit, and uses the SDP, RTP, and PortProfile information acquired in process 8560. Process 8600 then creates a source S1, from which multimedia data will be obtained. In step 8603, process 8600 reads media content from source S1 and checks the timer Trs for expiration in step 8604. If timer Trs expired, then, in step 8605, process 8600 logs the timeout anomaly, takes any suitable actions to alleviate the affect of the timeout anomaly. If the timer Trs did not expire, then the content read from the source S1 is written to the socket Stransmit in step 8606. In step 8607, process 8600 updates session statistics, which may include, but is not limited to a) the number of bytes transferred; b) the current real time, being either relative or actual; or c) a profile of any header information, such as a header maintained in an RTP packet. Step 8608 is a decision. In step 8608, process 8600 examines session statistics and the source of media content S1 to deduce of the transferal process should repeat by returning to step 8603. If the deduction indicates that the transferal process should terminate, then, in step 8609, process 8600 closes the socket Stransmit, releases the resources allocated in the acquisition of the media source S1, notifies any listeners which may have subscribed for notifications, and then process 8600 destroys itself; the deduction considering, but not limited to, any of: 1) packet latency; 2) invalid RTP packet content; 3) network congestion; and 4) the source of media content S1 is exhausted; 4) the source of media content S1 is no longer available.

What is claimed is:

1. A messaging system, comprising:
a first computer and a second computer connected via a network;
a first Edge Terminal Device (ETD) connected to the first computer and a second ETD connected to the second computer;
the first ETD being responsive to a received message transmitted by the second ETD to reproduce content of the received message and to accept user input in response to the message.

2. The system of claim 1, one or both of the first and second ETDs comprising a phone.

3. The system of claim 1, the received message comprising a multimedia message.

4. The system of claim 1, one or both of the first and second ETDs comprising an intercom providing simplex or duplex communications.

5. The system of claim 1, the second ETD serializing user input actions and transmitting data representative of the serialized user input actions to the second computer for re-characterizing the data as instructions for the first computer, the instructions comprising control information to relay directives to the first ETD.

6. The system of claim 5, the first edge terminal comprising one or more display elements, wherein the directives instruct the first ETD to change illumination of one or more of the display elements.

7. The system of claim 6, the first ETD comprising one or more display elements, at least one speaker, and at least one display, the directives instructing the first edge terminal to perform one or more of the following: change illumination of one or more of the display elements; change illumination of the display elements in a pattern illustrating one or more suggested actions for a user at the first edge terminal; emit sound through the speaker as one or more suggested actions for a user at the first ETD; emit sound through the speaker as the content; show one or both of text and graphics on one or more displays as one or more suggested actions for a user at the first ETD; and show one or both of test and graphics on the display as the content.

8. The system of claim 5, the first edge terminal comprising at least one speaker, wherein the directives instruct the first ETD to emit sound through the speaker as one or more suggested actions for a user at the first ETD.

9. The system of claim 5, the second ETD having one or more audio sources for capturing sound as at least part of the content.

10. The system of claim 5, the second ETD having a one or more video sources for capturing one or more images as at least part of the content.

11. The system of claim 5, further comprising a server connected in network with the first and second computers, for storing one or more received messages until the first ETD has a state to receive the stored messages.

12. The system of claim 5, the user input actions comprising one or more of keystrokes, voice commands, and tactile inputs.

13. A software product comprising instructions, stored on computer-readable media, wherein the instructions, when executed by a computer, perform steps for controlling the computer and an ETD connected to the computer, comprising:
instructions for interpreting user inputs of the ETD;
instructions for re-characterizing the user inputs as directive instructions for a second computer, the directive instructions comprising control information for a second ETD connected to the second computer; and
instructions for capturing content from the ETD, through the computer and second computer, for delivery to the second ETD.

14. The software product of claim 13, the instructions for capturing content comprising instructions for capturing multimedia information.

15. The software product of claim 13, the instructions for interpreting user inputs comprising instructions for utilizing one or more entities executing in the computer.

16. The software product of claim 13, the instructions for interpreting user inputs comprising instructions for resuming one or more waiting executable entities within the computer.

17. The software product of claim 13, the instructions for interpreting user inputs comprising instructions for interpreting one or more of keystrokes, voice commands, and tactile input at the ETD.

18. A method for best effort delivery messaging for a recipient user agent, comprising the steps of:
as directed by the recipient user agent, forming one or more surrogate proxy user agents for the user agent; and
through operation of the surrogate proxy user agents, storing multimedia data for the recipient user agent due to one or both of (a) unavailability of the recipient user agent and (b) request by the receiving user agent.

19. The method of claim 18, the step of storing comprising registering with a registration entity such that notification events on changes of user agent's availability are received by surrogate proxy user agents.

20. The method of claim 18, further comprising the step of attempting delivery of the multimedia data when the user agent becomes available.

21. The method of claim 20, further comprising the step of ranking the multimedia data for sequentially-ordered delivery of the multimedia data when the user agent becomes available.

22. A method for best effort delivery messaging for a sending user agent, comprising the steps of:
forming a list of one or more receiving user agents as specified by the sending user agent; and
forming at least one surrogate proxy user agent for each of the receiving user agents; and:
through operation of the surrogate proxy user agent, buffering multimedia data for its respective receiving user agent until the receiving user agent is disposed to receive the multimedia data.

23. The method of claim 22, the step of buffering comprising managing the multimedia data as distributed across a network, and further comprising one or more of prefixing, appending, inserting, combining, and mixing other data with the multimedia data, and one or more of blanking, deleting, and filtering the multimedia data.

24. A server system for managing mark-ups of multimedia data of one or more communicating devices on a network, comprising:
means for buffering first multimedia data; and
means for accepting inputs from the communicating devices to mark-up the first multimedia data such that, for each mark-up, a node is added to a hierarchical list structure having child and peer relationships, and such that applying the mark-ups to the first multimedia data defines a second multimedia data that is of equal or different duration and content to the first multimedia data.

25. The system of claim 24, wherein the mark-ups comprise one or more of prefixing, appending, inserting, combining, and mixing other data with the first multimedia data.

26. The system of claim 24, the first multimedia data comprising a first audio message, the inputs comprising one or more second audio messages, wherein the second multimedia data postfixes, prefixes, mixes or combines the second audio messages with the first audio message.

27. The system of claim 24, the first multimedia data comprising a first audio message, the inputs comprising a deletion, blanking or filtering specification, wherein the second multimedia data comprises only a portion of the first audio message.

28. The system of claim 24, further comprising means to traverse the hierarchical list structure to apply semantics as specified one or more of the nodes to the first multimedia data and produce the second multimedia data.
